(19) United States
(12) Patent Application Publication
(10) Pub. No.: US 2012/0237276 A1
(43) Pub. Date: Sep. 20, 2012

(54) Image Forming Apparatus

(75) Inventors: Tsutomu SASAKI, Matsumoto-shi (JP); Kazuhiro NISHIYAMA, Shiojiri-shi (JP); Naoyuki OKUMURA, Shimosuwa-machi (JP); Hidehiro TAKANO, Matsumoto-shi (JP); Ken IKUMA, Suwa-shi (JP)

(73) Assignee: SEIKO EPSON CORPORATION, Tokyo (JP)

(21) Appl. No.: 13/416,829

(22) Filed: Mar. 9, 2012

(30) Foreign Application Priority Data
Mar. 18, 2011 (JP) 2011-060766
Mar. 22, 2011 (JP) 2011-062373
Mar. 29, 2011 (JP) 2011-071856
Mar. 30, 2011 (JP) 2011-074396
Apr. 4, 2011 (JP) 2011-082919

(51) Int. Cl. G03G 21/10

(52) U.S. Cl. 399/348

(57) ABSTRACT

An image forming apparatus of the invention includes a carrier solution application roller that rotates centering on a rotary shaft and applies a carrier solution to a transfer roller after an image of a liquid developer including toner and the carrier solution is transferred to a transfer medium, a transfer roller cleaning roller, supported by a cleaning member support portion through a rotary shaft, which removes toner remaining in the transfer roller, and a carrier solution application roller of which the amount of movement is larger than the amount of movement of the transfer roller cleaning roller when the cleaning member support portion is rotated. Even when the transfer roller moves, satisfactory cleaning properties are secured without breaking a mutual positional relationship by facilitating mutual positioning between the transfer roller and the transfer roller cleaning roller.

### BACKGROUND

1. Technical Field

The present invention relates to an image forming apparatus including an image carrying roller which is rotated in contact with a latent image carrier and to which a toner image developed in the latent image carrier using a liquid developer (referred to as liquid toner) including toner and a carrier solution is transferred.

2. Related Art

In the past, image forming apparatuses have been known which include a photoreceptor cleaning portion in which a toner image formed by developing a latent image formed in a photoreceptor using liquid toner is transferred to a transfer medium such as transfer paper, and after the toner image is transferred to the transfer medium, a carrier solution is applied to the photoreceptor to remove toner remaining in a transfer roller (see, for example, JP-A-2005-77632).

In a photoreceptor cleaning portion of an image forming apparatus disclosed in JP-A-2005-77632, a carrier solution is applied to a photoreceptor after a toner image is transferred to a transfer medium to thereby weaken adhesion of remaining toner, and in this state, the remaining toner and the carrier solution adhering to the photoreceptor are scraped off by a photoreceptor cleaning blade. In addition, the remaining toner and the carrier solution which are not scraped off by the photoreceptor cleaning blade are scraped off by a photoreceptor cleaning roller.

In addition, in the past, image forming apparatuses have been known in which a toner image is formed by developing a latent image formed in a photoreceptor having a concave portion using liquid toner, a transfer roller which is an image carrying roller having a concave portion is brought into contact with the photoreceptor and is rotated to thereby transfer the toner image to the transfer roller, and the toner image transferred to the transfer roller is transferred to a transfer medium such as transfer paper (see, for example, JP-A-2004-317980).

In the image forming apparatus disclosed in JP-A-2004-317980, after the toner image formed in the photoreceptor is transferred to the transfer roller, the photoreceptor is cleaned using a photoreceptor cleaning roller, and liquid toner remaining in the photoreceptor is removed. In addition, after the toner image transferred to the transfer roller is transferred to the transfer medium, the transfer roller is cleaned using a transfer roller cleaning roller, and the liquid toner remaining in the transfer roller is removed.

However, even when the photoreceptor is cleaned by the photoreceptor cleaning roller, remaining liquid toner is not completely removed, and the remaining liquid toner is deposited in the concave portion of the photoreceptor provided in the photoreceptor. When the image forming apparatus is used for a long period of time, the liquid toner deposited in the concave portion of the photoreceptor seeps out of the concave portion, and contaminates peripheral members of the photoreceptor. Consequently, in the image forming apparatus disclosed in JP-A-2004-317980, the inside of the concave portion of the photoreceptor is cleaned by a web cleaning device, or the liquid toner deposited in the concave portion of the photoreceptor is suctioned by a suction pump, to thereby remove the liquid toner within the concave portion of the photoreceptor. Meanwhile, the liquid toner deposited in the concave portion of the transfer roller is not mentioned in JP-A-2004-317980.

Incidentally, when the position of the photoreceptor is moved for the replacement of the photoreceptor, positioning based on the thickness of the transfer medium, and the like, positioning between the cleaning solution application roller and the photoreceptor cleaning roller and the photoreceptor is required in order to satisfactorily secure the cleaning properties of the photoreceptor using the cleaning solution application roller and the photoreceptor cleaning roller.

However, in the photoreceptor cleaning portion disclosed in JP-A-2005-77632, the cleaning solution application roller and the photoreceptor cleaning roller are individually arranged. For this reason, positioning between the cleaning solution application roller and the photoreceptor cleaning roller and the photoreceptor becomes complicated. Furthermore, the cleaning solution application roller and the photoreceptor cleaning roller are individually arranged, and thus the support structure of each roller becomes not only complicated, but also the photoreceptor cleaning portion becomes large-sized.

Moreover, the photoreceptor cleaning blade is arranged in addition to the photoreceptor cleaning roller. Such a cleaning blade system has a relatively high surface pressure compared to a cleaning roller system. Since a target is liquid in a liquid development system, it is difficult to secure the cleaning performance. Consequently, it is known that a method of scraping off a liquid developer by a cleaning blade made of rubber is effective. However, since the cleaning blade is further arranged in this manner, the photoreceptor cleaning portion becomes much larger-sized.

On the other hand, in the image forming apparatus disclosed in JP-A-2004-317980, the outer circumferential surface except the concave portion of the transfer roller is brought into contact with the photoreceptor. For this reason, after the toner image of the photoreceptor is transferred to the transfer roller, the liquid toner remaining in the photoreceptor is transferred to the transfer roller. In that case, the liquid toner transferred to the outer circumferential surface of the transfer roller adjacent to the concave portion in the rotational direction side of the transfer roller is moved to the concave portion and is deposited in the concave portion of the transfer roller. When the image forming apparatus is used for a long period of time, the liquid toner deposited in the concave portion of the transfer roller seeps out of the concave portion, and contaminates peripheral members of the transfer roller. Consequently, it is considered that the web cleaning device or the suction pump used in the cleaning of the concave portion of the photoreceptor disclosed in JP-A-2004-317980 is applied to the cleaning of the concave portion of the transfer roller.

However, the web cleaning device or the suction pump is relatively large-sized and the structure thereof is complicated. For this reason, there is a problem that not only a large space is required, but also high costs are required.

### SUMMARY

An advantage of some aspects of the invention is to provide an image forming apparatus having a cleaning device capable of being formed in a small and compact manner while securing satisfactory cleaning properties, without breaking a mutual positional relationship by facilitating mutual positioning between an image carrying roller and a cleaning roller even when an image carrying roller that carries an image using a liquid developer is moved.

Another advantage of some aspects of the invention is to provide an image forming apparatus capable of being manufactured in a small and compact manner and inexpensively, while effectively removing a liquid developer deposited in a concave portion of an image carrying roller.

Still another advantage of some aspects of the invention is to provide an image forming apparatus capable of being manufactured in a small and compact manner and inexpensively, while effectively suppressing accumulation of a liquid developer in a concave portion of an image carrying roller.

An image forming apparatus according to an aspect of the invention includes a cleaning solution application roller which is rotated by a first rotary shaft and applies a cleaning solution to an image carrying roller after an image of a liquid developer including toner and a carrier solution is transferred to a transfer medium, an image carrying roller cleaning roller which is brought into contact with the image carrying roller to which the cleaning solution is applied so as to be rotated by a second rotary shaft and removes toner remaining in the image carrying roller, and a cleaning member support portion which is positioned in the image carrying roller by rotation by a third rotary shaft and supports the cleaning solution application roller and the image carrying roller cleaning roller. The cleaning solution is applied to the outer circumferential surface of the image carrying roller after the image of the liquid developer is transferred to the transfer medium by the cleaning solution application roller. Thereby, adhesion of the toner remaining in the outer circumferential surface of the image carrying roller after the transfer is weakened. Therefore, the remaining toner, the carrier solution, and the cleaning solution in which the adhesion is weakened can be effectively rubbed off from the outer circumferential surface of the image carrying roller by the image carrying roller cleaning roller.

Further, when the cleaning member support portion is rotated, the amount of movement of the image carrying roller cleaning roller is smaller than the amount of movement of the cleaning solution application roller. Thereby, it is possible to increase the surface pressure of the image carrying roller cleaning roller against the image carrying roller, and to decrease the surface pressure of the cleaning solution application roller against the image carrying roller. As a result, satisfactory carrier solution application properties using the cleaning solution application roller and satisfactory cleaning properties using the image carrying roller cleaning roller can be obtained with a simple structure. Particularly, the image carrying roller cleaning roller is made closer to the third rotary shaft than the cleaning solution application roller, so that when the cleaning member support portion moves following the movement of the image carrying roller, the rigidity is easily secured and the power relationship is stabilized. Thereby, it is possible to stably increase the surface pressure of the image carrying roller cleaning roller against the image carrying roller, and to improve the cleaning properties using the image carrying roller cleaning roller with a simple structure.

Further, the second rotary shaft is arranged in the vicinity of the third rotary shaft, whereby it is possible to decrease the moment due to the frictional force generated in a cleaning nip between the image carrying roller and the image carrying roller cleaning roller. Thereby, since the chatter vibration of the image carrying roller cleaning roller is hardly generated, it is possible to eliminate application unevenness of the cleaning solution of the cleaning solution application roller due to the propagation of vibration, to increase the surface pressure of the image carrying roller cleaning roller against the image carrying roller, and to stably remove the remaining toner and the carrier solution attached thereto. Particularly, the third rotary shaft and the second rotary shaft are form concentrically with each other, whereby the moment due to the frictional force applied to a frame support lever can be scarcely generated. The cleaning member support portion is brought into contact with the image carrying roller much more stably.

Further, in this manner, the satisfactory cleaning properties using the image carrying roller cleaning roller is obtained, thereby allowing the cleaning to be finished without using the cleaning blade. Therefore, damage to the image carrying roller due to the cleaning blade can be suppressed. Thereby, the configuration of the image carrying roller cleaning device can be made simpler. Particularly, when the image carrying roller includes a concave portion, and the concave portion faces the cleaning blade, it is necessary to separate the cleaning blade from the image carrying roller by a separation and contact mechanism. However, according to an aspect of the invention, since the cleaning blade is not provided as described above, the separation and contact mechanism is not required, and thus the configuration of the image carrying roller cleaning device can be made simpler.

Further, the cleaning member support portion is rotated by the third rotary shaft, and thus is positioned with respect to the image carrying roller. In that case, even when the image carrying roller includes the concave portion, the cleaning member support portion can be positioned with respect to the image carrying roller regardless of the position of the concave portion. Therefore, even when the image carrying roller moves, the cleaning member support portion follows the movement of the image carrying roller and thus can be positioned at a fixed position or a substantially fixed position with respect to the image carrying roller. Thereby, the image carrying roller cleaning roller and the cleaning solution application roller can all be positioned simply with respect to the image carrying roller. As a result, even when the image carrying roller is moved depending on the thickness of the transfer medium while maintaining the contact with a latent image carrier, or the image carrying roller is considerably moved at the time of the replacement of the latent image carrier, the positions of the image carrying roller cleaning roller and the cleaning solution application roller with respect to the image carrying roller do not nearly change. Thus, it is possible to satisfactorily maintain the cleaning solution application properties of the cleaning solution application roller, and to satisfactorily maintain the cleaning properties of the image carrying roller cleaning roller.

In addition, since the entire cleaning device is also easily separated and contacted with respect to the image carrying roller, for example, the blanket provided on the surface of the image carrying roller can be replaced through a simple operation, and thus the operability is improved.

Particularly, the cleaning member support portion is supported so as to move substantially parallel by the frame support lever supported to be rotated by the apparatus body, and thus the cleaning member support portion can be positioned more stably and more accurately with respect to the image carrying roller.

Further, the image carrying roller cleaning roller and the cleaning solution application roller are supported by the rotatable common cleaning member support portion. Therefore, the image carrying roller cleaning device including the image carrying roller cleaning roller and the cleaning solution application roller can be formed in a small and compact manner with a simple configuration. Furthermore, the image carrying roller cleaning device is formed in a small and compact manner with a simple configuration, and thus it is possible to improve the reliabilities of the image forming apparatus and the image carrying roller cleaning device and achieve space saving, and to inexpensively manufacture the image forming apparatus and the image carrying roller cleaning device.

Further, the second rotary shaft is arranged at a position located in the direction of a virtual tangent line (that is, on the line of action or the substantial line of action of the frictional force from the cleaning nip) common to the image carrying roller and the image carrying roller cleaning roller in the cleaning nip. Thereby, the frictional force can be supported by the second rotary shaft with little change. As a result, it is possible to effectively reduce the moment due to the frictional force generated between the image carrying roller and the image carrying roller cleaning roller. Therefore, it is possible to much more stably perform the cleaning of the remaining toner and the carrier solution adhering to the image carrying roller using the image carrying roller cleaning roller.

Further, the frame support lever is inclined in the direction of the virtual tangent line between the image carrying roller and the image carrying roller cleaning roller, and thus is provided inclined in the direction of the frictional force mentioned above. At the time of the cleaning operation of the image carrying roller using the image carrying roller cleaning roller, the frame support lever is applied with a compressive force by the frictional force, but the frame support lever causes a reactive force to act on the cleaning member support portion by this compressive force. At this time, the frame support lever is inclined in the direction of action of the frictional force, and thus force of a reactive force component in the direction of the image carrying roller is generated. The cleaning member support portion is much more stably brought into contact with the image carrying roller, by this force, through the first and second support rollers separated in the rotational direction of the image carrying roller.

Further, in the image forming apparatus according to another aspect of the invention, distance L1 (mm) from the rotation center of the transfer roller to the circumferential surface of the application roller when the concave portion of the transfer roller and the application roller face each other, distance L2 (mm) from the rotation center of the transfer roller to the circumferential surface of the cleaning roller when the concave portion of the transfer roller and the cleaning roller face each other, and radius R (mm) up to the circumferential surface except the concave portion of the transfer roller have a relationship of L2<L1<R. A specific configuration of the image forming apparatus having this relationship includes a first regulating roller that comes into contact with a portion to be contacted or the support portion arranged concentrically with the rotary shaft of the transfer roller to regulate the cleaning roller to a position in which the cleaning roller is penetrated into the concave portion when the concave portion of the transfer roller faces the cleaning roller, and a second regulating roller that comes into contact with the portion to be contacted to regulate the application roller to a position in which the application roller is penetrated into the concave portion when the concave portion of the transfer roller faces the application roller through the rotation of the transfer roller, radius R1 (mm) of the cleaning roller, radius R2 (mm) of the first regulating roller, radius R3 (mm) of the application roller, and radius R4 (mm) of the second regulating roller have a relationship of (R1−R2)>(R3−R4).

Therefore, when the concave portion of the transfer roller is located at a position which does not face the cleaning roller, the cleaning roller is brought into contact with the circumferential surface except the concave portion of the transfer roller. Therefore, the circumferential surface except the concave portion of the transfer roller after the image is transferred to the transfer medium can be cleaned by the cleaning roller. Thereby, it is possible to remove the remaining liquid developer (remaining toner and remaining carrier solution) adhering to the transfer roller after the transfer.

In addition, when the concave portion of the transfer roller is located at a position facing the cleaning roller, the cleaning roller is penetrated into the concave portion of the transfer roller. At this time, the first regulating roller comes into contact with the portion to be contacted or the support portion, whereby the amount of the penetration of the cleaning roller into the concave portion is regulated to a predetermined maximum amount of penetration. Therefore, using this cleaning roller, it is possible to effectively remove the remaining liquid developer (remaining toner and remaining carrier solution) having a tendency to be deposited in a region of the inclined surface of the concave portion immediately after the penetration thereof into the concave portion from the outer circumferential surface except the concave portion of the transfer roller. Thereby, it is possible to prevent the remaining liquid developer from being accumulated in the concave portion, and to prevent the remaining liquid developer from seeping from the concave portion. Further, in this manner, the remaining liquid developer is scarcely deposited in the concave portion, and thus even when the image forming apparatus is used for a long period of time, it is possible to more effectively prevent contamination of peripheral members of the transfer roller such as contamination of rollers other than the transfer roller and contamination of the transfer medium by the deposition of the remaining liquid developer in the concave portion. As a result, it is possible to prevent image defects due to the remaining liquid developer deposited in the concave portion, and to obtain a high-quality image.

Further, when the concave portion of the transfer roller is located at a position which does not face the application roller, the application roller is brought into contact with the outer circumferential surface except the concave portion of the transfer roller. Therefore, a toner removing solution for easily removing the remaining toner can be applied to the outer circumferential surface except the concave portion of the transfer roller after the transfer by the application roller. Thereby, the remaining toner adhering to the transfer roller after the transfer can be more effectively removed.

In addition, when the concave portion of the transfer roller is located at a position facing the application roller, the application roller is penetrated into the concave portion of the transfer roller. At this time, the second regulating roller comes into contact with the portion to be contacted or the support portion, whereby the amount of the penetration of the application roller into the concave portion is regulated to a second predetermined maximum amount of penetration. In that case, the difference (absolute value) between the radius of the cleaning roller and the radius of the first regulation roller is larger than the difference (absolute value) between the radius of the application roller and the radius of the second regulating roller. Therefore, with a simple structure, the maximum amount of the penetration of the cleaning roller into the concave portion on the outer circumferential surface can be made larger than the second maximum amount of the penetration of the application roller into the concave portion on the outer circumferential surface. In this manner, since the second maximum amount of the penetration of the application roller is smaller than the maximum amount of the penetration of the cleaning roller, the toner removing solution can be deposited in the region of the transfer roller as substantially mentioned above. Therefore, using the cleaning roller, it is possible to more effectively remove the toner removing solution applied to the transfer roller within the concave portion by the application roller. Thereby, it is possible to obtain a higher-quality image.

In this manner, in the image forming apparatus according to another aspect of the invention, since the remaining liquid developer is scarcely deposited in the concave portion, it is possible to eliminate the need for the web cleaning mechanism or the suction pump disclosed in JP-A-2004-317980 mentioned above, and to simplify the structure of the image forming apparatus. Since the image forming apparatus is formed with a simple structure, it is possible to realize an inexpensive image forming apparatus capable of obtaining high reliability and achieving space saving.

Further, in the image forming apparatus according to another aspect of the invention, when the concave portion of the image carrying roller that carries an image developed by the liquid developer is located at a position which does not face the cleaning member, the cleaning member is brought into contact with the circumferential surface except the concave portion of the image carrying roller. Therefore, the circumferential surface except the concave portion of the image carrying roller after the image is transferred to the transfer medium can be cleaned by the cleaning member. Thereby, it is possible to remove the remaining liquid developer (remaining toner and remaining carrier solution) adhering to the image carrying roller after the transfer. In addition, when the concave portion of the image carrying roller is located at a position facing the cleaning member, the image carrying roller cleaning member is penetrated into the concave portion of the image carrying roller by the cleaning member position regulating portion, and the amount of the penetration of the image carrying roller cleaning member into the concave portion is regulated to a predete/mined maximum amount of penetration. That is, the position of the penetration of the image carrying roller cleaning member into the concave portion is regulated by the cleaning member position regulating portion. Therefore, using this image carrying roller cleaning member, it is possible to effectively remove the remaining liquid developer (remaining toner and remaining carrier solution) having a tendency to be deposited in the region of the inclined surface of the concave portion immediately after the penetration thereof into the concave portion from the circumferential surface except the concave portion of the image carrying roller. Thereby, it is possible to prevent the remaining liquid developer from being accumulated in the concave portion, and to prevent the remaining liquid developer from seeping from the concave portion. Further, in this manner, the remaining liquid developer is scarcely deposited in the concave portion, and thus even when the image forming apparatus is used for a long period of time, it is possible to more effectively prevent contamination of peripheral members of the image carrying roller such as contamination of rollers other than the image carrying roller and contamination of the transfer medium by the deposition of the remaining liquid developer in the concave portion. As a result, it is possible to prevent image defects due to the remaining liquid developer deposited in the concave portion, and to obtain a high-quality image.

In this manner, in the image forming apparatus according to another aspect of the invention, since the remaining liquid developer is scarcely deposited in the concave portion, it is possible to eliminate the need for the web cleaning mechanism or the suction pump disclosed in JP-A-2004-317980 mentioned above, and to simplify the structure of the image forming apparatus. Since the image forming apparatus is formed with a simple structure, it is possible to realize an inexpensive image forming apparatus capable of obtaining high reliability and achieving space saving.

Further, when the concave portion of the image carrying roller is located at a position which does not face the application member that applies the carrier solution, the application member is brought into contact with the circumferential surface except the concave portion of the image carrying roller. Therefore, the carrier solution for easily removing the remaining toner can be applied to the circumferential surface except the concave portion of the image carrying roller after the transfer by the application member. Thereby, the remaining toner adhering to the image carrying roller after the transfer can be more effectively removed. In addition, when the concave portion of the image carrying roller is located at a position facing the application member, the application member is penetrated into the concave portion of the image carrying roller by the application member position regulating portion, and the amount of the penetration of the solution application member into the concave portion is regulated to a second predetermined maximum amount of penetration. In that case, since the second maximum amount of the penetration of the application member is smaller than the maximum amount of the penetration of the cleaning member, the carrier solution can be deposited in the region of the image carrying roller as substantially mentioned above. Therefore, using the application member, it is possible to more effectively remove the carrier solution applied to the image carrying roller within the concave portion by the cleaning member. Thereby, it is possible to obtain a higher-quality image.

Further, in the image forming apparatus according to another aspect of the invention, the image carrying roller to which an image developed in a development portion by the liquid developer is transferred includes a circumferential surface portion having a second diameter which is adjacent to the concave portion in the rotational direction side of the image carrying roller and does not come into contact with the latent image carrier. The second diameter is smaller than the first diameter of the circumferential surface portion of the image carrying roller which comes into contact with the latent image carrier. Therefore, it is possible to suppress the movement of the remaining toner and the remaining carrier solution from the latent image carrier to the circumferential surface portion having the second diameter of the image carrying roller. Thereby, the amounts of the remaining toner and the remaining carrier solution possibly adhering to the circumferential surface portion having the second diameter can all be made extremely small. As a result, it is possible to suppress the accumulation of the remaining toner and the remaining carrier solution into the concave portion, and to prevent them from seeping from the concave portion. Thereby, even when the image forming apparatus is used for a long period of time, it is possible to more effectively prevent contamination of peripheral members of the image carrying roller such as contamination of rollers other than the image carrying roller and contamination of the transfer medium by the accumulation of the remaining toner in the concave portion. In this manner, it is possible to eliminate the need for the web cleaning mechanism or the suction pump disclosed in JP-A-2004-317980 mentioned above, and to simplify the structure of the image forming apparatus. Since the image forming apparatus is formed with a simple structure, it is possible to realize an inexpensive image forming apparatus capable of obtaining high reliability and achieving space saving.

In addition, the image carrying roller includes a circumferential surface portion having a third diameter which does not come into contact with the latent image carrier. In the circumferential surface portion having a third diameter is not adjacent to the concave portion but is adjacent to the circumferential surface portion having the first diameter of the image carrying roller which comes into contact with the latent image carrier. In that case, the third diameter is smaller than the first diameter. The circumferential surface portion having the third diameter is provided in a non-image region, whereby it is possible to form an image with respect to two transfer mediums through one rotation of the image carrying roller, and to wear out the image forming remaining toner and the remaining carrier solution much more efficiently.

Particularly, the second diameter or the third diameter of the image carrying roller is made smaller than the first diameter of the contact portion which comes into contact with the latent image carrier, thereby allowing the accumulation of the remaining toner in the concave portion to be suppressed with a much simpler structure.

In addition, a small amount of the remaining toner and a small amount of the remaining carrier solution adhering to the circumferential surface portion having the second diameter or the third diameter are almost completely worn out by the image carrying roller cleaning member, thereby allowing the accumulation of the remaining toner in the concave portion to be efficiently suppressed. In that case, the image carrying roller cleaning roller rotating counter to the rotation of the image carrying roller is used in the image carrying roller cleaning member, thereby allowing an extremely small amount of the toner adhering to the circumferential surface portion having the second diameter or the third diameter of the image carrying roller to be effectively removed. Thereby, the accumulation of the remaining toner in the concave portion can be more efficiently suppressed with a much simpler structure.

Further, before the toner adhering to the image carrying roller is rubbed off by the image carrying roller cleaning member, a small amount of the cleaning solution is applied to the surface of the image carrying roller by the cleaning solution application portion. Thereby, the toner adhering to the surface of the image carrying roller is more easily removed, and thus the cleaning performance of the image carrying roller can be improved. In that case, the carrier solution of the liquid developer is used in the cleaning solution, whereby the cleaning is finished without using an exclusive cleaning solution. Therefore, it is possible to easily and inexpensively remove the toner adhering to the surface of the image carrying roller.

Further, a cover member that covers the opening end of the concave portion is provided. The image carrying roller cleaning member is prevented from falling into the concave portion by this cover member. Therefore, the image carrying roller can be smoothly rotated. In that case, the remaining toner is scarcely attached to the circumferential surface portion having the second diameter adjacent to the concave portion, and thus even when the cover member is provided, the attachment of the remaining toner thereto can be effectively suppressed. Therefore, the entire amount of the remaining toner possibly adhering to the cover member can be made extremely small. Thereby, it is possible to suppress the accumulation of the remaining toner in the concave portion from the cover member, and to prevent the remaining toner from seeping from the concave portion.

Further, a toner absorbing member that covers the opening end of the concave portion is provided. Therefore, a very extremely small amount of the toner can be absorbed by the toner absorbing member:

Further, in the image forming apparatus according to another aspect of the invention, the image carrying roller to which an image developed by the liquid developer is transferred includes a roller base having a concave portion on the circumferential surface and a blanket provided on the circumferential surface except the concave portion of the roller base. The blanket in a region except a predetermined region adjacent to the concave portion in the rotational direction side of the image carrying roller is formed of a first film thickness portion, and the blanket in this predetermined region is formed of a film thickness portion having a second thickness smaller than the first thickness. The film thickness portion having the second thickness is a noncontact portion which does not come into contact with the latent image carrier. Therefore, it is possible to suppress the movement of the remaining toner and the remaining carrier solution from the latent image carrier to the noncontact portion of the image carrying roller. Thereby, the amounts of the remaining toner and the remaining carrier solution possibly adhering to the noncontact portion can all be made extremely small. As a result, it is possible to suppress the accumulation of the remaining toner and the remaining carrier solution into the concave portion, and to prevent them from seeping the concave portion.

Thereby, even when the image forming apparatus is used for a long period of time, it is possible to more effectively prevent contamination of peripheral members of the image carrying roller such as contamination of rollers other than the image carrying roller and contamination of the transfer medium by the accumulation of the remaining toner in the concave portion. In this manner, it is possible to eliminate the need for the web cleaning mechanism or the suction pump disclosed in JP-A-2004-317980 mentioned above, and to simplify the structure of the image forming apparatus. Since the image forming apparatus is formed with a simple structure, it is possible to realize an inexpensive image forming apparatus capable of obtaining high reliability and achieving space saving.

In addition, the blanket in a predetermined region which is not adjacent to the concave portion is formed of a film thickness portion having a third thickness smaller than the first thickness. The film thickness portion having the third thickness is also a second noncontact portion which does not come into contact with the latent image carrier. This second noncontact portion is provided in a non-image region, whereby it is possible to form an image with respect to two transfer mediums through one rotation of the image carrying roller, and to wear out the image forming remaining toner and the remaining carrier solution much more efficiently.

Further, a small amount of the remaining toner and a small amount of the remaining carrier solution adhering to the noncontact portion are almost completely worn out by the image carrying roller cleaning member, thereby allowing the accumulation of the remaining toner in the concave portion to be efficiently suppressed. In that case, the image carrying roller cleaning roller rotating counter to the rotation of the image carrying roller is used in the image carrying roller cleaning member, thereby allowing an extremely small amount of the toner adhering to the noncontact portion of the image carrying roller to be effectively removed. Thereby, the accumulation of the remaining toner in the concave portion can be more efficiently suppressed with a much simpler structure.

Further, before the toner adhering to the image carrying roller is rubbed off by the image carrying roller cleaning member, a small amount of the cleaning solution is applied to the surface of the image carrying roller by the cleaning solution application portion. Thereby, the toner adhering to the surface of the image carrying roller is more easily removed, and thus the cleaning performance of the image carrying roller can be improved. In that case, the carrier solution of the liquid developer is used in the cleaning solution, whereby the cleaning is finished without using an exclusive cleaning solution. Therefore, it is possible to easily and inexpensively remove the toner adhering to the surface of the image carrying roller.

Further, a cover member that covers the opening circumferential surface of the concave portion is provided. The image carrying roller cleaning member is prevented from falling into the concave portion by this cover member. Therefore, the image carrying roller can be smoothly rotated. In that case, the remaining toner is scarcely attached to the noncontact portion adjacent to the concave portion, and thus even when the cover member is provided, the attachment of the remaining toner thereto can be effectively suppressed. Therefore, the entire amount of the remaining toner possibly adhering to the cover member can be made extremely small. Thereby, it is possible to suppress the accumulation of the remaining toner in the concave portion from the cover member, and to prevent the remaining toner from seeping from the concave portion.

Further, an absorbing member that covers the opening circumferential surface of the concave portion and absorbs the liquid developer is provided. Therefore, it is possible to absorb a very extremely small amount of the toner using the absorbing member.

### BRIEF DESCRIPTION OF THE DRAWINGS

The invention will be described with reference to the accompanying drawings, wherein like numbers reference like elements.

FIG. 1 is a diagram schematically and partially illustrating a first example of an image forming apparatus according to an embodiment of to the invention.

FIG. 2 is a diagram illustrating a modified example of a portion of a transfer roller cleaning portion of the first example.

FIG. 3 is a perspective view illustrating the transfer roller cleaning portion of the first example.

FIG. 4 is a diagram schematically and partially illustrating a portion of a second example of the image forming apparatus according to the embodiment of the invention.

FIG. 5 is a cross-sectional view for explaining positioning for a transfer roller of a support frame which supports a transfer roller cleaning roller of the second example.

FIG. 6 is a perspective view for explaining positioning for the transfer roller of the support frame which supports the transfer roller cleaning roller of the second example.

FIG. 7 is a partial front view for explaining positioning of the transfer roller of the support frame which supports the transfer roller cleaning roller of the second example.

FIG. 8 is a perspective view illustrating the transfer roller cleaning portion and a carrier solution application portion of the second example.

FIG. 9 is a partial perspective view partially illustrating the transfer roller cleaning portion and the carrier solution application portion of the second example.

FIG. 10A is a diagram illustrating a state where a concave portion is located at a position which does not face the transfer roller cleaning roller and the carrier solution application roller.

FIG. 10B is a diagram illustrating a state where the concave portion is located at a position facing the transfer roller cleaning roller and the carrier solution application roller.

FIG. 11A is a diagram for explaining some operations of the transfer roller cleaning roller and the carrier solution application roller of the second example.

FIG. 11B is a diagram for explaining some other operations of the transfer roller cleaning roller and the carrier solution application roller of the second example.

FIG. 11C is a diagram for explaining some other operations of the transfer roller cleaning roller and the carrier solution application roller of the second example.

FIG. 11D is a diagram for explaining some other operations of the transfer roller cleaning roller and the carrier solution application roller of the second example.

FIG. 12A is a diagram for explaining some other operations of the transfer roller cleaning roller and the carrier solution application roller of the second example.

FIG. 12B is a diagram for explaining some other operations of the transfer roller cleaning roller and the carrier solution application roller of the second example.

FIG. 12C is a diagram for explaining the rest of the operations of the transfer roller cleaning roller and the carrier solution application roller of the second example.

FIG. 13A is a diagram illustrating a state where a liquid developer deposited in the concave portion by the transfer roller cleaning roller penetrated into the concave portion of the second example is removed.

FIG. 13B is a diagram illustrating a state where the liquid developer deposited in the concave portion by the transfer roller cleaning roller is removed.

FIG. 14 is a partial perspective view partially illustrating a third example of the image forming apparatus according to the embodiment of the invention.

FIG. 15 is a diagram partially illustrating a transverse section of the transfer roller, the transfer roller cleaning roller, and the carrier solution application roller shown in FIG. 14.

FIG. 16A is a diagram for explaining some operations of a transfer roller cleaning roller and a carrier solution application roller of a third example.

FIG. 16B is a diagram for explaining some other operations of the transfer roller cleaning roller and the carrier solution application roller of the third example.

FIG. 16C is a diagram for explaining some other operations of the transfer roller cleaning roller and the carrier solution application roller of the third example.

FIG. 16D is a diagram for explaining some other operations of the transfer roller cleaning roller and the carrier solution application roller of the third example.

FIG. 17A is a diagram for explaining some other operations of the transfer roller cleaning roller and the carrier solution application roller of the third example.

FIG. 17B is a diagram for explaining some other operations of the transfer roller cleaning roller and the carrier solution application roller of the third example.

FIG. 17C is a diagram for explaining some other operations of the transfer roller cleaning roller and the carrier solution application roller of the third example.

FIG. 17D is a diagram for explaining some other operations of the transfer roller cleaning roller and the carrier solution application roller of the third example.

FIG. 18 is a cross-sectional view illustrating a transfer roller cleaning portion and a carrier solution application portion of a fourth example of the image forming apparatus according to the embodiment of the invention.

FIG. 19 is a cross-sectional view for explaining penetration of the transfer roller cleaning roller and the carrier solution application roller of the fourth example into the concave portion.

FIG. 20A is a diagram illustrating a state where a liquid developer deposited in the concave portion by the transfer roller cleaning roller penetrated into the concave portion of the fourth example is removed.

FIG. 20B is a diagram illustrating a state where the liquid developer deposited in the concave portion by the transfer roller cleaning roller of the fourth example is removed.

FIG. 21 is a partial view partially illustrating a fifth example of the image forming apparatus according to the embodiment of the invention.

FIG. 22A is a diagram illustrating a state where a concave portion of the fifth example is located at a position which does not face the transfer roller cleaning roller.

FIG. 22B is a diagram illustrating a state where the concave portion of the fifth example is located at a position facing the transfer roller cleaning roller.

FIG. 23 is a diagram schematically and partially illustrating a portion of a sixth example of the image forming apparatus according to the embodiment of the invention.

FIG. 24 is a diagram for explaining that a noncontact portion of a transfer roller of the sixth example is not in contact with a photoreceptor.

FIG. 25 is a diagram for explaining a transfer of a toner image using the transfer roller of the sixth example.

FIG. 26 is a diagram for explaining a cleaning termination of an image region of the transfer roller of the sixth example.

FIG. 27 is a diagram for explaining a wearing-out termination of the noncontact portion of the transfer roller of the sixth example.

FIG. 28 is a diagram schematically and partially illustrating a portion of a seventh example of the image forming apparatus according to the embodiment of the invention.

FIG. 29 is a diagram schematically and partially illustrating a transfer roller used in an eighth example of the image forming apparatus according to the embodiment of the invention.

FIG. 30 is a diagram schematically and partially illustrating a transfer roller used in a ninth example of the image forming apparatus according to the embodiment of the invention.

FIG. 31 is a diagram schematically and partially illustrating a portion of a tenth example of the image forming apparatus according to the embodiment of the invention.

FIG. 32 is a diagram for explaining that a noncontact portion of a transfer roller of the tenth example is not in contact with a photoreceptor.

FIG. 33 is a diagram for explaining a transfer of the toner image using the transfer roller of the tenth example.

FIG. 34 is a diagram for explaining a cleaning termination of an image region of the transfer roller of the tenth example.

FIG. 35 is a diagram for explaining a wearing-out termination of the noncontact portion of the transfer roller of the tenth example.

FIG. 36 is a diagram schematically and partially illustrating a portion of an eleventh example of the image forming apparatus according to the embodiment of the invention.

FIG. 37 is a diagram schematically and partially illustrating a transfer roller used in a twelfth example of the image forming apparatus according to the embodiment of the invention.

FIG. 38 is a diagram schematically and partially illustrating a transfer roller used in a thirteenth example of the image forming apparatus according to the embodiment of the invention.

FIG. 39 is a diagram schematically and partially illustrating a transfer roller used in a fourteenth example of the image forming apparatus according to the embodiment of the invention.

### DESCRIPTION OF EXEMPLARY EMBODIMENTS

Hereinafter, an embodiment for carrying out the invention will be described with reference to the drawings.

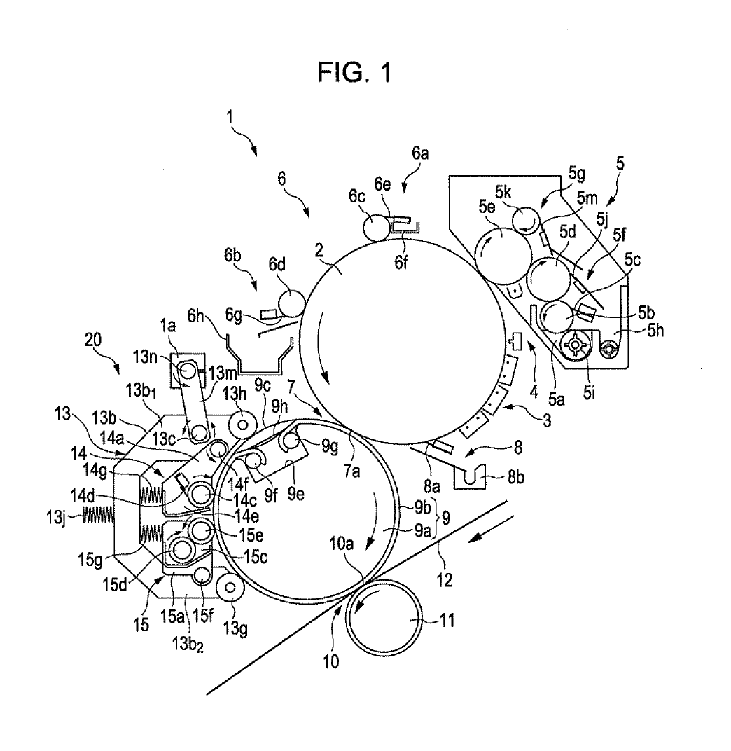

FIG. 1 is a diagram schematically and partially illustrating a portion of an image forming apparatus including a first example of the image forming apparatus according to the embodiment of the invention. In the following description, each rotational direction and each movement direction are directions shown by arrows in each of the drawings.

As shown in FIG. 1, an image forming apparatus 1 of the first example includes a photoreceptor 2 which is a latent image carrier that carries an electrostatic latent image. The photoreceptor 2 is driven by a driving source, not shown, and rotates anticlockwise.

A charging portion 3 is arranged around the photoreceptor 2. Further, an exposure portion 4, a development portion 5, a photoreceptor squeeze portion 6, a primary transfer portion 7, and a photoreceptor cleaning portion 8 are arranged in order from the charging portion 3 toward the rotational direction of the photoreceptor 2. Meanwhile, although not shown in FIG. 1, a neutralization portion that neutralizes the photoreceptor 2 is arranged between the primary transfer portion 7 and the photoreceptor cleaning portion 8.

The charging portion 3 is a charging member such as scorotron or corotron, and uniformly charges the surface of the photoreceptor 2. In addition, the exposure portion 4 is a latent image forming member such as a laser beam, and forms an electrostatic latent image on the uniformly charged surface of the photoreceptor 2.

The development portion 5 includes a liquid developer storage portion 5a, an anilox roller 5b, a developer amount regulating member 5c, an intermediate roller 5d, a developing roller 5e, an intermediate roller cleaning portion 5f, a developing roller cleaning portion 5g, and a liquid developer recovery portion 5h. The liquid developer storage portion 5a stores a liquid developer including toner and a carrier solution stirred by a stirring roller 5i. The anilox roller 5b is rotated anticlockwise and draws up the liquid developer stored in the liquid developer storage portion 5a. The developer amount regulating member 5c regulates the amount of the liquid developer drawn up by the anilox roller 5b. The intermediate roller 5d is rotated anticlockwise. The liquid developer regulated by the developer amount regulating member 5c and transported by the anilox roller 5c is supplied to the intermediate roller 5d. The developing roller 5e is rotated clockwise and the liquid developer is supplied from the intermediate roller 5d. In a development nip formed of the developing roller 5e and the photoreceptor 2, the developing roller 5e develops an electrostatic latent image formed on the photoreceptor 2 using the supplied liquid developer and forms a toner image on the photoreceptor 2.

The intermediate roller cleaning portion 5f cleans the intermediate roller 5d. That is, the intermediate roller cleaning portion 5f removes the liquid developer remaining in the intermediate roller 5d after the liquid developer is supplied to the developing roller 5e, using an intermediate roller cleaning blade 5j. The developing roller cleaning portion 5g cleans the developing roller 5e. That is, the developing roller cleaning portion 5g removes the liquid developer remaining in the developing roller 5e after the electrostatic latent image of the photoreceptor 2 is developed, using a developing roller cleaning roller 5k. The liquid developer attached to the developing roller cleaning roller 5k is removed using a developing roller cleaning blade 5m. The liquid developer recovery portion 5h recovers and stores the liquid developer removed using the intermediate roller cleaning portion 5f and the liquid developer removed using the developing roller cleaning portion 5g.

Further, the photoreceptor squeeze portion 6 includes a first photoreceptor squeeze portion 6a, a second photoreceptor squeeze portion 6b, a first photoreceptor squeeze roller 6c, a second photoreceptor squeeze roller 6d, a first photoreceptor squeeze roller cleaning blade 6e, a first photoreceptor squeeze storage portion 6f, a second photoreceptor squeeze roller cleaning blade 6g, and a second photoreceptor squeeze storage portion 6h.

The first photoreceptor squeeze roller 6c is arranged at a position away from the development nip to the rotational direction side of the photoreceptor 2 by a predetermined distance and is brought into contact with the photoreceptor 2. The first photoreceptor squeeze roller 6c squeezes the photoreceptor 2 and removes a carrier solution of the liquid developer developed from the development portion 5, toner of a non-image area, and the like. The first photoreceptor squeeze roller cleaning blade 6e cleans the first photoreceptor squeeze roller 6c, and removes the liquid developer adhering to the first photoreceptor squeeze roller 6c. The liquid developer removed by the first photoreceptor squeeze roller cleaning blade 6e is stored in the first photoreceptor squeeze storage portion 6f. The liquid developer stored in the first photoreceptor squeeze storage portion 6f is recovered in the liquid developer recovery portion 5h of the development portion 5.

The second photoreceptor squeeze roller 6d is arranged at a position away from the first photoreceptor squeeze roller 6c to the rotational direction side of the photoreceptor 2 by a predetermined distance and is brought into contact with the photoreceptor 2. The second photoreceptor squeeze roller 6d squeezes the photoreceptor 2 squeezed by the first photoreceptor squeeze roller 6c and removes the liquid developer (mainly, carrier solution). The second photoreceptor squeeze roller cleaning blade 6g cleans the second photoreceptor squeeze roller 6d, and removes the liquid developer adhering to the second photoreceptor squeeze roller 6d. The liquid developer removed by the second photoreceptor squeeze roller cleaning blade 6g is stored in the second photoreceptor squeeze storage portion 6h. The liquid developer stored in the second photoreceptor squeeze storage portion 6h is recovered in the liquid developer recovery portion 5h of the development portion 5.

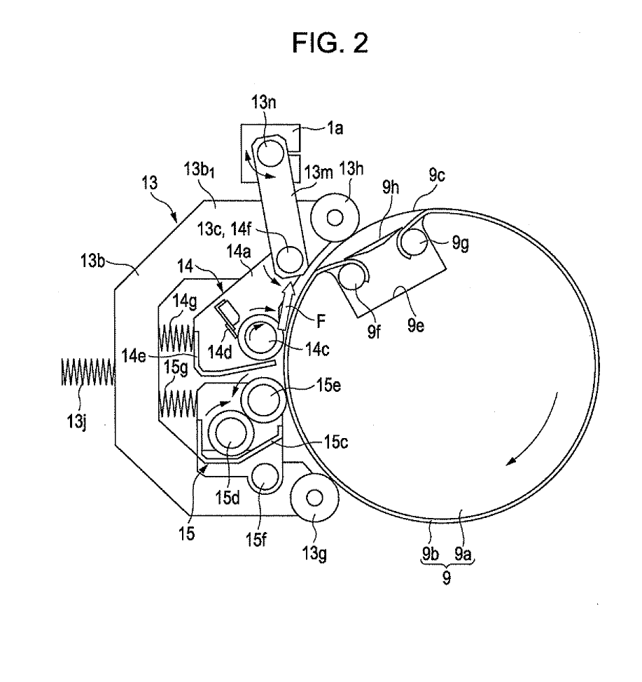

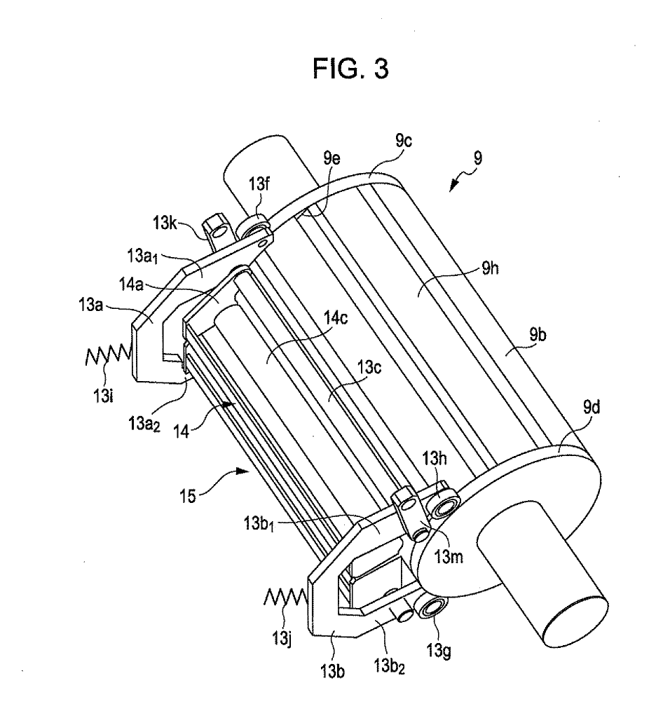

A transfer roller 9 rotating clockwise in FIG. 1 is arranged in the primary transfer portion 7. As shown in FIGS. 2 and 3, the transfer roller 9 includes a rigid columnar base 9a and a blanket seat 9b which is an elastic member such as rubber having a constant thickness or a substantially constant thickness. The base 9a includes a pair of first and second support roller contact portions 9c and 9d which are provided on both ends in the axial direction thereof and formed on the outer circumferential surface of which the transverse section is continuously circular, and a concave portion 9e provided on the outer circumferential portion between the first and second support roller contact portions 9c and 9d in the axial direction. The blanket seat 9b of which both ends are respectively wound around a pair of winding shafts 9f and 9g extending in the axial direction within the concave portion 9e is replaceably fixed. Therefore, a discontinuous portion is formed on the outer circumferential surface of the transfer roller 9 due to this concave portion 9e. The blanket seat 9b is given a predetermined tension and is windingly attached in close adhesion to a portion of the outer circumferential surface of the base 9a except the concave portion 9e and the first and second support roller contact portions 9c and 9d. In that case, the outer diameter of the blanket seat 9b attached to the outer circumferential surface of the base 9a and each outer diameter of the first and second support roller contact portions 9c and 9d are equal or substantially equal to each other.

Further, a sheet-like cover member 9h is provided in the concave portion 9e of the transfer roller 9. The cover member 9h is arranged so as to cover the opening circumferential surface of the concave portion 9e (more specifically, gap between both ends of the blanket 9b) in the vicinity of the inside of the opening end of the concave portion 9e.

In the primary transfer portion 7, the photoreceptor 2 and the transfer roller 9 are respectively positioned at a fixed position so as to have a predetermined amount of interlocking set in advance and are rotatably supported through a shaft by an apparatus body (not shown) of the image forming apparatus 1. In that case, as shown in FIG. 1, a primary transfer nip 7a is formed by interlocking the photoreceptor 2 and the transfer roller 9. The toner image transferred to the photoreceptor 2 is transferred to the transfer roller 9 by the primary transfer nip 7a. That is, in the image forming apparatus 1 of the first example, the transfer roller 9 constitutes an image carrying roller of the invention that carries the toner image developed by the liquid developer.

A secondary transfer portion 10 is arranged at a predetermined position from the primary transfer portion 7 toward the rotational direction of the transfer roller 9. The secondary transfer portion 10 includes the transfer roller 9 and a secondary transfer roller 11. The transfer roller 9 and the secondary transfer roller 11 are respectively positioned at a fixed position so as to have a predetermined amount of interlocking set in advance and are rotatably supported through a shaft by the apparatus body of the image forming apparatus 1. In that case, a secondary transfer nip 10a is formed by interlocking the transfer roller 9 and the secondary transfer roller 11. The toner image transferred to the transfer roller 9 is transferred to a transfer medium 12 such as transfer paper by the secondary transfer nip 10a. Although not shown, the toner image transferred to the transfer medium 12 by the secondary transfer portion 10 is fixed by a fixing portion similarly to an image forming apparatus in the related art in which the liquid developer is used. Thereby, an image is formed on the transfer medium 12.

The photoreceptor cleaning portion 8 cleans the photoreceptor 2. That is, the photoreceptor cleaning portion 8 removes the liquid developer remaining in the photoreceptor 2 after the primary transfer, using a photoreceptor cleaning blade 8a. The removed liquid developer is stored in a liquid developer recovery portion 8b.

As shown in FIG. 1, a transfer roller cleaning device 20 which is a cleaning device of the transfer roller 9 is arranged at the rotational direction side of the transfer roller 9 from the secondary transfer portion 10. The transfer roller cleaning device 20 cleans the outer circumferential surface of the transfer roller 9 after the secondary transfer and before the primary transfer. The transfer roller cleaning device 20 includes a cleaning member support portion 13, a remaining toner wearing-out portion, and a carrier solution application portion 15. A transfer device is constituted by the secondary transfer portion 10 and the transfer roller cleaning portion 20.

The cleaning member support portion 13 includes a pair of first and second support frames 13a and 13b, a rotary shaft 13c which is a third rotary shaft of the invention, a pair of first and second frame support levers 13k and 13m functioning as a link lever, a lever support shaft 13n, first to fourth support rollers 13e, 13f, 13g, and 13h, and support frame biasing springs 13i and 13j. The first and third support rollers 13e and 13g and the second and fourth support rollers 13f and 13h are respectively provided in the rotational direction of the transfer roller 9 with a distance apart. Therefore, the first and third support rollers 13e and 13g are constituted by a first support roller of the invention, and the second and fourth support rollers 13f and 13h are constituted by a second support roller of the invention.

The first and second support frames 13a and 13b are formed in the same shape and the same size, and are respectively formed in a substantially lateral U-shape or in a substantially U-shape having first to fourth arm portions 13a₁, 13a₂, 13b₁, and 13b₂. In that case, the first arm portion 13a₁ is located in the vertically upward direction from the second arm portion 13a₂, and the third arm portion 13b₁ is located in the vertically upward direction from the fourth arm portion 13b₂. The first and second support frames 13a and 13b are supported integrally with each other by the rotary shaft 13c in the first and third arm portions 13a₁, and 13b₁. In addition, the first and second support frames 13a and 13b are respectively connected to one end of each of the first and second frame support levers 13k and 13m through the rotary shaft 13c so as to be rotated. Each of the other ends of the first and second frame support levers 13k and 13m is provided to a support member 1a so as to be rotated through the lever support shaft 13n attached to the apparatus body of the image forming apparatus 1. Thereby, the first and second support frames 13a and 13b are configured to move substantially in parallel.

The first to fourth support rollers 13e, 13f, 13g, and 13h are respectively provided on the apical ends of the first to fourth arm portions 13a₁, 13a₂, 13b₁, and 13b₂ of the first and second support frames 13a and 13b so as to rotate located at the inner sides or the outer sides (inner sides in the illustrated example) of the corresponding first and second support frames 13a and 13b. The first and second support rollers 13e and 13f come into contact with the outer circumferential surface of a first support roller contact portion 9c of the transfer roller 9, and the third and fourth support rollers 13g and 13h come into contact with the outer circumferential surface of a second support roller contact portion 9d of the transfer roller 9. In that case, the contact position of the first support roller 13e and the first support roller contact portion 9c is located in the vertically downward direction from the contact position of the second support roller 13f and the first support roller contact portion 9c. In addition, the contact position of the third support roller 13g and the second support roller contact portion 9d is located in the vertically downward direction from the contact position of the fourth support roller 13h and the second support roller contact portion 9d.

In addition, in the state where the first to fourth support rollers 13e, 13f, 13g, and 13h come into contact with the first and second support roller contact portions 9c and 9d, the position of the rotary shaft 13c is located in the vertically upward direction from the contact position of the first support roller 13e and the first support roller contact portion 9c, and is located in the vertically downward direction from the contact position of the second support roller 13f and the second support roller contact portion 9d. In that case, the distance in the vertical direction between the position of the rotary shaft 13c and the contact position of the first support roller 13e with the first support roller contact portion 9c is longer than the distance in the vertical direction between the position of the rotary shaft 13c and the contact position of the second support roller 13f with the first support roller contact portion 9c. Similarly, the position of the rotary shaft 13c is located in the vertically upward direction from the contact position of the third support roller 13g and the second support roller contact portion 9d, and is located in the vertically upward direction from the contact position of the fourth support roller 13h and the second support roller contact portion 9d. In that case, the distance in the vertical direction between the position of the rotary shaft 13c and the contact position of the third support roller 13g with the second support roller contact portion 9d is longer than the distance in the vertical direction between the position of the rotary shaft 13c and the contact position of the fourth support roller 13h with the second support roller contact portion 9d.

The first and second biasing springs 13i and 13j are compressively provided between each of the first and second support frames 13a and 13b and the apparatus body. Each of the first and second support frames 13a and 13b is biased so as to be rotated anticlockwise centering on the rotary shaft 13c by biasing forces of the first and second biasing springs 13i and 13j, respectively. Thereby, the first to fourth support rollers 13e, 13f, 13g, and 13h come into contact with the corresponding outer circumferential surfaces of the support roller contact portions 9c and 9d of the transfer roller 9 with a predetermined contact pressure. In that case, the rotary shaft 13c is arranged between the first and second support rollers 13e and 13f in the vertical direction (direction substantially perpendicular to the movement direction of the first and second support frames 13a and 13b toward the transfer roller 9) and between the third and fourth support rollers 13g and 13h in the vertical direction, and thus the pressing force is effectively applied from each of the first and second support frames 13a and 13b to each of the first to fourth support rollers 13e, 13f, 13g, and 13h.

Therefore, the first and second support frames 13a and 13b are positioned with respect to the transfer roller 9 regardless of the position of the concave portion 9e. That is, the transfer roller 9 is rotated while maintaining a constant mutual positional relationship with the transfer roller cleaning portion 20. Furthermore, even when the transfer roller 9 moves by a predetermined amount, the first and second support frames 13a and 13b follow the movement of the transfer roller 9 due to the biasing forces of the first and second biasing springs 13i and 13j.

In the image forming apparatus 1 of the first example, a remaining toner wearing-out portion 14 functions as a transfer roller cleaning portion that cleans the transfer roller 9. The remaining toner wearing-out portion 14 is arranged at the rotational direction side of the transfer roller 9 from the secondary transfer portion 10, and at the side in the direction opposite to the rotational direction side of the transfer roller 9 from the primary transfer portion 7. The remaining toner wearing-out portion 14 is provided between the first and second support frames 13a and 13b. The remaining toner wearing-out portion 14 includes first and second cleaning portion body frames 14a and 14b, a transfer roller cleaning roller 14c, a transfer roller cleaning blade 14d, a recovery portion 14e of the liquid developer of the transfer roller 9, a rotary shaft 14f which is a second rotary shaft of the invention or a shaft member of the invention, and first and second cleaning portion body biasing springs 14g and 14h (sign 14h is not shown in the drawing, but denotes a second cleaning portion body biasing spring arranged at the second support frame 13b side, and is the same as the first cleaning portion body biasing spring 14g arranged at the first support frame 13b side; for the purpose of description, sign 14h is used in the specification).

The first and second cleaning portion body frames 14a and 14b are provided in the second and fourth arm portions 13a₂ and 13b₂ of the first and second support frames 13a and 13b so as to be rotated through the rotary shaft 14f. In that case, the rotary shaft 14f is arranged in the vicinity of the rotary shaft 13c of the first and second frame support levers 13k and 13m.

The transfer roller cleaning roller 14c is provided in the first and second cleaning portion body frames 14a and 14b so as to be rotated. At least the surface layer of the transfer roller cleaning roller 14c is formed of an elastic material such as rubber. The transfer roller cleaning blade 14d is brought into contact with the transfer roller cleaning roller 14c and is provided in the first and second cleaning portion body frames 14a and 14b. The liquid developer recovery portion 14e is provided in the first and second cleaning portion body frames 14a and 14b.

The first and second cleaning portion biasing springs 14g and 14h are respectively compressively provided so as to be expanded and contracted between the first and second support frames 13a and 13b and the first and second cleaning portion body frames 14a and 14b. Therefore, the first and second cleaning portion body frames 14a and 14b are biased so as to be rotated centering on the rotary shaft 14f by the biasing forces of the corresponding first and second cleaning portion body biasing springs 14g and 14h. Thereby, the transfer roller cleaning roller 14c comes into contact with the blanket seat 9b on the continuous outer circumferential surface of the transfer roller 9 except the concave portion 9e with the contact force having a predetermined constant load set in advance. Thereby, a cleaning nip is formed between the transfer roller 9 and the transfer roller cleaning roller 14c. In addition, the transfer roller cleaning roller 14c rotates counter to the rotation of the transfer roller 9 in the state where it comes into contact with the blanket seat 9b of the transfer roller 9.

The transfer roller cleaning roller 14c rotates counter to the rotation of the transfer roller 9, whereby frictional force F acts on the transfer roller cleaning roller 14c due to friction with the transfer roller 9 in the cleaning nip as shown in FIG. 2. The frictional force F acts in the direction (direction shown by an arrow in FIG. 2) on the rotational direction side of the transfer roller 9 which is a direction of a virtual tangent line common to the transfer roller 9 and the transfer roller cleaning roller 14C in the cleaning nip. For this reason, when the elastic material of the transfer roller cleaning roller 14c is flexible, it is pushed to the rotational direction side of the transfer roller 9 due to this frictional force, and thus the cleaning operation of the transfer roller cleaning roller 14c is not stabilized. Consequently, in order for the transfer roller cleaning roller 14c to perform the cleaning operation stably, an elastic material having a relatively high rigidity is used in the transfer roller cleaning roller 14c. Thereby, the surface layer of the transfer roller cleaning roller 14c is maintained at high rigidity.

In addition, in the image forming apparatus 1 of the first example, the rotary shaft 14f is arranged at a position located on the line of action or the substantial line of action (that is, direction of a virtual tangent line common to the transfer roller 9 and the transfer roller cleaning roller 14c in the cleaning nip) of the frictional force F from the cleaning nip in the state where the transfer roller cleaning roller 14c and a carrier solution application roller 15e described later which are shown in FIG. 2 come into contact with the blanket seat 9b of the transfer roller 9. Thereby, the frictional force F is supported by the rotary shaft 14f through the first and second cleaning portion body frames 14a and 14b with little change. As a result, the moment acting on the first and second cleaning portion body frames 14a and 14b by the frictional force F is reduced. Therefore, the transfer roller cleaning roller 14c supported by the first and second cleaning portion body frames 14a and 14b is stably brought into contact with the transfer roller 9.

Further, the rotary shaft 14f is arranged in the vicinity of the rotary shaft 13c of the first and second frame support levers 13k and 13m, thereby allowing the moment acting on the first and second support frames 13a and 13b by the frictional force F to be effectively reduced. Particularly, in the case of a cleaning method using the transfer roller cleaning roller 14c, it is necessary to increase the contact force of the transfer roller cleaning roller 14c with the transfer roller 9 as compared to the cleaning method using the cleaning blade in order to secure satisfactory cleaning properties. Further, since the contact between the transfer roller cleaning roller 14c and the blanket seat 9b is a contact between materials having a relatively high coefficient of friction, and the transfer roller cleaning roller 14c rotates in the counter direction to the rotational direction of the transfer roller 9, the frictional force F is forced to be increased. However, as described above, since the rotary shaft 14f is arranged in the vicinity of the rotary shaft 13c, it is possible to reduce the moment due to the frictional force F, and to reduce the influence.

Further, the rotary shaft 13 of the first and second frame support levers 13k and 13m is located in the vicinity of the rotary shaft 14f, and thus the moment due to the frictional force F applied to the first and second frame support levers 13k and 13m is reduced. Thereby, the first and second support frames 13a and 13b are stably brought into contact with the transfer roller 9 through the first to fourth support rollers 13e, 13f, 13g, and 13h. Particularly, as shown in FIGS. 2 and 3, the rotary shaft 13c and the rotary shaft 14f are formed concentrically with each other, whereby the moment due to the frictional force F applied to the first and second frame support levers 13k and 13m is scarcely generated, and the first and second support frames 13a and 13b are much more stably brought into contact with the transfer roller 9 through the first to fourth support rollers 13e, 13f, 13g, and 13h.

Further, the first and second frame support levers 13k and 13m are provided so as to be slightly inclined in the direction of the frictional force F. The first and second frame support levers 13k and 13m are applied with the compressive force due to the frictional force F. At this time, the first and second frame support levers 13k and 13m causes a reactive force to act on the first and second support frames 13a and 13b due to this compressive force. Consequently, as described above, the first and second frame support levers 13k and 13m are inclined in the direction of the frictional force F, and thus force of a reactive force component in the direction of the transfer roller 9 is generated. The first and second support frames 13a and 13b are much more stably brought into contact with the transfer roller 9 through the first to fourth support rollers 13e, 13f, 13g, and 13h by this force.

The carrier solution application portion 15 is a cleaning solution application portion. The carrier solution application portion 15 is arranged at the rotational direction side of the transfer roller 9 from the secondary transfer portion 10 and at the side in the direction opposite to the rotational direction side of the transfer roller 9 from the remaining toner wearing-out portion 14. The carrier solution application portion 15 includes first and second application portion body frames 15a and 15b, a carrier solution storage portion 15c, a carrier solution supply roller 15d, a carrier solution application roller 15e, a rotary shaft 15f which is a first rotary shaft of the invention, and first and second application portion body biasing springs 15g and 15h (sign 15h is not shown in the drawing, but denotes a second application portion body biasing spring arranged at the second support frame 13b side, and is the same as the first application portion body biasing spring 15g arranged at the first support frame 13b side; for the purpose of description, sign 15h is used in the specification).

The first and second application portion body frames 15a and 15b are provided in the second and fourth arm portions 13a₂ and 13b₂ of the first and second support frames 13a and 13b so as to be rotated through the rotary shaft 15f. In that case, the distance between the rotary shaft 13c and the rotary shaft 15f of the first and second application portion body frames 15a and 15b is much longer than the distance between the rotary shaft 13c and the rotary shaft 14f of the first and second cleaning portion body frames 14a and 14b. That is, the rotary shaft 14f is closer to the rotary shaft 13c than the rotary shaft 15f.

The carrier solution storage portion 15c is provided in the first and second application portion body frames 15a and 15b, and stores a carrier solution which is a cleaning solution applied to the transfer roller 9. The carrier solution supply roller 15d is provided in the first and second application portion body frames 15a and 15b so as to be rotated. The carrier solution supply roller 15d draws up the carrier solution stored in the carrier solution storage portion 15c by rotation to supply the carrier solution to the carrier solution application roller 15e.

The carrier solution application roller 15e is brought into contact with the carrier solution supply roller 15d and is provided in the first and second application portion body frames 15a and 15b. The carrier solution supply roller 15d and the carrier solution application roller 15e are provided so as to be trail-rotated with each other, and the carrier solution application roller 15e is trail-rotated with respect to the rotation of the transfer roller 9.

In addition, the carrier solution application roller 15e is arranged so as to be located in the vertically downward direction from the transfer roller cleaning roller 14c. Specifically, the contact position of the carrier solution application roller 15e with the transfer roller 9 is arranged so as to be located in the vertically downward direction from the contact position of the transfer roller cleaning roller 14c with the transfer roller 9.

The first and second application portion biasing springs 15g and 15h are respectively compressively provided so as to be expanded and contracted between the first and second support frames 13a and 13b and the first and second application portion body frames 15a and 15b. Thereby, the first and second application portion body biasing springs 15g and 15h cause the biasing force to act on the corresponding first and second application portion body frames 15a and 15b.

The first and second application portion body frames 15a and 15b are biased so as to be rotated centering on the rotary shaft 15f by the biasing forces of the corresponding first and second application portion body biasing springs 15g and 15h. Thereby, the carrier solution application roller 15e comes into contact with the blanket seat 9b on the continuous outer circumferential surface of the transfer roller 9 except the concave portion 9e with a predetermined constant load set in advance. At this time, the contact load of the carrier solution application roller 15e with the transfer roller 9 is smaller than the contact load of the transfer roller cleaning roller 14c with the transfer roller 9. In addition, since the carrier solution is interposed between the carrier solution application roller 15e and the transfer roller 9, the frictional force is scarcely generated between the carrier solution application roller 15e and the transfer roller 9. Therefore, force due to the frictional force is scarcely applied to the rotary shaft 15f.

In addition, when the concave portion 9e is located at a position facing the carrier solution application roller 15e, the carrier solution application roller 15e is penetrated into the concave portion 9e. In that case, the amount of penetration of the carrier solution application roller 15e is regulated to a predetermined maximum amount of penetration smaller than the maximum amount of penetration of the transfer roller cleaning roller 14c into the concave portion 9e mentioned above.

In the image forming apparatus 1 of the first example, the maximum distance between the rotary shaft 13c which is a rotation fulcrum of the first and second support frames 13a and 13b and the transfer roller cleaning roller 14c is shorter than the minimum distance between the rotary shaft 13n and the carrier solution application roller 15e. That is, the amount of movement of the transfer roller cleaning roller 14c by the rotation of the first and second support frames 13a and 13b centering on the rotary shaft 13n is smaller than the amount of movement of the carrier solution application roller 15e by the rotation of the first and second support frames 13a and 13b centering on the rotary shaft 13n.

Thereby, the transfer roller cleaning roller contact force of the transfer roller cleaning roller 14c with the transfer roller 9 by the biasing forces of the first and second cleaning portion body biasing springs 14g and 14h and the carrier solution application roller contact force of the carrier solution application roller 15e with the transfer roller 9 by the biasing forces of the first and second application portion body biasing springs 15g and 15h are equal or substantially equal to each other, the transfer roller cleaning roller contact force becomes larger than the carrier solution application roller contact force. Thereby, the remaining liquid developer (remaining toner or remaining carrier solution) and the applied carrier solution which remain in the transfer roller 9 after the secondary transfer scarcely passes between the transfer roller cleaning roller 14c and the transfer roller 9. As a result, the cleaning properties of the transfer roller 9 using the transfer roller cleaning roller 14c are improved. In addition, the carrier solution application roller contact force is relatively small, and thus the application properties of the carrier solution using the carrier solution application roller 15e are improved. Thus, even when the first and second support frames 13a and 13b are commonly used in the transfer roller cleaning portion 14 and the carrier solution application portion 15, satisfactory cleaning properties of the transfer roller 9 and satisfactory carrier solution application properties to the transfer roller 9 are realized.

Particularly, in the image forming apparatus 1 of the first example, the transfer roller cleaning roller 14c is closer to the rotary shaft 13 than the carrier solution application roller 15e. Therefore, the transfer roller cleaning roller contact force of the transfer roller cleaning roller 14c with the transfer roller 9 by the biasing forces of the first and second cleaning portion body biasing springs 14g and 14h can be made larger than the contact force of the carrier solution application roller 15e with the transfer roller 9 by the biasing forces of the first and second application portion body biasing springs 15g and 15h.

Thereby, even when the first and second support frames 13a and 13b are commonly used in the transfer roller cleaning portion 14 and the carrier solution application portion 15, the cleaning properties of the transfer roller 9 and the carrier solution application properties to the transfer roller 9 can all be further improved.

According to the image forming apparatus 1 of the first example having such a configuration, the carrier solution is applied to the outer circumferential surface of the transfer roller 9 passing through the secondary transfer nip 10a by the carrier solution application roller 15e. Thereby, the adhesion of remaining toner which remains in the outer circumferential surface of the transfer roller 9 after the secondary transfer is weakened. Therefore, the remaining toner and the carrier solution in which the adhesion is weakened can be effectively rubbed off from the outer circumferential surface of the transfer roller 9 by the transfer roller cleaning roller 14c.

In addition, the rotary shaft 14f of the first and second cleaning portion body frames 14a and 14b is provided in the vicinity of the rotary shaft 13c of the cleaning member support portion 13, and the rotary shaft 15f of the first and second application portion body frames 15a and 15b is provided at a position further away from the rotary shaft 13c than the rotary shaft 14f. Therefore, since the transfer roller cleaning roller 14c is closer to the rotary shaft 13c than the carrier solution application roller 15e, rigidity is easily secured, and the power relationship is stabilized. Thereby, it is possible to stably increase the surface pressure of the transfer roller cleaning roller 14c against the transfer roller 9. Further, the rotary shaft 14f is arranged in the vicinity of the rotary shaft 13c, whereby it is possible to decrease the moment due to the frictional force F generated in the cleaning nip between the transfer roller 9 and the transfer roller cleaning roller 14e. Thereby, the chatter vibration of the transfer roller cleaning roller 14e is not easily generated. Thereby, it is possible to reduce the surface pressure of the carrier solution application roller 15e against the transfer roller 9. As a result, it is possible to obtain satisfactory carrier solution application properties by the carrier solution application roller 15e and satisfactory cleaning properties by the transfer roller cleaning roller 14c with a simple structure.

Further, in this manner, satisfactory cleaning properties by the transfer roller cleaning roller 14c are obtained, thereby allowing the cleaning to be finished without using the cleaning blade. Thereby, damage to the blanket seat 9b of the transfer roller 9 can be suppressed. Thereby, the configuration of the transfer roller cleaning portion 20 can be made simpler. Particularly, when the concave portion 9e is included as in the transfer roller 9 of the image forming apparatus 1 of the first example, and the concave portion 9e faces the cleaning blade, it is necessary to separate the cleaning blade from the transfer roller 9 by a separation and contact mechanism. However, since the cleaning blade is not provided in this manner, the separation and contact mechanism is not required, and thus the configuration of the transfer roller cleaning portion 20 can be made simpler.

Further, the cleaning member support portion 13 that supports the remaining toner wearing-out portion 14 and the carrier solution application portion 15 is supported by the first and second frame support levers 13k and 13m to be rotated. The first to fourth support rollers 13e, 13f, 13g, and 13h provided in the cleaning member support portion 13 are brought into contact with the first and second support roller contact portions 9c and 9d of the transfer roller 9 by the biasing force of the support frame biasing spring 13i. Thereby, the first and second support frames 13a and 13b can be positioned with respect to the transfer roller 9. Particularly, in the image forming apparatus 1 of the first example, the transfer roller 9 has the concave portion 9e in order to be capable of replace the blanket seat 9b, but the first and second support frames 13a and 13b can be positioned with respect to the transfer roller 9 regardless of the position of the concave portion 9e. Therefore, even when the transfer roller 9 moves, the first and second frame support levers 13k and 13m follow the movement of the transfer roller 9 and thus can be positioned with respect to the transfer roller 9 to a fixed position or a substantially fixed position. Thereby, the transfer roller cleaning roller 14c and the carrier solution application roller 15e can all be positioned with respect to the transfer roller 9 simply. As a result, even when the transfer roller 9 slightly moves due to the replacement or the thickness of the transfer medium, the positions of the transfer roller cleaning roller 14c and the carrier solution application roller 15e with respect to the transfer roller 9 does not nearly change. Thus, it is possible to satisfactorily maintain the carrier solution application properties of the carrier solution application roller 15e, and to satisfactorily maintain the cleaning properties of the transfer roller cleaning roller 14c.

Particularly, the cleaning member support portion 13 is supported by the first and second frame support levers 13k and 13m rotating centering on the rotary shaft 13n so as to move substantially in parallel. Therefore, the cleaning member support portion 13 can be positioned with respect to the transfer roller 9 more stably and more accurately.

Further, the transfer roller cleaning roller 14c and the carrier solution application roller 15e are supported by the rotatable common first and second support frames 13a and 13b. Therefore, the transfer roller cleaning portion 20 including the transfer roller cleaning roller 14c and the carrier solution application roller 15 can be formed with a simple small and compact configuration. Further, the transfer roller cleaning portion 20 is formed with a simple small and compact configuration, whereby it is possible to improve reliabilities of the image forming apparatus 1 and the transfer roller cleaning portion 20, to achieve space saving, and further to inexpensively manufacture the image forming apparatus 1 and the transfer roller cleaning portion 20.

Further, the rotary shaft 14f of the first and second cleaning portion body frames 14a and 14b is arranged in the vicinity of the rotary shaft 13c of the first and second support frames. Therefore, it is possible to reduce the moment acting on the first and second support frames 13a and 13b due to the frictional force F generated in the cleaning nip between the blanket seat 9b of the transfer roller 9 and the transfer roller cleaning roller 14c. Thereby, it is possible to stably perform the application of the carrier solution using the carrier solution application roller 15e, and to stably perform the cleaning of the remaining toner and the carrier solution adhering to the transfer roller 9 using the transfer roller cleaning roller 14c.

Further, the rotary shaft 14f of the first and second cleaning portion body frames 14a and 14b is arranged at a position located on the line of action or the substantial line of action (that is, direction of a virtual tangent line common to the transfer roller 9 and the transfer roller cleaning roller 14c in the cleaning nip) of the frictional force F from the cleaning nip. Thereby, the frictional force F can be supported by the rotary shaft 14f through the first and second cleaning portion body frames 14a and 14b with little change. As a result, it is possible to effectively reduce the moment acting on the first and second cleaning portion body frames 14a and 14b by the frictional force F generated between the transfer roller 9 and the transfer roller cleaning roller 14c. Therefore, it is possible to much more stably perform the cleaning of the remaining toner and the carrier solution adhering to the transfer roller 9 using the transfer roller cleaning roller 14c.

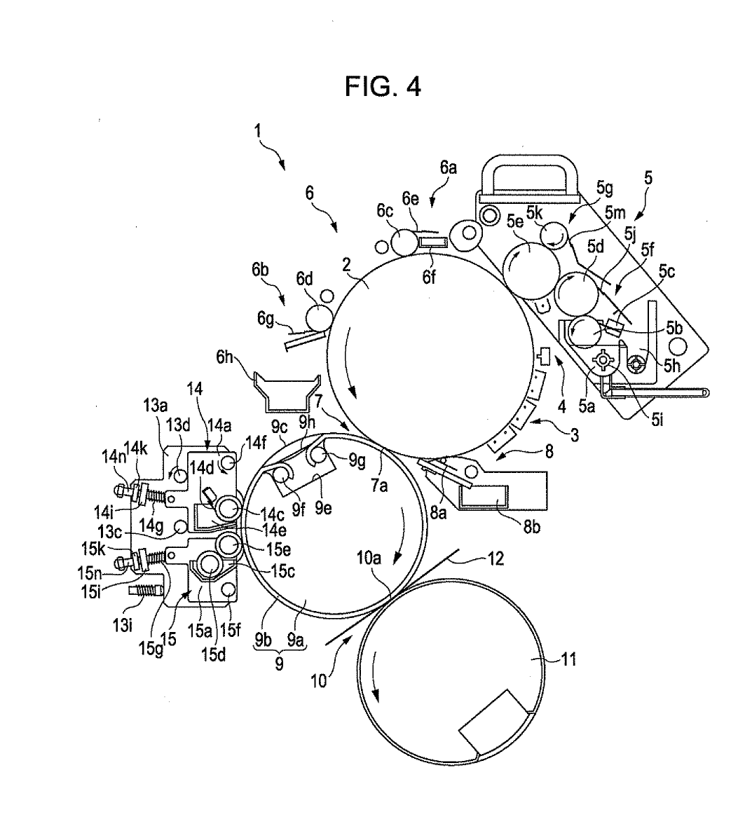

FIG. 4 is a diagram schematically and partially illustrating a second example of the image forming apparatus according to the embodiment of the invention. In the following description of each example of the embodiment, the components same as those of the example described prior to the corresponding example are assigned the same reference signs, and thus a detailed description of these components will be omitted.

As shown in FIG. 4, in the image forming apparatus 1 of the second example, similarly to the above-mentioned first example, the blanket seat 9b is given a predetermined tension and is windingly attached in close adhesion to a portion of the outer circumferential surface of the base 9a except the concave portion 9e and the first and second support roller contact portions 9c and 9d. In that case, the outer diameter of the blanket seat 9b attached to the outer circumferential surface of the base 9a and each outer diameter of the first and second support roller contact portions 9c and 9d are equal or substantially equal to each other. In addition, both ends of the blanket seat 9b located within the concave portion 9e are formed of inclined surfaces 9r and 9s which are inclined so as to come close to each other with progress into the concave portion 9e.

In addition, the outer circumferential surface of the cover member 9h that covers the opening circumferential surface of the concave portion 9e is formed in an arc concentric with the transfer roller 9. The cover member 9h prevents the transfer roller cleaning roller 14c from falling to the opening circumferential surface of the concave portion 9e.

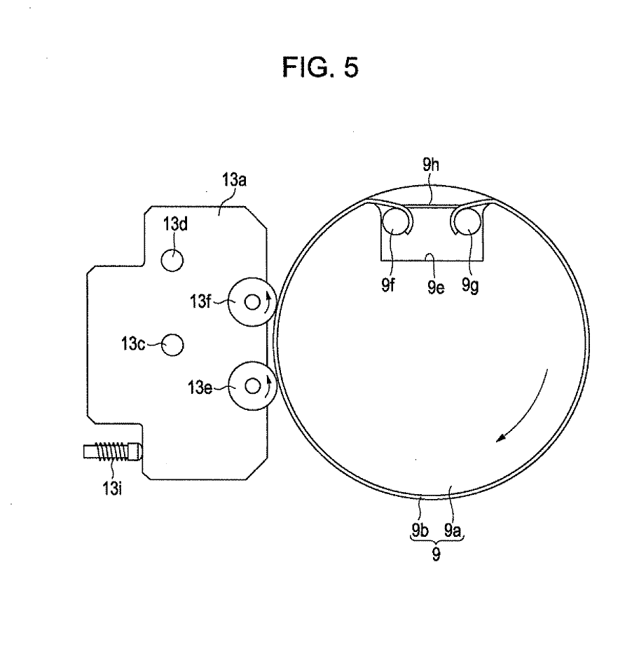

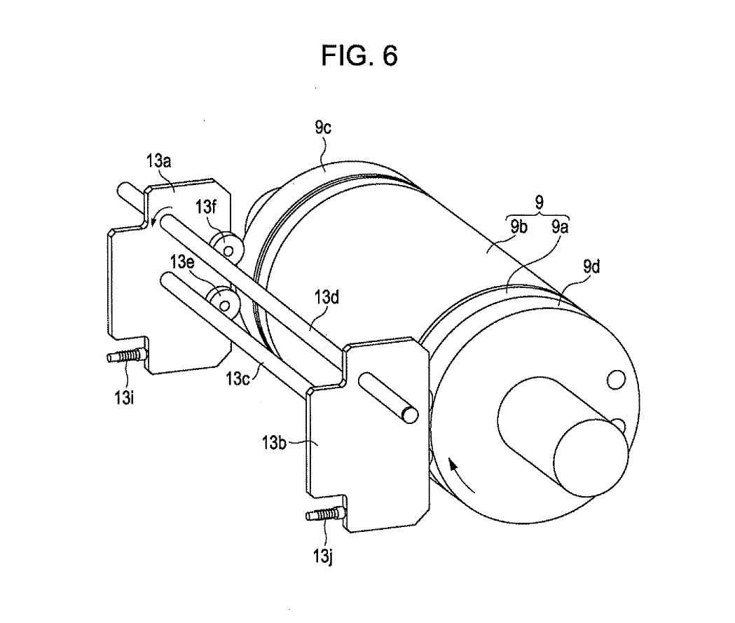

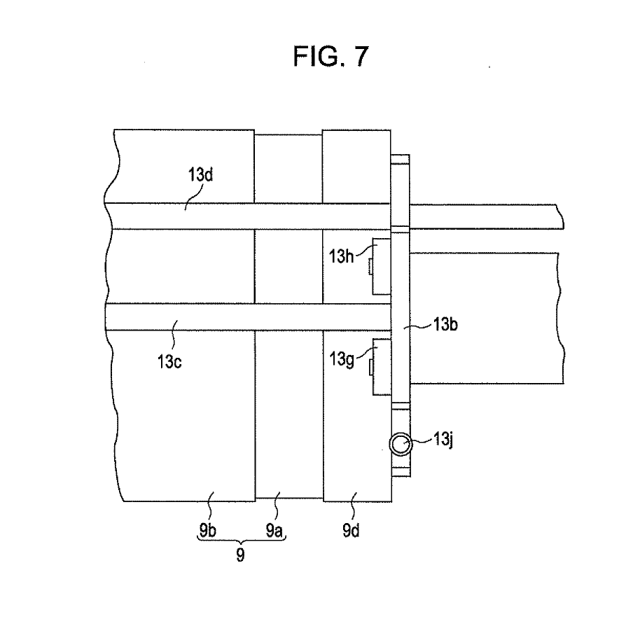

As shown in FIGS. 4 to 7, in the image forming apparatus 1 of the second example, a pair of first and second support frames 13a and 13b are provided in the apparatus body (not shown) of the image forming apparatus 1 from the secondary transfer portion 10 to the rotational direction side of the transfer roller 9. In that case, the first and second support frames 13a and 13b are connected integrally with each other through the connecting shaft 13c. In addition, the first and second support frames 13a and 13b are provided in the apparatus body so as to be integrally rotated by a rotary shaft 13d. The first to fourth rollers 13e, 13f, 13g, and 13h are respectively provided in the first and second support frames 13a and 13b so as to rotate located on the facing surfaces (inner sides) of the corresponding first and second support frames 13a and 13b. In that case, the first and second rollers 13e and 13f come into contact with the outer circumferential surface of one roller support portion 9c of the transfer roller 9, and the third and fourth rollers 13g and 13h come into contact with the outer circumferential surface of the other roller support portion 9d of the transfer roller 9.

The first and second biasing springs 13i and 13j are compressively provided between each of the first and second support frames 13a and 13b and the apparatus body. Each of the first and second support frames 13a and 13b is biased so as to be rotated anticlockwise centering on the rotary shaft 13d by the biasing forces of the first and second biasing springs 13i and 13j, respectively. Thereby, the first to fourth rollers 13e, 13f, 13g, and 13h come into contact with the corresponding outer circumferential surfaces of the roller support portions 9c and 9d of the transfer roller 9. Therefore, the first and second support frames 13a and 13b are positioned with respect to the transfer roller 9 regardless of the position of the concave portion 9e.

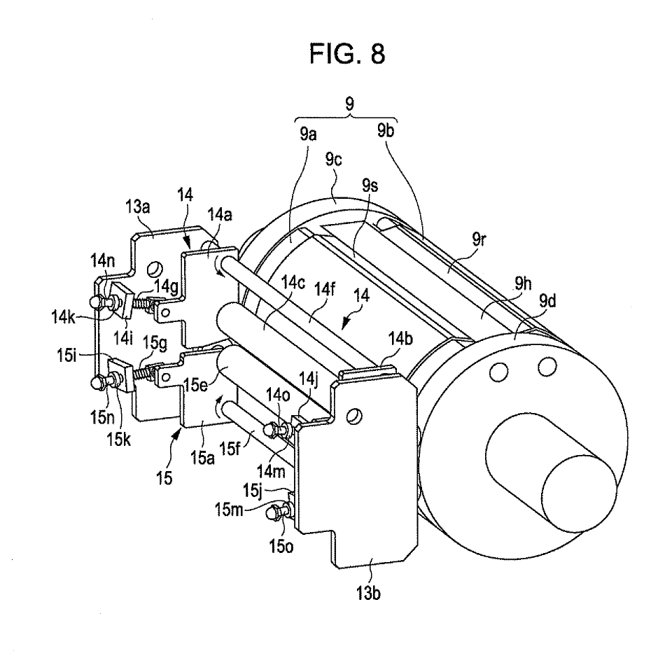

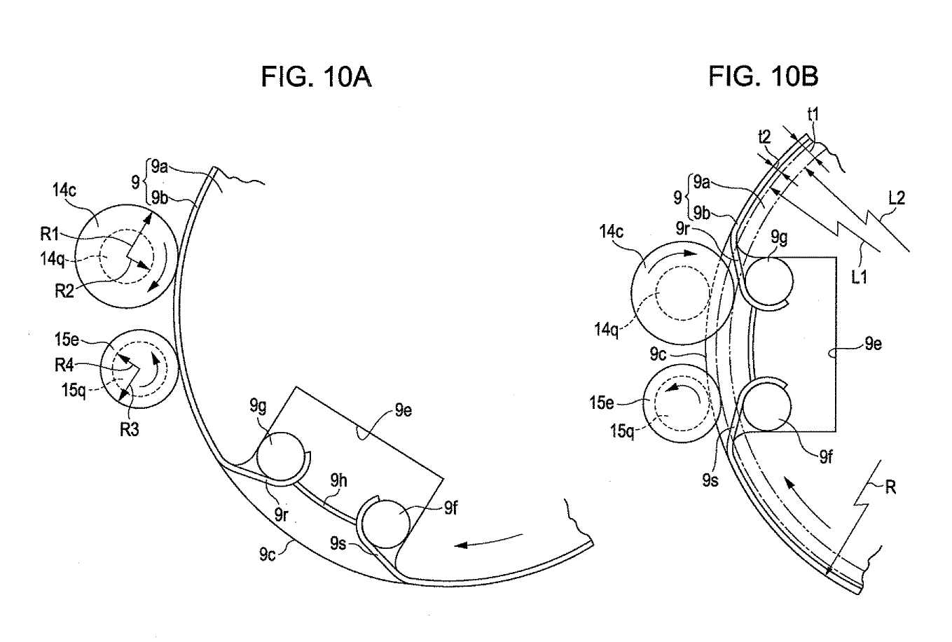

As shown in FIGS. 4, 8, and 9, the transfer roller cleaning portion 14 is arranged between the first and second support frames 13a and 13b from the primary transfer portion 7 in the direction side opposite to the rotational direction of the transfer roller 9 (since the transfer roller cleaning portion performs the cleaning of the transfer roller 9 similarly to the remaining toner wearing-out portion 14 of the first example mentioned above, the same sign is used in the transfer roller cleaning portion for the purpose of description). In addition to the transfer roller cleaning portion 14 of the first example, the transfer roller cleaning portion 14 further includes first and second transfer roller cleaning roller contact load setting members 14i and 14j, first and second transfer roller cleaning roller contact load adjusting members 14k and 14m, first and second transfer roller cleaning roller contact load setting shanks 14n and 140, a rotary shaft 14p on both ends of the transfer roller cleaning roller 14c, and roller-like (cylindrical) first and second rollers 14q and 14r on the cleaning roller side (sign 14q is shown in FIGS. 10A and 10B) which are a first regulating roller of the invention.

The first and second cleaning portion body biasing springs 14g and 14h are compressively provided between the corresponding first and second cleaning portion body frames 14a and 14b and the first and second transfer roller cleaning roller contact load setting members 14i and 14j. The first and second cleaning portion body biasing springs 14g and 14h bias the first and second cleaning portion body frames 14a and 14b so that the first and second cleaning portion body frames 14a and 14b rotate centering on the rotary shaft 14f and the transfer roller cleaning roller 14c comes into contact with the transfer roller 9.

The first and second transfer roller cleaning roller contact load setting members 14i and 14j are fixed to the corresponding first and second support frames 13a and 13b. The first and second transfer roller cleaning roller contact load setting members 14i and 14j support each one end of the first and second cleaning portion body biasing springs 14g and 14h. Thereby, the contact load of the transfer roller cleaning roller 14c with the transfer roller 9 by the biasing forces of the first and second cleaning portion body biasing springs 14g and 14h is set to a constant load. In that case, the contact force of the transfer roller cleaning roller 14c with the transfer roller 9 is relatively large. Thereby, since the transfer roller cleaning roller 14c interlocks with the transfer roller 9 by a predetermined amount set in advance, the remaining liquid developer (remaining toner and remaining carrier solution) and the applied carrier solution which remain in the transfer roller 9 after the secondary transfer scarcely passes between the transfer roller cleaning roller 14c and the transfer roller 9. As a result, the cleaning properties of the transfer roller 9 using the transfer roller cleaning roller 14c are improved.

The first and second transfer roller cleaning roller contact load adjusting members 14k and 14m are threadably mounted on threaded portions (not shown) of the first and second transfer roller cleaning roller contact load setting shanks 14n and 140, respectively. The first and second transfer roller cleaning roller contact load adjusting members 14k and 14m are brought into contact with the first and second transfer roller cleaning roller contact load setting members 14i and 14j by the biasing forces of the first and second cleaning portion body biasing springs 14g and 14h.

The first transfer roller cleaning roller contact load setting shank 14n slidably passes through the corresponding first transfer roller cleaning roller contact load setting member 14i and is relatively rotatably connected to the first cleaning portion body frame 14a. The second transfer roller cleaning roller contact load setting shank 14o slidably passes through the corresponding second transfer roller cleaning roller contact load setting member 14j and is relatively rotatably connected to the second cleaning portion body frame 14b. In addition, the first and second transfer roller cleaning roller contact load setting shanks 14n and 140 fit and support the first and second cleaning portion biasing springs 14g and 14h, respectively. The first and second transfer roller cleaning roller contact load adjusting members 14k and 14m are rotated, whereby the biasing forces of the first and second cleaning portion body biasing springs 14g and 14h are adjusted. In this manner, the biasing forces of the first and second cleaning portion body biasing springs 14g and 14h are adjusted, whereby the contact load of the transfer roller cleaning roller 14c with the transfer roller 9 by the biasing forces of the first and second cleaning portion body biasing springs 14g and 14h is adjusted to a desired value.

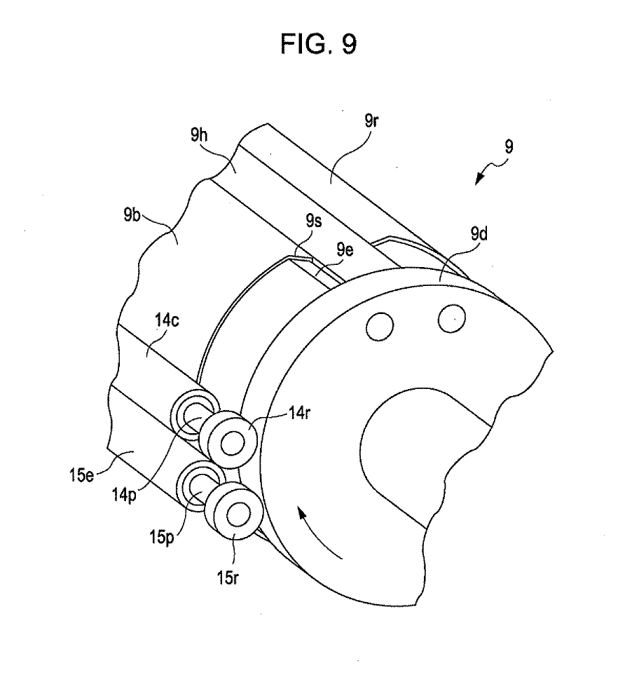

As shown in FIG. 9, the first and second rollers 14q and 14r on the cleaning roller side are respectively rotatably provided on the rotary shaft 14p on both ends of the transfer roller cleaning roller 14c concentrically or substantially concentrically with the transfer roller cleaning roller 14c. As shown in FIG. 10A, when the transfer roller cleaning roller 14c is located at a position coming into contact with the blanket seat 9b on the continuous outer circumferential surface except the concave portion 9e of the transfer roller 9, the first and second rollers 14q and 14r on the cleaning roller side are separated from the first and second roller support portions 9c and 9d, respectively.

In addition, as shown in FIG. 10B, when the concave portion 9e which is a discontinuous portion on the outer circumferential surface of the transfer roller 9 is located at a position facing the transfer roller cleaning roller 14c, the blanket seat 9b is penetrated into the concave portion 9e, and thus the first and second cleaning portion body frames 14a and 14b are rotated in the direction in which the transfer roller cleaning roller 14c is penetrated into the concave portion 9e by the biasing forces of the first and second cleaning portion body biasing springs 14g and 14h. Then, the transfer roller cleaning roller 14c is penetrated into the concave portion 9e while coming into contact with the inclined surface 9r of the blanket seat 9b within the concave portion 9e. The first and second rollers 14q and 14r on the cleaning roller side come into contact with the first and second roller support portions 9c and 9d. At this time, as described above, the first and second support frames 13a and 13b are positioned with respect to the transfer roller 9 regardless of the position of the concave portion 9e. As a result, the penetration of the transfer roller cleaning roller 14c into the concave portion 9e is regulated, and the transfer roller 9 is separated from the blanket seat 9b by rotation. In that case, the transfer roller cleaning roller 14c does not come into contact with the cover member 9h. The maximum amount of the penetration of the transfer roller cleaning roller 14c into the concave portion 9e on the outer circumferential surface is regulated to the maximum amount of penetration t1.

Further, as shown in FIGS. 4, 8, FIG. 9, the carrier solution application portion 15 which is a toner removing solution application portion is arranged at the rotational direction side of the transfer roller 9 from the secondary transfer portion 10 and at the side in the direction opposite to the rotational direction side of the transfer roller 9 from the transfer roller cleaning portion 14. The carrier solution application portion 15 includes the first and second application portion body frames 15a and 15b, the carrier solution storage portion 15c, the carrier solution supply roller 15d, the carrier solution application roller 15e, the rotary shaft 15f, the first and second application portion body biasing springs 15g and 15h (sign 15h is not shown in the drawing, but denotes a second application portion body biasing spring arranged at the second support frame 13b side, and is the same as the first application portion body biasing spring 15g arranged at the first support frame 13b side; for the purpose of description, sign 15h is used in the specification), first and second carrier solution application roller contact load setting members 15i and 15j, first and second carrier solution application roller contact load adjusting members 15k and 15m, first and second carrier solution application roller contact load setting shanks 15n and 15o, a rotary shaft 15p on both ends of the carrier solution application roller 15e, and roller-like (cylindrical) first and second rollers 15q and 15r on the application roller side (sign 15q is shown in FIGS. 10A and 10B) which are a second regulating roller of the invention.

The first and second application portion body frames 15a and 15b are provided on the first and second support frames 13a and 13b so as to be rotated through the rotary shaft 15f. The carrier solution storage portion 15c stores the carrier solution which is a toner removing solution (cleaning solution) applied to the transfer roller 9. The carrier solution supply roller 15d is provided on the first and second application portion body frames 15a and 15b so as to be rotated. The carrier solution supply roller 15d draws up the carrier solution stored in the carrier solution storage portion 15c by rotation and supplies the carrier solution to the carrier solution application roller 15e.

The carrier solution application roller 15e is brought into contact with the carrier solution supply roller 15d and is provided on the first and second application portion body frames 15a and 15b. The carrier solution supply roller 15d and the carrier solution application roller 15e are provided on the application portion body frame 15a so as to be trail-rotated. In that case, the carrier solution application roller 15e is trail-rotated with respect to the rotation of the transfer roller 9.

The carrier solution application roller 15e is trail-rotated to thereby apply the carrier solution supplied from the carrier solution supply roller 15d to the outer circumferential surface of the blanket seat 9b of the transfer roller 9 after the termination of the secondary transfer. In that case, the contact force of the carrier solution application roller 15e with the transfer roller is small, and thus the carrier solution is much more effectively applied to the transfer roller 9. As a result, the carrier solution application properties to the transfer roller 9 using the carrier solution application roller 15e are improved.

In addition, the transfer roller cleaning roller 14c is arranged vertically upward from the carrier solution application roller 15e. Specifically, the contact position of the transfer roller cleaning roller 14c with the transfer roller 9 is arranged vertically upward from carrier solution application roller 15e.

The first and second application portion body biasing springs 15g and 15h are compressively provided between the corresponding first and second application portion body frames 15a and 15b and the first and second carrier solution application roller contact load setting members 15i and 15j. The first and second application portion body biasing springs 15g and 15h bias the first and second application portion body frames 15a and 15b so that the first and second application portion body frames 15a and 15b are rotated centering on the rotary shaft 15f and the carrier solution application roller 15e comes into contact with the transfer roller 9.

The first and second carrier solution application roller contact load setting members 15i and 15j are respectively fixed to the corresponding first and second support frames 13a and 13b. The first and second carrier solution application roller contact load setting members 15i and 15j support each one end of the first and second application portion body biasing springs 15g and 15h. Thereby, the contact load of the carrier solution application roller 15e with the transfer roller 9 by the biasing forces of the first and second application portion body biasing springs 15g and 15h is set to a constant load. In that case, the contact force of the carrier solution application roller 15e with the transfer roller 9 is relatively small. Thereby, the carrier solution application roller 15e is interlocked into the transfer roller 9 relatively small, and much more effectively applies the carrier solution to the transfer roller 9. As a result, the carrier solution application properties to the transfer roller 9 using the carrier solution application roller 15e are improved.

In addition, since the rotary shaft 14f of the cleaning portion body frames 14a and 14b and the rotary shaft 15f of the first and second application portion body frames 15a and 15b are provided independently of each other, the contact load of the transfer roller cleaning roller 14c with the transfer roller 9 and the contact load of the carrier solution application roller 15e with the transfer roller 9 are independent of each other.

The first and second carrier solution application roller contact load adjusting members 15k and 15m are threadably mounted on threaded portions (not shown) of the first and second carrier solution application roller contact load setting shanks 15n and 15o, respectively. The first and second carrier solution application roller contact load adjusting members 15k and 15m are brought into contact with the first and second carrier solution application roller contact load setting members 15i and 15j by the biasing forces of the first and second application portion body biasing springs 15g and 15h.

The first carrier solution application roller contact load setting shank 15n slidably passes through the corresponding first carrier solution application roller contact load setting member 15i and is relatively rotatably connected to the first application portion body frame 15a. The second carrier solution application roller contact load setting shank 15o slidably passes through the corresponding second carrier solution application roller contact load setting member 15j and is relatively rotatably connected to the second application portion body frame 15b. In addition, the first and second carrier solution application roller contact load setting shanks 15n and 150 fit and support the first and second application portion biasing springs 15g and 15h, respectively. The first and second carrier solution application roller contact load adjusting members 15k and 15m are rotated, whereby the biasing forces of the first and second application portion body biasing springs 15g and 15h are adjusted. In this manner, the biasing forces of the first and second application portion body biasing springs 15g and 15h are adjusted, whereby the contact load of the carrier solution application roller 15e with the transfer roller 9 by the biasing forces of the first and second application portion body biasing springs 15g and 15h is adjusted to a desired value.

As shown in FIG. 9, the first and second rollers 15q and 15r on the application roller side are respectively rotatably provided on the rotary shaft 15p on both ends of the carrier solution application roller 15c concentrically or substantially concentrically with the carrier solution application roller 15c. As shown in FIG. 10A, when the carrier solution application roller 15e is located at a position coming into contact with the blanket seat 9b on the continuous outer circumferential surface except the concave portion 9e of the transfer roller 9, the first and second rollers 15q and 15r on the application roller side are separated from the first and second roller support portions 9c and 9d, respectively.

In addition, as shown in FIG. 10B, when the concave portion 9e which is a discontinuous portion on the outer circumferential surface of the transfer roller 9 is located at a position facing the carrier solution application roller 15e, the blanket seat 9b is penetrated into the concave portion 9e, and thus the first and second application portion body frames 15a and 15b are rotated in the direction in which the carrier solution application roller 15e is penetrated into the concave portion 9e by the biasing forces of the first and second application portion body biasing springs 15g and 15h. Then, the carrier solution application roller 15e is penetrated into the concave portion 9e while coming into contact with the inclined surface 9r of the blanket seat 9b within the concave portion 9e. The first and second rollers 15q and 15r on the application roller side come into contact with the first and second roller support portions 9c and 9d. At this time, as described above, the first and second support frames 13a and 13b are positioned with respect to the transfer roller 9 regardless of the position of the concave portion 9e. As a result, the penetration of the carrier solution application roller 15e into the concave portion 9e is regulated, and the transfer roller 9 is separated from the blanket seat 9b by rotation. In that case, the carrier solution application roller 15e does not come into contact with the cover member 9h. The maximum amount of the penetration of the carrier solution application roller 15e into the concave portion 9e on the outer circumferential surface is regulated to the second maximum amount of penetration t2.

Incidentally, in the image forming apparatus 1 of the second example, radius R1 (mm) of the transfer roller cleaning roller 14c is larger than radius R3 (mm) of the carrier solution application roller 15e. In addition, radius R2 (mm) of the first and second rollers 14q and 14r on the cleaning roller side is equal or substantially equal to radius R4 (mm) of the first and second rollers 15q and 15r on the application roller side. Therefore, the difference between radius R1 (mm) of the transfer roller cleaning roller 14c and radius R2 (mm) of the first and second rollers 14q and 14r on the cleaning roller side is larger than the difference between radius R3 (mm) of the carrier solution application roller 15e and radius R4 (mm) of the first and second rollers 15q and 15r on the application roller side ((R1−R2)>(R3−R4)>0). As a result, the maximum amount of penetration t1 of the transfer roller cleaning roller 14c into the concave portion 9e on the outer circumferential surface is larger than the second maximum amount of penetration t2 of the carrier solution application roller 15e into the concave portion 9e on the outer circumferential surface (t1>t2). At this time, distance L1 (mm) from the rotation center of the transfer roller 9 to the circumferential surface of the carrier solution application roller 15e when the concave portion 9e of the transfer roller 9 and the carrier solution application roller 15e face each other, distance L2 (mm) from the rotation center of the transfer roller 9 to the circumferential surface of the transfer roller cleaning roller 14c when the concave portion 9e of the transfer roller 9 and the transfer roller cleaning roller 14c face each other, and radius R (mm) up to the circumferential surface except the concave portion 9e of the transfer roller 9 have a relationship of L2<L1<R.

Next, operations of the transfer roller cleaning roller 14c and the carrier solution application roller 15e of the second example will be described.

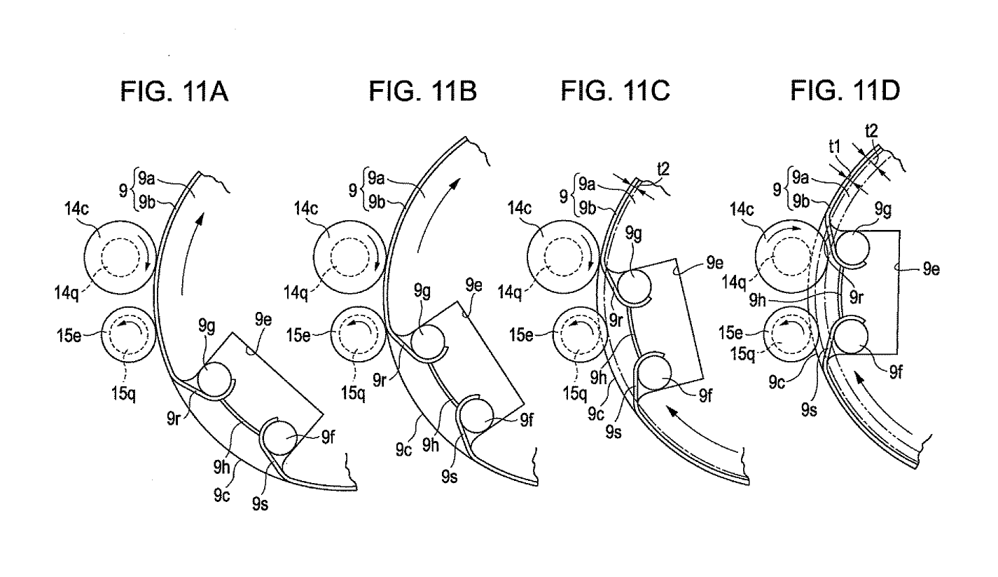

As shown in FIG. 11A, when the concave portion 9e of the transfer roller 9 is located at a position which does not face any of the transfer roller cleaning roller 14c and the carrier solution application roller 15e, the transfer roller cleaning roller 14c and the carrier solution application roller 15e all come into contact with the outer circumferential surface of the continuous arc-like blanket seat 9b. Thereby, the carrier solution application roller 15e applies the carrier solution to the outer circumferential surface of the arc-like blanket seat 9b, and the transfer roller cleaning roller 14c cleans the arc-like blanket seat 9b to remove the remaining liquid developer and the applied carrier solution adhering to the arc-like blanket seat 9b. At this time, the first and second rollers 14q and 14r on the cleaning roller side and the first and second rollers 15q and 15r on the application roller side are separated from the blanket seat 9b. The transfer roller 9 is rotated, whereby as shown in FIG. 11B, the carrier solution application roller 15e is located at a position immediately before it is separated from the outer circumferential surface of the continuous arc-like blanket seat 9b.

The transfer roller 9 is further rotated, whereby as shown in FIG. 11C, the carrier solution application roller 15e moves while coming into contact with the inclined surface 9r of the continuous arc-like blanket seat 9b and then is separated from the outer circumferential surface, and the transfer roller cleaning roller 14c is located at a position immediately before it is separated from the outer circumferential surface of the continuous arc-like blanket seat 9b. Then, the application of the carrier solution by the carrier solution application roller 15e is stopped. At this time, the carrier solution application roller 15e is penetrated into the concave portion 9e, and the first and second rollers 15q and 15r on the application roller side come into contact with the first and second roller support portions 9c and 9d, respectively. Thereby, the carrier solution application roller 15e is penetrated into the concave portion 9e up to the second maximum amount of penetration t2.

The transfer roller 9 is further rotated, whereby as shown in FIG. 11D, the transfer roller cleaning roller 14c moves while coming into contact with the inclined surface 9r of the continuous arc-like blanket seat 9b and then is separated from the outer circumferential surface. The carrier solution application roller 15e is maintained to the second maximum amount of penetration t2 and is in a state where it is separated from the outer circumferential surface of the blanket seat 9b. Then, the cleaning of the transfer roller 9 by the transfer roller cleaning roller 14c is stopped, and the application of the carrier solution by the carrier solution application roller 15e continues to be stopped. At this time, the carrier solution application roller 15e is penetrated into the concave portion 9e, and the first and second rollers 14q and 14r on the cleaning roller side come into contact with the first and second roller support portions 9c and 9d, respectively. Thereby, the transfer roller cleaning roller 14c is penetrated into the concave portion 9e up to the maximum amount of penetration t1.

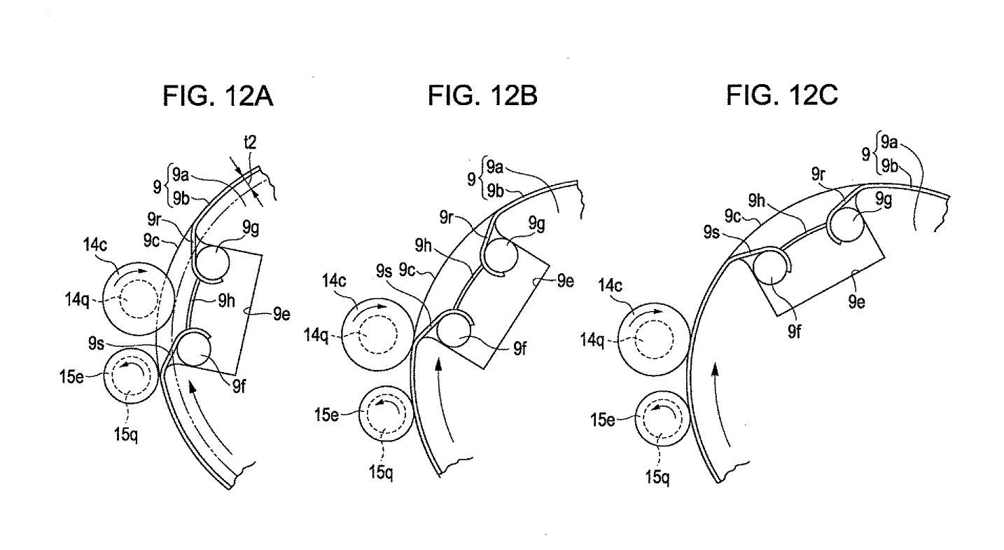

The transfer roller 9 is further rotated, whereby as shown in FIG. 12A, the carrier solution application roller 15e comes into contact with the inclined surface 9s of the blanket seat 9b, and then moves while coming into contact with the inclined surface of the blanket seat 9b and is located at a position coming into contact with the outer circumferential surface of the continuous arc-like blanket seat 9b. Then, the application of the carrier solution by the carrier solution application roller 15e is started. At this time, the transfer roller cleaning roller 14c is maintained to the maximum amount of penetration t1 and is in a state where it is separated from the outer circumferential surface of the blanket seat 9b. Thereby, the cleaning of the transfer roller 9 by the transfer roller cleaning roller 14c continues to be stopped.

The transfer roller 9 is further rotated, whereby as shown in FIG. 12B, the transfer roller cleaning roller 14c comes into contact with the inclined surface 9s of the blanket seat 9b, and then moves while coming into contact with the inclined surface of the blanket seat 9b and is located at a position coming into contact with the outer circumferential surface of the continuous arc-like blanket seat 9b. Then, the cleaning of the transfer roller 9 by the transfer roller cleaning roller 14c is started. At this time, the application of the carrier solution to the arc-like blanket seat 9b by the carrier solution application roller 15e is continued.

The transfer roller 9 is further rotated, whereby as shown in FIG. 12C, the transfer roller cleaning roller 14c and the carrier solution application roller 15e are all in a state where they come into contact with the outer circumferential surface of the continuous arc-like blanket seat 9b. Thereby, the application of the carrier solution to the blanket seat 9b by the carrier solution application roller 15e and the cleaning of the transfer roller 9 by the transfer roller cleaning roller 14c are both performed.

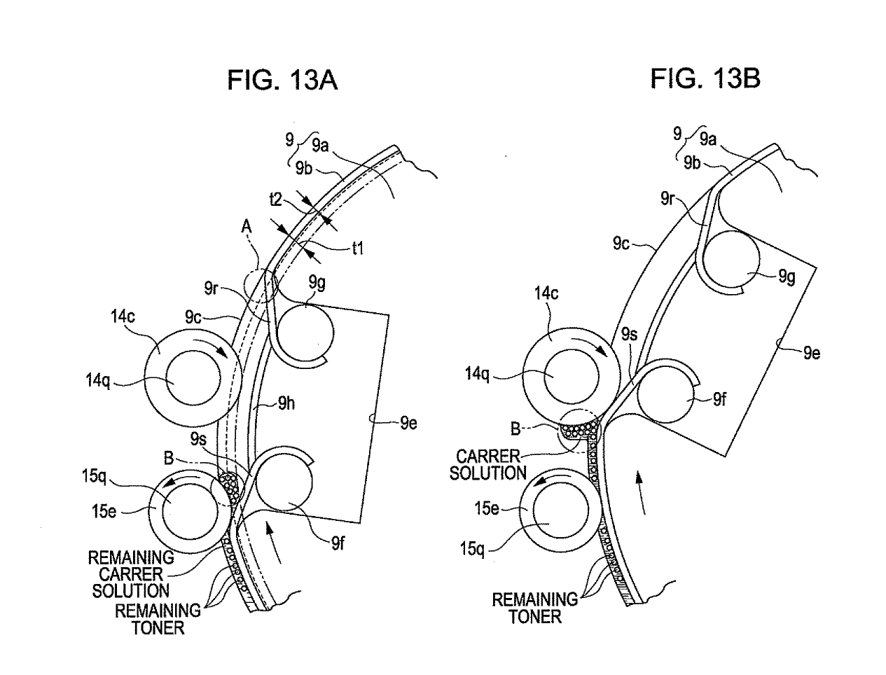

Incidentally, as shown in FIG. 13A, the concave portion 9e of the transfer roller 9 passes through the contact position of the carrier solution application roller 15e with the transfer roller 9, the remaining liquid developer (remaining toner and remaining carrier solution) and the carrier solution applied by the carrier solution application roller 15e tend to be deposited in regions A and B of the inclined surfaces 9r and 9s of the blanket seat 9b immediately after the blanket seat 9b is penetrated into the concave portion 9e from the outer circumferential surface except the concave portion 9e of the transfer roller 9.

Consequently, the remaining liquid developer (remaining toner and remaining carrier solution) and the carrier solution applied by the carrier solution application roller 15e which have a tendency to be deposited in the regions A and B of the inclined surfaces 9r and 9s of the blanket seat 9b are removed by a series of operations of the transfer roller cleaning roller 14c mentioned above. At this time, as mentioned above, the maximum amount of penetration t1 of the transfer roller cleaning roller 14c into the concave portion 9e is larger than the second maximum amount of penetration t2 of the carrier solution application roller 15e into the concave portion 9e. Therefore, as shown in FIG. 13A, first, the toner and the carrier solution deposited in the region A are efficiently removed by the transfer roller cleaning roller 14c which is greatly penetrated into the concave portion 9e, or move to the region B (for this reason, the remaining liquid developer and the application carrier solution of the region A are not shown in FIG. 13A). Next, as shown in FIG. 13B, the region B comes to the contact position of the transfer roller cleaning roller 14c, and thus the toner and the carrier solution deposited in the region A are efficiently removed by the transfer roller cleaning roller 14c.

According to the image forming apparatus 1 of the second example, when the concave portion 9e of the transfer roller 9 is located at a position which does not face the transfer roller cleaning roller 14c, the transfer roller cleaning roller 14c is brought into contact with the outer circumferential surface except the concave portion 9e of the transfer roller 9. Therefore, the outer circumferential surface except the concave portion 9e of the transfer roller 9 after the secondary transfer can be cleaned by the transfer roller cleaning roller 14c. Thereby, the remaining liquid developer (remaining toner and remaining carrier solution) adhering to the transfer roller 9 after the secondary transfer can be removed. In addition, when the concave portion 9e of the transfer roller 9 is located at a position facing the transfer roller cleaning roller 14c, the transfer roller cleaning roller 14c is penetrated into the concave portion 9e of the transfer roller 9. At this time, the first and second rollers 14q and 14r on the cleaning roller side come into contact with the first and second roller support portions 9c and 9d, whereby the amount of the penetration of the transfer roller cleaning roller 14c into the concave portion 9e is regulated to the maximum amount of penetration t1. Therefore, using this transfer roller cleaning roller 14c, it is possible to effectively remove the remaining liquid developer (remaining toner and remaining carrier solution) and the application carrier solution which a tendency to be deposited in the regions A and B of the inclined surfaces 9r and 9s of the blanket seat 9b immediately after the penetration thereof into the concave portion 9e from the outer circumferential surface except the concave portion 9e of the transfer roller 9. Thereby, it is possible to prevent the liquid developer and the application carrier solution remaining in the concave portion 9e from being accumulated, and to prevent the remaining liquid developer and the application carrier solution from seeping from the concave portion 9e. Further, in this manner, the remaining liquid developer and the application carrier solution are scarcely deposited in the concave portion 9e, and thus even when the image forming apparatus 1 is used for a long period of time, it is possible to more effectively prevent contamination of peripheral members of the transfer roller 9 such as contamination of rollers other than the transfer roller 9 and contamination of the transfer medium 12 by the deposition of the remaining liquid developer and the application carrier solution in the concave portion 9e. As a result, it is possible to prevent image defects due to the remaining liquid developer and the application carrier solution deposited in the concave portion 9e, and to obtain a high-quality image.

Further, when the concave portion 9e of the transfer roller 9 is located at a position which does not face the carrier solution application roller 15e, the carrier solution application roller 15e is brought into contact with the outer circumferential surface except the concave portion 9e of the transfer roller 9. Therefore, the carrier solution for easily removing the remaining toner can be applied to the outer circumferential surface except the concave portion 9e of the transfer roller 9 after the secondary transfer by the carrier solution application roller 15e. Thereby, the remaining toner adhering to the transfer roller 9 after the secondary transfer can be effectively removed. In addition, when the concave portion 9e of the transfer roller 9 is located at a position facing the carrier solution application roller 15e, the carrier solution application roller 15e is penetrated into the concave portion 9e of the transfer roller 9. At this time, the first and second rollers 15q and 15r on the application roller side come into contact with the first and second roller support portions 9c and 9d, whereby the amount of the penetration of the carrier solution application roller 15e into the concave portion 9e is regulated to the second maximum amount of penetration t2. In that case, the difference between radius R1 (mm) of the transfer roller cleaning roller 14c and radius R2 (mm) of the first and second rollers 14q and 14r on the cleaning roller side is larger than the difference between radius R3 (mm) of the carrier solution application roller 15e and radius R4 (mm) of the first and second rollers 15q and 15r on the application roller side ((R1−R2)>(R3−R4)). Therefore, with a simple structure, the maximum amount of penetration t1 of the transfer roller cleaning roller 14c into the concave portion 9e on the outer circumferential surface can be made larger than the second maximum amount of penetration t2 of the carrier solution application roller 15e into the concave portion 9e on the outer circumferential surface.

In this manner, since the second maximum amount of penetration t2 of the carrier solution application roller 15e is smaller than the maximum amount of penetration t1 of the transfer roller cleaning roller 14c, the carrier solution can be deposited in the regions A and B of the blanket seat 9b as substantially mentioned above. Therefore, using this transfer roller cleaning roller 15e, it is possible to effectively remove the carrier solution applied to the blanket seat 9b within the concave portion 9e by the carrier solution application roller 15e. Thereby, it is possible to obtain a higher-quality image.

In this manner, in the image forming apparatus 1 of the second example, since the remaining liquid developer and the application carrier solution are scarcely deposited in the concave portion 9e of the transfer roller 9, it is possible to eliminate the need for the web cleaning mechanism or the suction pump as disclosed in JPA-2004-317980 mentioned above, and to form the transfer device and the image forming apparatus 1 with a simple structure. Since the transfer device and the image forming apparatus 1 are formed with a simple structure, it is possible to realize an inexpensive transfer device and an image forming apparatus which are capable of obtaining high reliability of the transfer device and the image forming apparatus 1 and achieving space saving.

Other configurations, operations, and effects of the image forming apparatus 1 of the second example are the same as that of the first example.

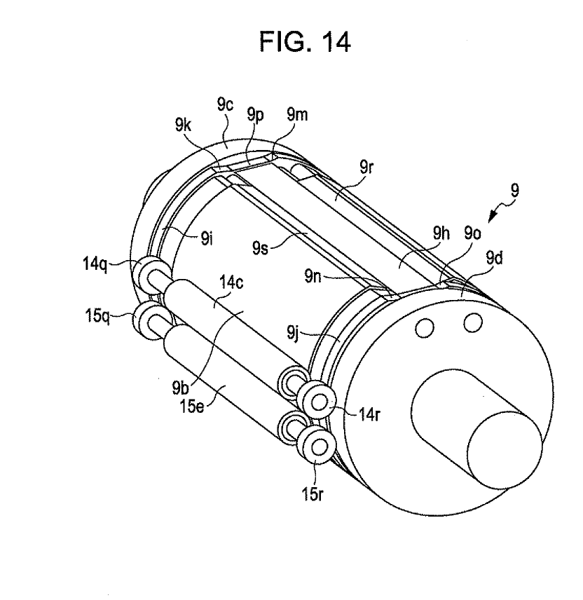

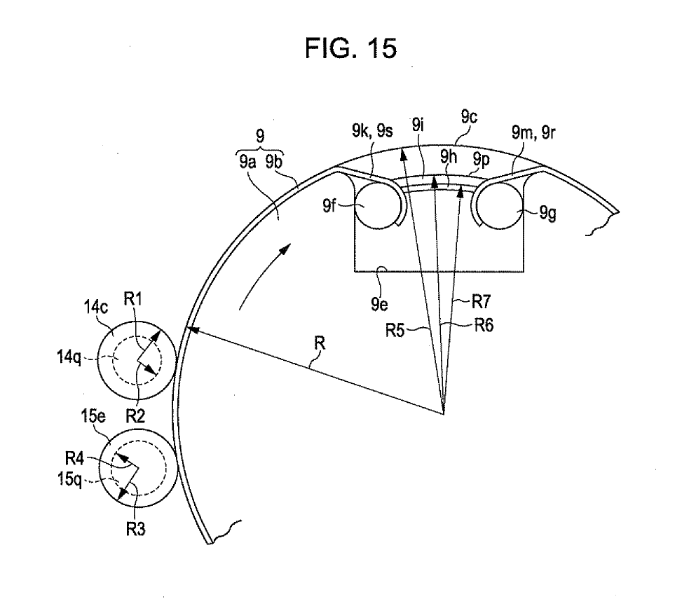

FIG. 14 is a partial perspective view partially illustrating a third example of the image forming apparatus according to the embodiment of the invention, and FIG. 15 is a transverse cross-sectional view in FIG. 14.

As shown in FIGS. 14 and 15, in the image forming apparatus 1 of the third example, the base 9a of the transfer roller 9 further includes third and fourth roller support portions 9i and 9j. The third and fourth roller support portions 9i and 9j are provided adjacent to the insides of the first and second roller support portions 9c and 9d, respectively. In that case, the first and second roller support portions 9c and 9d are equivalent to the roller support portion on the application roller side, and the third and fourth roller support portions 9i and 9j are equivalent to the roller support portion on the cleaning roller of the invention.

In the third and fourth roller support portions 9i and 9j, the outer circumferential surfaces except portions corresponding to the concave portion 9e are formed in an arc shape having a radius the same or substantially the same as the radius of the outer circumferential surface of the first and second roller support portions 9c and 9d. In addition, portions of the third and fourth roller support portions 9i and 9j corresponding to the concave portion 9e are formed in a concave shape. In that case, in the concave portions of the third and fourth roller support portions 9i and 9j, both end surfaces of the third and fourth roller support portions 9i and 9j in the rotational direction are formed of inclined surfaces 9k and 9m, and 9n and 9o, and the outer circumferential surfaces of the third and fourth roller support portions 9i and 9j between these inclined surfaces are formed of arc surfaces 9p and 9q (sign 9q is not shown, but is used for the purpose of description as mentioned above). Each of the inclined surface 9k and 9m, and 9n and 90 is formed of an inclined surface axially consistent or substantially consistent with the inclined surfaces 9r and 9s of the blanket seat 9b, and each of the arc surfaces 9p and 9q is formed of an arc surface of a circle concentric or substantially concentric with the outer circumferential surface of the transfer roller 9. In that case, radius R6 (mm) of the arc surfaces 9p and 9q between the inclined surfaces 9k and 9m, and 9n and 90 of the third and fourth roller support portions 9i and 9j is smaller than radius (outer diameter) R5 (mm) of the outer circumferential surface of the transfer roller 9 and is larger than radius R7 (mm) of the outer circumferential surface of the arc-like cover member 9h (R7<R6<R5).

In addition, in the image forming apparatus 1 of the third example, radius R1 (mm) of the transfer roller cleaning roller 14c and radius R3 (mm) of the carrier solution application roller 15e are equal or substantially equal to each other (R1=R3 or R1≅R3). Further, radius R2 (mm) of the first and second roller 14q and 14r on the cleaning roller side is smaller than radius R4 (mm) of the first and second roller 15q and 15r on the application roller side (R2<R4). Therefore, in the image forming apparatus 1 of the third example, the difference (R1−R2) between radius R1 (mm) of the transfer roller cleaning roller 14c and radius R2 (mm) of the first and second rollers 14q and 14r on the cleaning roller side is larger than the difference (R3−R4) between radius R3 (mm) of the carrier solution application roller 15e and radius R4 (mm) of the first and second rollers 15q and 15r on the application roller side ((R1−R2)>(R3−R4)>0).

When the concave portion 9e is located at a position facing the transfer roller cleaning roller 14c, the first roller 14q on the cleaning roller side moves while coming into contact with the inclined surfaces 9k and 9m and the arc surface 9p of the third roller support portion 9i, and the second roller 14r on the cleaning roller side rotates while coming into contact with inclined surfaces 9n and 90 and the arc surface 9q of the fourth roller support portion 9j. When the first and second rollers 14q and 14r on the cleaning roller side come into contact with the arc surfaces 9p and 9q, respectively, the outer circumferential surface of the transfer roller cleaning roller 14c is penetrated into the concave portion 9e by the maximum amount of penetration t1.

On the other hand, when the concave portion 9e is located at a position facing the transfer roller cleaning roller 14c, the carrier solution application roller 15e, and the first and second rollers 15q and 15r on the application roller side rotate while coming into contact with the outer circumferential surfaces of the first and second roller support portions 9c and 9d which are not a discontinuous portion similarly to the second example mentioned above. Therefore, when the first and second rollers 15q and 15r on the application roller side come into contact with the outer circumferential surfaces of the first and second roller support portions 9c and 9d, respectively, the outer circumferential surface of the carrier solution application roller 15e is penetrated into the concave portion 9e by the second maximum amount of penetration t2. In that case, since radii R1, R2, R3, and R4 of each roller satisfy the relationship of (R1−R2)>(R3−R4), and the third and fourth roller support portions 9i and 9j have a concave portion, similarly to the above-mentioned second example, the maximum amount of penetration t1 of the transfer roller cleaning roller 14c into the concave portion 9e is larger than the second maximum amount of penetration t2 of the carrier solution application roller 15e into the concave portion 9e (t1>t2).

Next, operations of the transfer roller cleaning roller 14c and the carrier solution application roller 15e of the third example will be described.

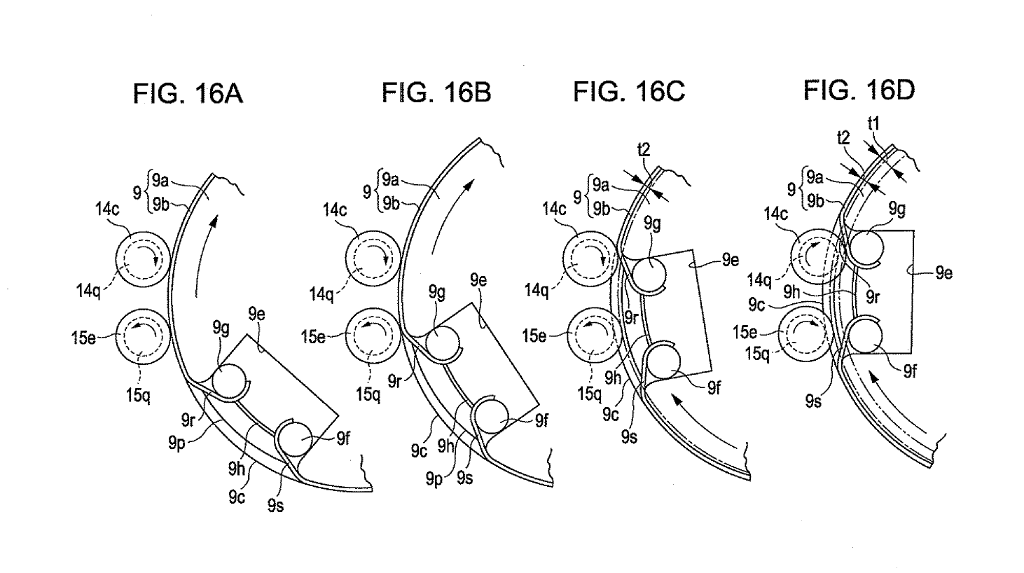

As shown in FIG. 16A, when the concave portion 9e of the transfer roller 9 is located at a position which does not face any of the transfer roller cleaning roller 14c and the carrier solution application roller 15e, the transfer roller cleaning roller 14c and the carrier solution application roller 15e all come into contact with the outer circumferential surface of the continuous arc-like blanket seat 9b. Thereby, the carrier solution application roller 15e applies the carrier solution to the outer circumferential surface of the arc-like blanket seat 9b, and the transfer roller cleaning roller 14c cleans the arc-like blanket seat 9b to remove the remaining liquid developer and the applied carrier solution adhering to the arc-like blanket seat 9b. At this time, the first and second rollers 14q and 14r on the cleaning roller side and the first and second rollers 15q and 15r on the application roller side are all separated from the blanket seat 9b. The transfer roller 9 is rotated, whereby as shown in FIG. 16B, the carrier solution application roller 15e is located at a position immediately before it is separated from the outer circumferential surface of the continuous arc-like blanket seat 9b.

The transfer roller 9 is further rotated, whereby the carrier solution application roller 15e moves while coming into contact with the inclined surface 9r of the blanket seat 9b. When the first and second rollers 15q and 15r on the application roller side come into contact with the arc surfaces 9p and 9q of the third and fourth roller support portions 9i and 9j, respectively, the penetration of the carrier solution application roller 15e into the concave portion 9e is stopped. At this time, the carrier solution application roller 15e is penetrated into the concave portion 9e by the second maximum amount of penetration t2. The transfer roller 9 is further rotated, whereby the first and second rollers 15q and 15r on the application roller side rotate while coming into contact with the arc surfaces 9p and 9q, respectively, and thus the carrier solution application roller 15e is separated from the inclined surface 9r. In that case, the carrier solution application roller 15e maintains the second maximum amount of penetration t2.

As shown in FIG. 16C, the transfer roller 9 is further rotated, whereby the transfer roller cleaning roller 14c is located at a position immediately before it is separated from the outer circumferential surface of the continuous arc-like blanket seat 9b. At this time, the first and second rollers 15q and 15r on the application roller side come into contact with the arc surfaces 9p and 9q, and the carrier solution application roller 15e maintains the second maximum amount of penetration t2.

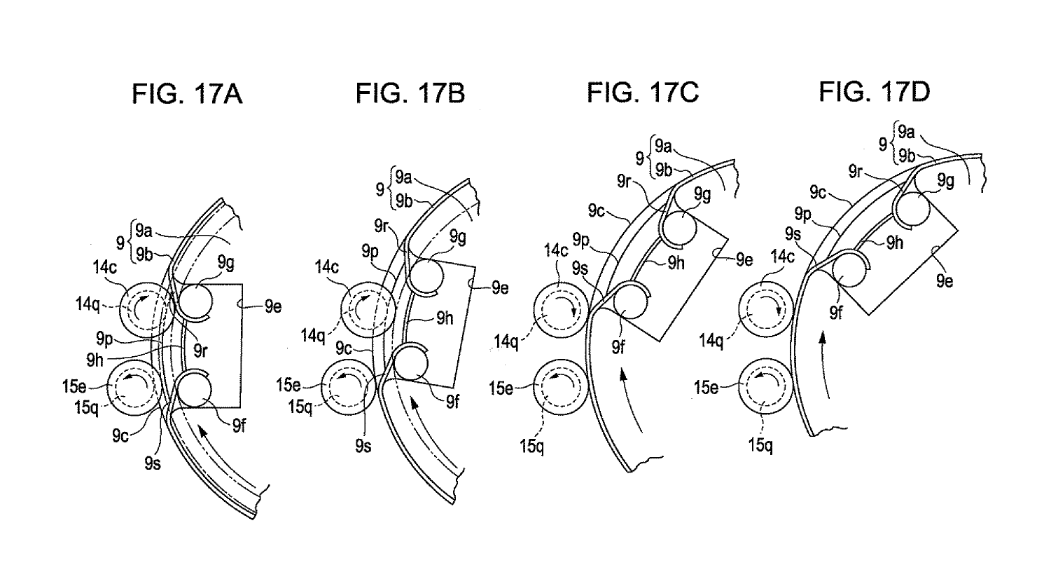

The transfer roller 9 is further rotated, whereby the transfer roller cleaning roller 14c moves while coming into contact with the inclined surface 9r of the blanket seat 9b. As shown in FIG. 16D, when the first and second rollers 14q and 14r on the cleaning roller side come into contact with the arc surfaces 9p and 9q of the third and fourth roller support portions 9i and 9j, respectively, the penetration of the transfer roller cleaning roller 14c into the concave portion 9e is stopped. At this time, the transfer roller cleaning roller 14c is penetrated into the concave portion 9e by the maximum amount of penetration t1. As shown in FIG. 17A, the transfer roller 9 is further rotated, the first and second rollers 14q and 14r on the cleaning roller side rotates while coming into contact with the arc surfaces 9p and 9q, respectively, and thus the transfer roller cleaning roller 14c is separated from the inclined surface 9r. Thereby, the cleaning of the transfer roller 9 by the transfer roller cleaning roller 14c is stopped. In that case, the transfer roller cleaning roller 14c maintains the maximum amount of penetration t1. At this time, the carrier solution application roller 15e is separated from the blanket seat 9b and maintains the second maximum amount of penetration t2.

The transfer roller 9 is further rotated, whereby after the carrier solution application roller 15e comes into contact with the inclined surface 9s of the blanket seat 9b, as shown in FIG. 17B, it moves while coming into contact with the inclined surface 9s of the blanket seat 9b and is located at a position coming into contact with the outer circumferential surface of the continuous arc-like blanket seat 9b. Then, the application of the carrier solution by the carrier solution application roller 15e is started. At this time, the transfer roller cleaning roller 14c maintains the maximum amount of penetration t1 and maintains a state where it is separated from the outer circumferential surface of the blanket seat 9b. Thereby, the cleaning of the transfer roller 9 by the transfer roller cleaning roller 14c continues to be stopped.

The transfer roller 9 is further rotated, whereby after the transfer roller cleaning roller 14c comes into contact with the inclined surface 9s of the blanket seat 9b, it moves coming into contact with the inclined surface 9s of the blanket seat 9b, and is located at a position coming into contact with the outer circumferential surface of the continuous arc-like blanket seat 9b as shown in FIG. 17C. Then, the cleaning of the transfer roller 9 by the transfer roller cleaning roller 14c is started. At this time, the application of the carrier solution to the arc-like blanket seat 9b by the carrier solution application roller 15e is continued.

The transfer roller 9 is further rotated, whereby as shown in FIG. 17D, the transfer roller cleaning roller 14c and the carrier solution application roller 15e are all in a state where they come into contact with the outer circumferential surface of the continuous arc-like blanket seat 9b. Thereby, the application of the carrier solution to the blanket seat 9b by the carrier solution application roller 15e and the cleaning of the transfer roller 9 by the transfer roller cleaning roller 14c are both performed.

According to the image forming apparatus 1 of the third example, the third and fourth roller support portions 9i and 9j with which the first and second rollers 14q and 14r on the cleaning roller side of the transfer roller cleaning roller 14c come into contact have a concave portion, and thus even when the difference (R1−R2) between radius R1 (mm) of the transfer roller cleaning roller 14c and radius R2 (mm) of the first and second rollers 14q and 14r on the cleaning roller side is not made larger to that extent, the maximum amount of penetration t1 of the transfer roller cleaning roller 14c can be made larger than the second maximum amount of penetration t2 of the carrier solution application roller 15e more effectively.

Other configurations, operations, and effects of the image forming apparatus 1 of the third example are the same as that of the second example mentioned above.

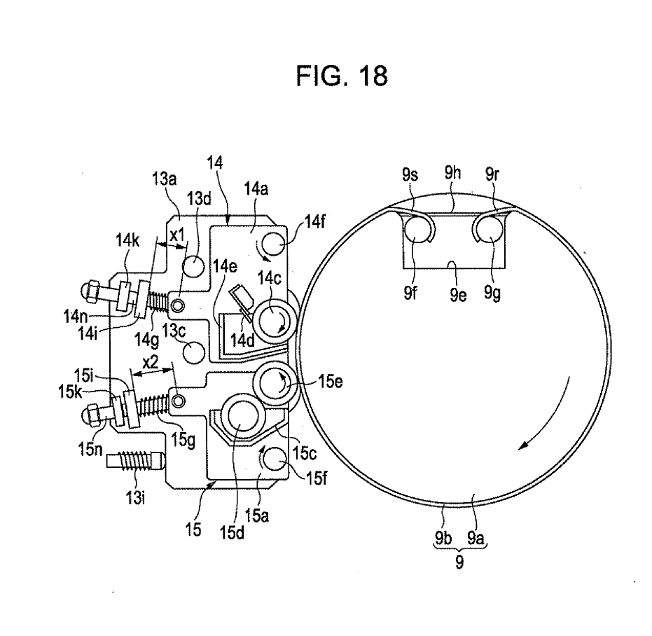

FIG. 18 is a cross-sectional view illustrating a transfer roller cleaning portion and a carrier solution application portion of a transfer device in a fourth example of the image forming apparatus according to the embodiment of the invention. Meanwhile, in the image forming apparatus 1 of the fourth example and the following fifth example, names of a portion of components and functions are merely different and thus FIGS. 4 to 8 of the image forming apparatus 1 of the second example can be used. Therefore, in the following description of the fourth example and the fifth example, a description will be made with reference to FIGS. 4 to 8.

As shown in FIG. 18, in the image forming apparatus 1 of the fourth example, a pair of first and second roller support portions 9c and 9d in the second example constitute a pair of first and second cam follower contact portions (in the following description of the fourth example and the fifth example, for the purpose of description, the first and second cam follower contact portions are also denotes by signs 9c and 9d same as those of the first and second roller support portions 9c and 9d). The image forming apparatus 1 of the fourth example has the concave portion 9e axially provided on the circumferential surface of the base 9a between the first and second cam follower contact portions 9c and 9d.

The first to fourth rollers 13e, 13f, 13g, and 13h provided on the first and second support frames 13a and 13b, respectively, so as to be rotated in the image forming apparatus 1 of the second example mentioned above constitute the first to fourth cam followers, respectively, in the image forming apparatus 1 of the fourth example (in the following description of the fourth example and the fifth example, for the purpose of description, the first to fourth cam followers are also denoted by signs 13e, 13f, 13g, and 13h same as those of the first to fourth rollers 13e, 13f, 13g, and 13h, respectively). In that case, the first and second cam followers 13e and 13f come into contact with the outer circumferential surface of one cam follower contact portion 9c of the transfer roller 9, and the third and fourth cam followers 13g and 13h come into contact with the outer circumferential surface of the other cam follower contact portion 9d of the transfer roller 9.

Similarly to the above-mentioned second example, each of the first and second support frames 13a and 13b is biased so as to be rotated anticlockwise centering on the rotary shaft 13d by the biasing forces of the first and second biasing springs 13i and 13j. Thereby, the first to fourth cam followers 13e, 13f, 13g, and 13h come into contact with the corresponding outer circumferential surfaces of the cam follower contact portions 9c and 9d of the transfer roller 9. Therefore, the first and second support frames 13a and 13b are positioned with respect to the transfer roller 9 regardless of the position of the concave portion 9e.

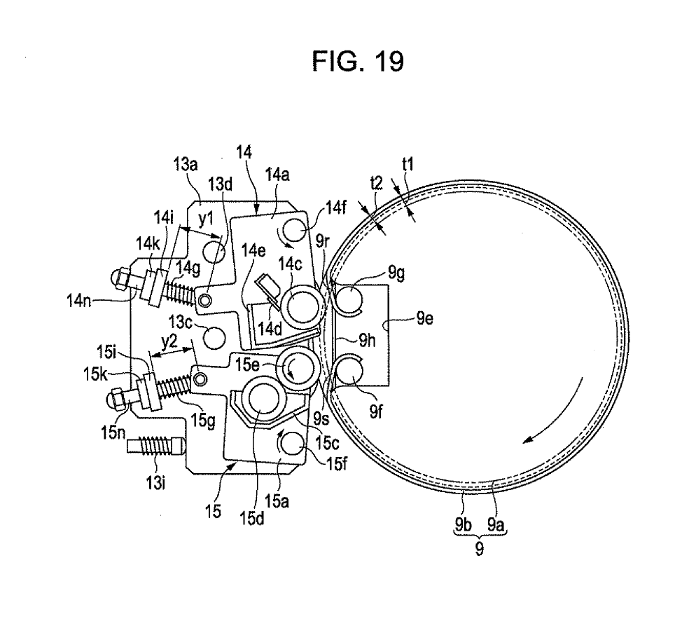

As shown in FIG. 19, similarly to the above-mentioned second example, the transfer roller cleaning portion 14 is arranged between the first and second support frames 13a and 13b. In the transfer roller cleaning portion 14 of the image forming apparatus 1 of the fourth example, the first and second transfer roller cleaning roller contact load setting members 14i and 14j in the second example constitute first and second transfer roller cleaning roller positioning members, respectively (in the following description of the fourth example and the fifth example, for the purpose of description, the first and second transfer roller cleaning roller positioning members are also denoted by signs 14i and 14j same as those of the first and second transfer roller cleaning roller contact load setting members 14i and 14j). In addition, in the transfer roller cleaning portion 14 of the fourth example, the first and second transfer roller cleaning roller contact load adjusting members 14k and 14m in the second example constitute first and second cleaning portion body rotation regulating members, respectively (in the following description of the fourth example and the fifth example, for the purpose of description, the first and second cleaning portion body rotation regulating members are also denoted by signs 14k and 14m same as those of the first and second transfer roller cleaning roller contact load adjusting members 14k and 14m).

Therefore, in the image forming apparatus 1 of the fourth example, FIGS. 4 to 8 of the image forming apparatus 1 of the second example can also be used.

The first and second transfer roller cleaning roller positioning members 14i and 14j are fixed to the corresponding first and second support frames 13a and 13b, respectively. In addition, the first and second cleaning portion body rotation regulating members 14k and 14m include the first and second cleaning portion body rotation regulating shanks 14n and 14o, respectively. The first cleaning portion body rotation regulating shank 14n slidably passes through the corresponding first transfer roller cleaning roller positioning member 14i and is relatively rotatably connected to the first cleaning portion body frame 14a. The second cleaning portion body rotation regulating shank 14o slidably passes through the corresponding second transfer roller cleaning roller positioning member 14j and is relatively rotatably connected to the second cleaning portion body frame 14b. Further, the first and second cleaning portion biasing springs 14g and 14h are fitted to the corresponding first and second cleaning portion body rotation regulating shanks 14n and 14o, respectively, and are compressively provided so as to be expanded and contracted between the first and second transfer roller cleaning roller positioning members 14i and 14j and the first and second cleaning portion body frames 14a and 14b. Thereby, the first and second cleaning portion body biasing springs 14g and 14h cause the biasing force to act on the corresponding first and second cleaning portion body frames 14a and 14b, respectively.

As shown in FIG. 18, the first and second cleaning portion body frames 14a and 14b are biased so as to be rotated centering on the rotary shaft 14f by the biasing forces of the corresponding first and second cleaning portion body biasing springs 14g and 14h. At this time, when the transfer roller cleaning roller 14c is located at a position coming into contact with the blanket seat 9b of the continuous outer circumferential surface except the concave portion 9e of the transfer roller 9, the operating length of the first and second cleaning portion body biasing springs 14g and 14h is operating length x1.

A clearance on the application portion side is provided between the first and second transfer roller cleaning roller positioning members 14i and 14j and the first and second cleaning portion body rotation regulating members 14k and 14m, and thus the first and second cleaning portion body frames 14a and 14b are rotated without being regulated by the first and second cleaning portion body rotation regulating members 14k and 14m. As a result, the biasing forces of the first and second cleaning portion body biasing springs 14g and 14h act on the first and second cleaning portion body frames 14a and 14b without being influenced by the first and second cleaning portion body rotation regulating members 14k and 14m. Thereby, the transfer roller cleaning roller 14c is brought into contact with the outer circumferential surface of the transfer roller 9 due to the constant load based on the biasing forces of the first and second cleaning portion body biasing springs 14g and 14h.

In addition, as shown in FIG. 19, when the concave portion 9e which is a discontinuous portion on the outer circumferential surface of the transfer roller 9 is located at a position facing the transfer roller cleaning roller 14c, the blanket seat 9b is penetrated into the concave portion 9e, and thus the transfer roller cleaning roller 14c of the first and second cleaning portion body frames 14a and 14b is rotated by the biasing forces of the first and second cleaning portion body biasing springs 14g and 14h and is penetrated into the concave portion 9e. Then, the first and second cleaning portion body rotation regulating members 14k and 14m move and come into contact with the first and second transfer roller cleaning roller positioning members 14i and 14j. Therefore, the first and second cleaning portion body frames 14a and 14b are stopped by regulation of the rotation thereof. At this time, as described above, the first and second support frames 13a and 13b are positioned with respect to the transfer roller 9 regardless of the position of the concave portion 9e. As a result, the transfer roller cleaning roller 14c is separated from the blanket seat 9b by regulation of the penetration thereof into the concave portion 9e, and does not come into contact with the cover member 9h. In that case, the maximum amount of the penetration of the transfer roller cleaning roller 14c into the concave portion 9e on the outer circumferential surface is regulated to the maximum amount of penetration t1. That is, when the concave portion 9e of the transfer roller 9 faces the transfer roller cleaning roller 14c, the transfer roller cleaning roller 14c is located at the shaft center side of the transfer roller 9 rather than the virtual circumferential surface extended from the circumferential surface except the concave portion 9e of the transfer roller 9 to the concave portion 9e. Thus, the cleaning member position regulating member and the cleaning member position regulating portion of the invention are constituted by the first and second cleaning portion body rotation regulating members 14k and 14m and the first and second transfer roller cleaning roller positioning members 14i and 14j.

Further, as shown in FIG. 4 and FIGS. 8 to 19, in the carrier solution application portion 15 of the fourth example, the first and second carrier solution application roller contact load setting members 15i and 15j in the second example constitute the first and second carrier solution application roller positioning members, respectively (in the following description of the fourth example and the fifth example, for the purpose of description, the first and second carrier solution application roller positioning member are also denoted by signs 15i and 15j same as those of the first and second carrier solution application roller contact load setting members 15i and 15j). In addition, in the carrier solution application portion 15 of the fourth example, the first and second carrier solution application roller contact load adjusting members 15k and 15m in the second example constitute the first and second application portion body rotation regulating member, respectively (in the following description in the fourth example and the fifth example, for the purpose of description, the first and second application portion body rotation regulating member are also denoted by signs 15k and 15m same as those of the first and second carrier solution application roller contact load adjusting members 15k and 15m).

The first and second carrier solution application roller positioning members 15i and 15j are fixed to the corresponding first and second support frames 13a and 13b, respectively. In addition, the first and second application portion body rotation regulating members 15k and 15m include the first and second application portion body rotation regulating shanks 15n and 150, respectively. The first application portion body rotation regulating shank 15n slidably passes through the corresponding first carrier solution application roller positioning member 15i and is relatively rotatably connected to the first application portion body frame 15a. The second application portion body rotation regulating shank 15o slidably passes through the corresponding second carrier solution application roller positioning member 15j and is relatively rotatably connected to the second application portion body frame 15b. Further, the first and second application portion body biasing springs 15g and 15h are fitted to the corresponding first and second application portion body rotation regulating shanks 15n and 15o, respectively, and are compressively provided so as to be expanded and contracted between the first and second carrier solution application roller positioning members 15i and 15j and the first and second application portion body frames 15a and 15b. Thereby, the first and second application portion body biasing springs 15g and 15h cause the biasing force to act on the corresponding first and second application portion body frames 15a and 15b, respectively.

As shown in FIG. 18, the first and second application portion body frames 15a and 15b are biased so as to be rotated centering on the rotary shaft 15f by the biasing forces of the corresponding first and second application portion body biasing springs 15g and 15h. Thereby, the carrier solution application roller 15e is brought into contact with the outer circumferential surface of the blanket seat 9b of the transfer roller 9. At this time, when the carrier solution application roller 15e is located at a position coming into contact with the blanket seat 9b which is a continuous portion except the concave portion 9e, the operating length of the first and second application portion body biasing springs 15g and 15h is operating length x2. In that case, in the transfer device of the image forming apparatus 1 of the fourth example, the operating length x1 of the first and second cleaning portion body biasing springs 14g and 14h is shorter than the operating length x2 of the first and second application portion body biasing springs 15g and 15h (x1<x2).

When the first and second cleaning portion body biasing springs 14g and 14h and the first and second application portion body biasing springs 15g and 15h are formed of the same spring, the operating length x1 of the first and second cleaning portion body biasing springs 14g and 14h becomes shorter than the operating length x2 of the first and second application portion body biasing springs 15g and 15h in this manner, and thus the biasing forces of the first and second cleaning portion body biasing springs 14g and 14h are relatively large. Therefore, the contact force of the transfer roller cleaning roller 14c with the transfer roller 9 is large. Thereby, the remaining liquid developer (remaining toner and remaining carrier solution) and the applied carrier solution which remain in the transfer roller 9 after the secondary transfer scarcely passes between the transfer roller cleaning roller 14c and the transfer roller 9. As a result, the cleaning properties of the transfer roller 9 using the transfer roller cleaning roller 14c are improved. In addition, the biasing forces of the first and second application portion body biasing springs 15g and 15h are relatively small. Therefore, the contact force of the carrier solution application roller 15e with the transfer roller 9 is small.

A clearance on the application portion side is provided between the first and second carrier solution application roller positioning members 15i and 15j and the first and second application portion body rotation regulating members 15k and 15m, and thus the first and second application portion body frames 15a and 15b are rotated without being regulated by the first and second application portion body rotation regulating members 15k and 15m. As a result, the biasing forces of the first and second application portion body biasing springs 15g and 15h act on the first and second application portion body frames 15a and 15b without being influenced by the first and second application portion body rotation regulating members 15k and 15m. Thereby, the carrier solution application roller 15e is brought into contact with the outer circumferential surface of the transfer roller 9 due to the constant load based on the biasing forces of the first and second application portion body biasing springs 15g and 15h. In that case, since the rotary shaft 14f of the cleaning portion body frames 14a and 14b and the rotary shaft 15f of the first and second application portion body frames 15a and 15b are provided independently of each other, the contact load of the transfer roller cleaning roller 14c with the transfer roller 9 and the contact load of the carrier solution application roller 15e with the transfer roller 9 are independent of each other.

In addition, as shown in FIG. 19, when the carrier solution application roller 15e faces the concave portion 9e which is a discontinuous portion on the outer circumferential surface of the transfer roller 9 and is located at a position which does not come into contact with the blanket seat 9b, the first and second application portion body frames 15a and 15b are rotated by the biasing forces of the first and second application portion body biasing springs 15g and 15h.

In addition, as shown in FIG. 19, when the concave portion 9e which is a discontinuous portion on the outer circumferential surface of the transfer roller 9 is located at a position facing the carrier solution application roller 15e, similarly to the above-mentioned transfer roller cleaning roller 14c, the first and second application portion body frames 15a and 15b is penetrated into the concave portion 9e by the rotation of the carrier solution application roller 15e by the biasing forces of the first and second application portion body biasing springs 15g and 15h. Then, the first and second application portion body rotation regulating members 15k and 15m move and come into contact with the first and second carrier solution application roller positioning members 15i and 15j. Therefore, the rotation of the first and second application portion body frames 15a and 15b is regulated and stopped. At this time, as described above, the first and second support frames 13a and 13b is positioned with respect to the transfer roller 9 regardless of the position of the concave portion 9e. As a result, the carrier solution application roller 15e is separated from the blanket seat 9b by regulation of the penetration thereof into the concave portion 9e, and does not come into contact with the cover member 9h. In that case, the maximum amount of the penetration of the carrier solution application roller 15e into the concave portion 9e on the outer circumferential surface is regulated to the second maximum amount of penetration t2. That is, when the concave portion 9e of the transfer roller 9 faces the carrier solution application roller 15e, the carrier solution application roller 15e is located at the shaft center side of the transfer roller 9 rather than the above-mentioned virtual circumferential surface. At this time, operating length y1 of the first and second cleaning portion body biasing springs 14g and 14h is also shorter than operating length y2 of the first and second application portion body biasing springs 15g and 15h (y1<y2).

In the image forming apparatus 1 of the fourth example, the maximum amount of penetration t1 of the transfer roller cleaning roller 14c is larger than the second maximum amount of penetration t2 of the carrier solution application roller 15e (t1>t2). The operating length x1 of the first and second cleaning portion body biasing springs 14g and 14h when the transfer roller cleaning roller 14c comes into contact with the circumferential surface except the concave portion 9e of the transfer roller 9 is shorter than the operating length x2 of the first and second application portion body biasing springs 15g and 15h when the carrier solution application roller 15e comes into contact with the circumferential surface except the concave portion 9e of the transfer roller 9 (x1>x2). Therefore, the distance in a radial direction of the transfer roller cleaning roller 14c from the transfer roller cleaning roller 14c in which the position is regulated to the maximum amount of penetration t1 to the shaft center of the transfer roller 9 is shorter than the distance from the carrier solution application roller 15e in which the position is regulated to the second maximum amount of penetration t2 to the shaft center of the transfer roller. Thus, the application member position regulating member of the invention is constituted by the first and second carrier solution application roller positioning members 15i and 15j and the first and second application portion body rotation regulating members 15k and 15m.

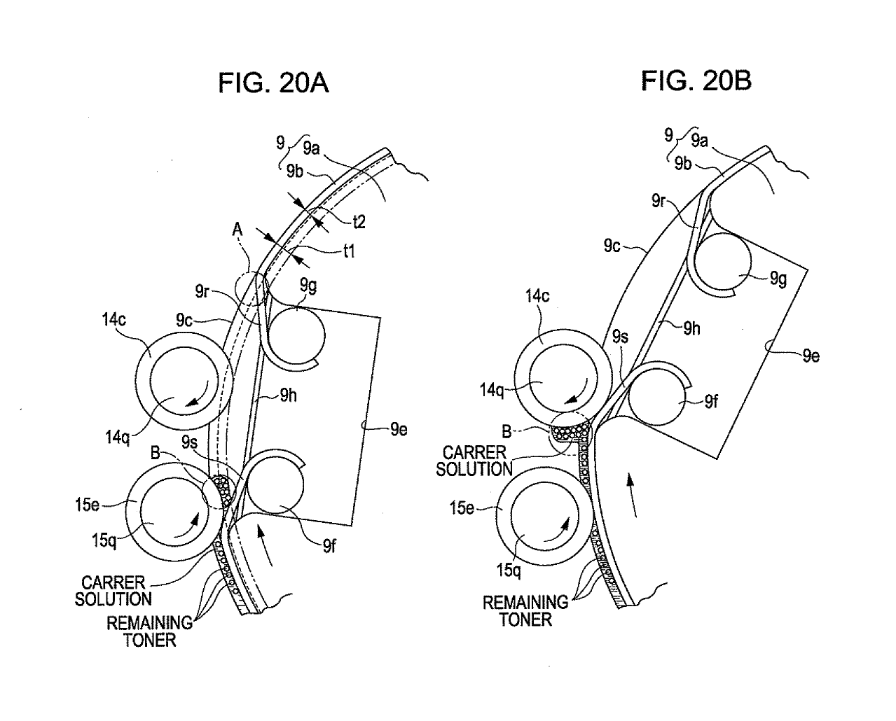

Incidentally, as shown in FIG. 20A, the concave portion 9e of the transfer roller 9 passes through the contact position of the carrier solution application roller 15e with the transfer roller 9, the remaining liquid developer (remaining toner and remaining carrier solution) and the carrier solution applied by the carrier solution application roller 15e tend to be deposited in regions A and B of the inclined surfaces of the blanket seat 9b immediately after the blanket seat 9b is penetrated into the concave portion 9e from the outer circumferential surface except the concave portion 9e of the transfer roller 9.

Therefore, as described above, when the maximum amount of penetration t1 of the transfer roller cleaning roller 14c into the concave portion 9e is larger than the second maximum amount of penetration t2 of the carrier solution application roller 15e into the concave portion 9e, as shown in FIG. 20A, the toner and the carrier solution first deposited in the region A by the transfer roller cleaning roller 14c greatly penetrated into the concave portion 9e is efficiently removed by the transfer roller cleaning roller 14c, or move to the region B (for this reason, the remaining liquid developer and the application carrier solution in the region A are not shown in FIG. 20). Next, as shown in FIG. 20B, the region B comes to the contact position of the transfer roller cleaning roller 14c, and thus the toner and the carrier solution deposited in the region A are efficiently removed by the transfer roller cleaning roller 14c.

In this manner, in the image forming apparatus 1 of the fourth example, the maximum amount of penetration t1 is determined so that the transfer roller cleaning roller 14c penetrated into the concave portion 9e by the maximum amount of penetration t1 removes the toner and the carrier solution deposited in the regions A and B. In addition, the second maximum amount of penetration t2 is determined so that the carrier solution application roller 15e penetrated into the concave portion 9e by the second maximum amount of penetration t2 deposits the toner and the carrier solution in the regions A and B which are located on the blanket seat 9b within the concave portion 9e. Specifically, the maximum amount of penetration t1 and the second maximum amount of penetration t2 are determined by, for example, data or the like obtained through experiments.

In this manner, the transfer device of the image forming apparatus 1 of the fourth example includes the transfer roller 9, the transfer roller cleaning portion 14, and the carrier solution application portion 15.

According to the image forming apparatus 1 of the fourth example, when the concave portion 9e of the transfer roller 9 is located at a position which does not face the transfer roller cleaning roller 14c, the transfer roller cleaning roller 14c is brought into contact with the outer circumferential surface except the concave portion 9e of the transfer roller 9. Therefore, the outer circumferential surface except the concave portion 9e of the transfer roller 9 after the secondary transfer can be cleaned by the transfer roller cleaning roller 14c. Thereby, the remaining liquid developer (remaining toner and remaining carrier solution) adhering to the transfer roller 9 after the secondary transfer can be removed. In addition, when the concave portion 9e of the transfer roller 9 is located at a position facing the transfer roller cleaning roller 14c, the transfer roller cleaning roller 14c is penetrated into the concave portion 9e of the transfer roller 9. At this time, the amount of the penetration of the transfer roller cleaning roller 14c into the concave portion 9e is regulated to the maximum amount of penetration t1 by the first and second transfer roller cleaning roller positioning members 14i and 14j and the first and second cleaning portion body rotation regulating members 14k and 14m. Therefore, using this transfer roller cleaning roller 14c, it is possible to effectively remove the remaining liquid developer (remaining toner and remaining carrier solution) and the application carrier solution which have a tendency to be deposited in the regions A and B of the inclined surfaces of the blanket seat 9b immediately after the penetration thereof into the concave portion 9e from the outer circumferential surface except the concave portion 9e of the transfer roller 9. Thereby, it is possible to prevent the remaining liquid developer and the application carrier solution from being accumulated in the concave portion 9e, and to prevent the remaining liquid developer and the application carrier solution from seeping from the concave portion 9e. Further, in this manner, the remaining liquid developer and the application carrier solution are scarcely deposited in the concave portion 9e, and thus even when the image forming apparatus 1 is used for a long period of time, it is possible to more effectively prevent contamination of peripheral members of the transfer roller 9 such as contamination of rollers other than the transfer roller 9 and contamination of the transfer medium 12 by the deposition of the remaining liquid developer and the application carrier solution in the concave portion 9e. As a result, it is possible to prevent image defects due to the remaining liquid developer and the application carrier solution deposited in the concave portion 9e, and to obtain a high-quality image.

Further, when the concave portion 9e of the transfer roller 9 is located at a position which does not face the carrier solution application roller 15e, the carrier solution application roller 15e is brought into contact with the outer circumferential surface except the concave portion 9e of the transfer roller 9. Therefore, the carrier solution for easily removing the remaining toner can be applied to the outer circumferential surface except the concave portion 9e of the transfer roller 9 after the secondary transfer by the carrier solution application roller 15e. Thereby, the remaining toner adhering to the transfer roller 9 after the secondary transfer can be effectively removed. In addition, when the concave portion 9e of the transfer roller 9 is located at a position facing the carrier solution application roller 15e, the carrier solution application roller 15e is penetrated into the concave portion 9e of the transfer roller 9. At this time, the amount of the penetration of the carrier solution application roller 15e into the concave portion 9e is regulated to the second maximum amount of penetration t2 by the first and second carrier solution application roller positioning members 15i and 15j and the first and second carrier solution application portion body rotation regulating members 15k and 15m. In that case, since the second maximum amount of penetration t2 of the carrier solution application roller 15e is smaller than the maximum amount of penetration t1 of the transfer roller cleaning roller 14c, the carrier solution can be deposited in the regions A and B of the blanket seat 9b as substantially mentioned above. Therefore, using this transfer roller cleaning roller 15e, it is possible to effectively remove the carrier solution applied to the blanket seat 9b within the concave portion 9e by the carrier solution application roller 15e. Thereby, it is possible to obtain a higher-quality image.

In this manner, in the image forming apparatus 1 of the fourth example, since the remaining liquid developer and the application carrier solution are scarcely deposited in the concave portion 9e of the transfer roller 9, it is possible to eliminate the need for the web cleaning mechanism or the suction pump as disclosed in JPA-2004-317980 mentioned above, and to form the transfer device and the image forming apparatus 1 with a simple structure. Since the transfer device and the image forming apparatus 1 are formed with a simple structure, it is possible to realize an inexpensive transfer device and an image forming apparatus which are capable of obtaining high reliability of the transfer device and the image forming apparatus 1 and achieving space saving.

Other configurations, operations, and effects of the image forming apparatus 1 of the fourth example are all the same as those of the image forming apparatus 1 of the second example mentioned above.

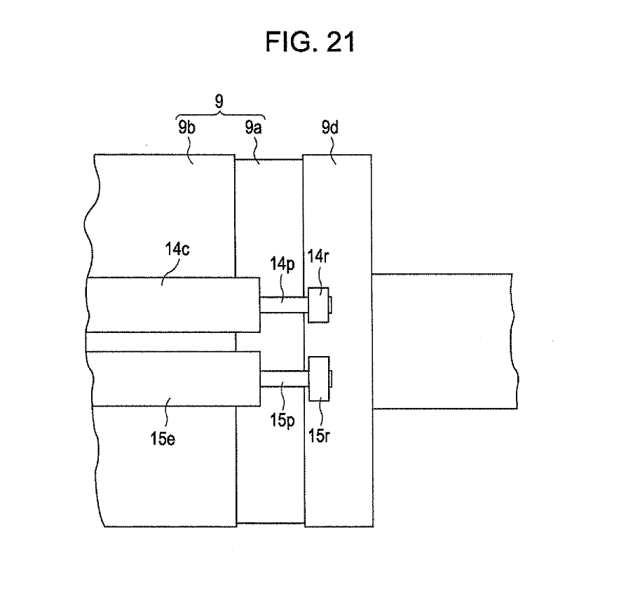

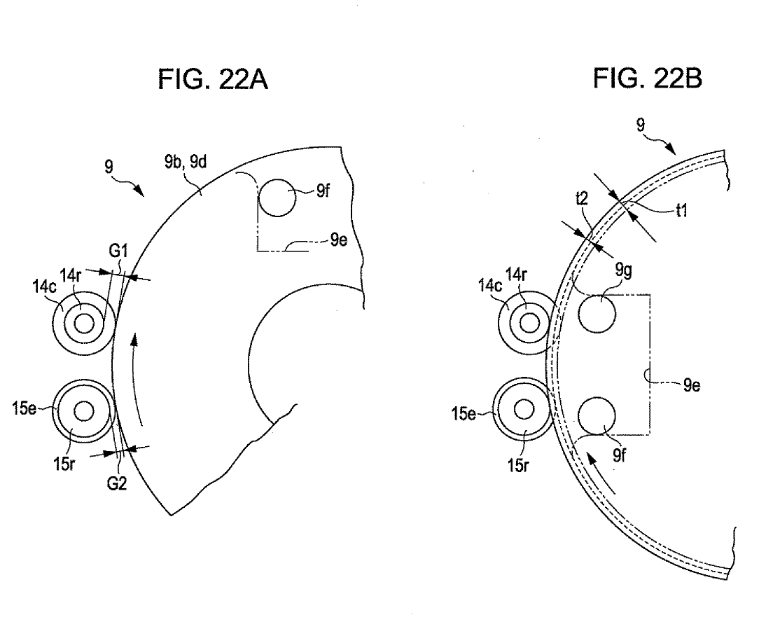

FIG. 21 is a partial view partially illustrating a fifth example of the image forming apparatus according to the embodiment of the invention, FIG. 22A is a diagram illustrating a state where a concave portion of the fifth example shown in FIG. 21 is located at a position which does not face the transfer roller cleaning roller, and FIG. 22B is a diagram illustrating a state where the concave portion of the fifth example shown in FIG. 21 is located at a position facing the transfer roller cleaning roller.

As shown in FIG. 21, in the image forming apparatus of the fifth example, the first and second gap rollers 14q and 14r on the cleaning roller side which are roller members of the invention are respectively rotatably provided on the rotary shaft 14p on both ends of the transfer roller cleaning roller 14c (sign 14q is not shown, but denotes a first gap roller on the cleaning roller side arranged at the rotary shaft 14p on the end on the side opposite to the second gap roller 14r on the cleaning roller side, and the first gap roller on the cleaning roller side is the same as the second gap roller 14r on the cleaning roller side. For the purpose of description, sign 14q is used in the specification).

The transfer roller cleaning roller 14c of the fifth example also comes into contact with the outer circumferential surface except the concave portion 9e of the blanket seat 9b, and is penetrated into the concave portion 9e. In that case, as shown in FIG. 22A, when the concave portion 9e of the transfer roller 9 is located at a position which does not face the transfer roller cleaning roller 14c, the transfer roller cleaning roller 14c comes into contact with the blanket seat 9b on the outer circumferential surface except the concave portion 9e of the transfer roller 9. Thereby, the first and second gap rollers 14q and 14r on the cleaning roller side are respectively separated from the cam follower contact portions 9c and 9d of the transfer roller 9, and a gap G1 on the cleaning roller side is formed between the outer circumferential surfaces of the first and second gap rollers 14q and 14r on the cleaning roller side and the outer circumferential surfaces of the cam follower contact portions 9c and 9d.

In addition, as shown in FIG. 22B, when the concave portion 9e of the transfer roller 9 is located at a position facing the transfer roller cleaning roller 14c, the transfer roller cleaning roller 14c is penetrated into the concave portion 9e. The outer circumferential surfaces of the first and second gap rollers 14q and 14r on the cleaning roller side come into contact with the cam follower contact portions 9c and 9d of the transfer roller 9, respectively, and the gap G1 on the cleaning roller side disappears. In this manner, the first and second gap rollers 14q and 14r on the cleaning roller side come into contact with the cam follower contact portions 9c and 9d, whereby the amount of the penetration of the transfer roller cleaning roller 14c into the concave portion 9e is regulated to a predetermined maximum amount of the penetration. The maximum amount of the penetration of the transfer roller cleaning roller 14c into the concave portion 9e at this time is the maximum amount of penetration t1 same as that of the fourth example shown in FIG. 19 mentioned above. Thus, the transfer roller cleaning member position regulating portion is constituted by the first and second gap rollers 14q and 14r on the cleaning roller side.

On the other hand, as shown in FIG. 21, the first and second gap rollers 15q and 15r on the application roller side which are the second roller member of the invention are respectively rotatably provided on the rotary shaft 15p on both ends of the carrier solution application roller 15e (sign 15q is not shown, but denotes the first gap roller on the application roller side arranged at the rotary shaft 15p on the end on the side opposite to the second gap roller 15r on the application roller side, and the first gap roller on the application roller side is the same as the second gap roller 15r on the application roller side. For the purpose of description, sign 15q is used in the specification).

The carrier solution application roller 15e of the fifth example also comes into contact with the outer circumferential surface except the concave portion 9e of the blanket seat 9b, and is penetrated into the concave portion 9e. In that case, as shown in FIG. 22A, when the concave portion 9e of the transfer roller 9 is located at a position which does not face the carrier solution application roller 15e, the carrier solution application roller 15e comes into contact with the blanket seat 9b on the outer circumferential surface except the concave portion 9e of the transfer roller 9. Thereby, the first and second gap rollers 15q and 15r on the application roller side are respectively separated from the cam follower contact portions 9c and 9d of the transfer roller 9, and a gap G2 on the application roller side is formed between the outer circumferential surfaces of the first and second gap rollers 15q and 15r on the application roller side and the outer circumferential surfaces of the cam follower contact portions 9c and 9d. In the transfer device of the image forming apparatus 1 of the fifth example, the gap G2 on the application roller side is smaller than the gap G1 on the cleaning roller side (G2<G1).

In addition, as shown in FIG. 22B, when the concave portion 9e of the transfer roller 9 is located at a position facing the carrier solution application roller 15e, the carrier solution application roller 15e is penetrated into the concave portion 9e. The outer circumferential surfaces of the first and second gap rollers 15q and 15r on the application roller side come into contact with the cam follower contact portions 9c and 9d of the transfer roller 9, respectively, and the gap G2 on the application roller side disappears. In this manner, the first and second gap rollers 15q and 15r on the application roller side come into contact with the cam follower contact portions 9c and 9d, whereby the amount of the penetration of the carrier solution application roller 15e into the concave portion 9e is regulated to a predetermined maximum amount of the penetration. The maximum amount of the penetration of the carrier solution application roller 15e into the concave portion 9e at this time is the second maximum amount of penetration t2 same as that of the fourth example shown in FIG. 19 mentioned above. Thus, the application member position regulating member and the application member position regulating portion of the invention are constituted by the first and second gap rollers 15q and 15r on the application roller side.

In the image forming apparatus 1 of the fifth example, the gap G1 on the cleaning roller side, that is, the maximum amount of penetration t1 is also determined in advance so that the transfer roller cleaning roller 14c penetrated into the concave portion 9e by the maximum amount of penetration t1 removes the toner and the carrier solution deposited in the regions A and B. In addition, the gap G2 on the application roller side, that is, the second maximum amount of penetration t2 is determined in advance so that the carrier solution application roller 15e penetrated into the concave portion 9e by the second maximum amount of penetration t2 deposits the toner and the carrier solution in the regions A and B which are located on the blanket seat 9b within the concave portion 9e. Specifically, the gap G1 on the cleaning roller side and the gap G2 on the application roller side are determined by, for example, data or the like obtained by experiments.

Other configurations, operations, and effects of the image forming apparatus 1 of the fifth example are all the same as those of the image forming apparatus 1 of the fourth example mentioned above.

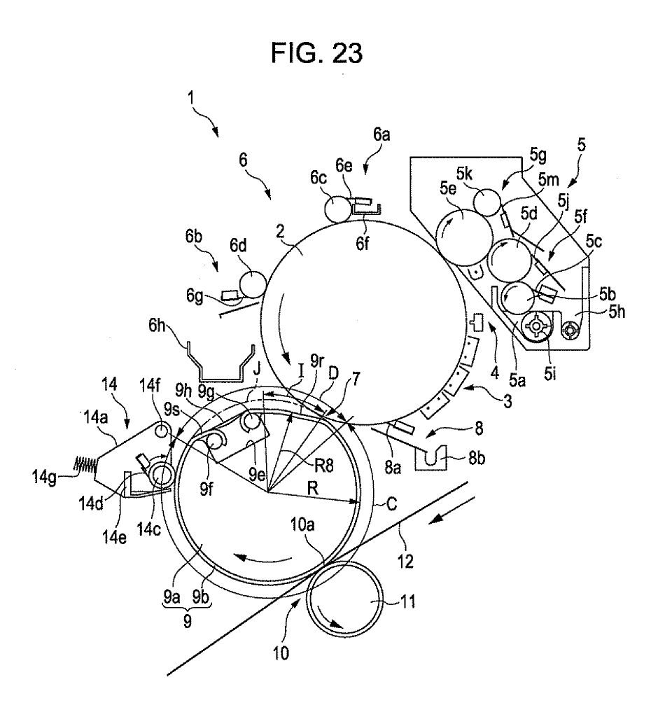

FIG. 23 is a diagram schematically and partially illustrating a portion of a sixth example of the image forming apparatus according to the embodiment of the invention.

As shown in FIG. 23, in the image forming apparatus 1 of the sixth example, the image forming apparatus 1 has a lateral plate which is not shown in the drawing, a rotary shaft of the photoreceptor 2 and a rotary shaft of the transfer roller 9 (equivalent to the image carrying roller of the invention) are supported through a shaft by this lateral plate. Thereby, the distance between the photoreceptor 2 and the transfer roller 9 is determined. In addition, a predetermined region on the circumferential surface portion of the base 9a adjacent to the concave portion 9e in the rotational direction of the transfer roller 9 is formed of a small-diameter region I smaller than the radius of another circumferential surface portion of the base 9a except the concave portion 9e. In that case, the circumferential surface portion of the blanket 9b located at the small-diameter region I of the base 9a includes a circumferential surface portion having a radius R8 (diameter R8 is a maximum length of lengths from the rotation center of the transfer roller 9 to this circumferential surface portion) which is adjacent to the concave portion 9e and is adjacent to the small-diameter region I of the base 9a and a circumferential surface portion having a radius R (circumferential surface portion of the contact portion with which the photoreceptor 2 comes into contact) located at other than the concave portion 9e. In the image forming apparatus 1 of this example, the second diameter R8 is smaller than the first diameter R (R8<R). Meanwhile, in FIG. 23, the diameter R8 is not shown in a position having a maximum length for convenience in order to make an illustration easy to understand.

That is, the transfer roller 9 includes a small-diameter region (small-diameter portion) A smaller than the radius R of another circumferential surface portion except the concave portion 9e of the transfer roller 9 in a predetermined region of the circumferential surface portion of the transfer roller 9 adjacent to the concave portion 9e in the rotational direction of the transfer roller 9. The circumferential surface portion in the small-diameter region I of the transfer roller 9 is located at the rotation center side of the transfer roller 9 from an arc-like virtual circumferential surface portion J shown by the dashed-two dotted line same as the radius R of the circumferential surface portion of the transfer roller 9.

In addition, the circumferential surface portion of the small-diameter region I is formed in a flat or a substantially flat shape, which is smoothly continuous, having no difference in level in the circumferential direction. Meanwhile, the circumferential surface portion of the small-diameter region I can be formed of a convex surface, curved smoothly continuously, having no difference in level in the circumferential direction or a concave surface, curved smoothly continuously, having no difference in level in the circumferential direction. The boundary between the circumferential surface portion of the small-diameter region I and the circumferential surface portion having the radius R is formed smoothly continuously in the curved R portion, and the boundary between the circumferential surface portion of the small-diameter region I and the sidewall surface of the concave portion 9e is also formed smoothly continuously in the curved R portion.

The transfer roller 9 includes an image region (image portion) C in which the toner image is transferred to the circumferential surface portion of the blanket 9b and a non-image region (non-image portion) D in which the toner image is not transferred to the circumferential surface portion thereof. That is, since an image cannot be formed in the concave portion 9e, the concave portion 9e is provided, and thus the non-image region D exists in the circumferential surface portion of the transfer roller 9. The concave portion 9e and the small-diameter region I are arranged in the non-image region D.

In the image forming apparatus 1 of the sixth example, the transfer roller cleaning portion 14 constitutes an image carrying roller cleaning portion of the invention, the transfer roller cleaning roller 14c constitutes an image carrying roller cleaning member of the invention.

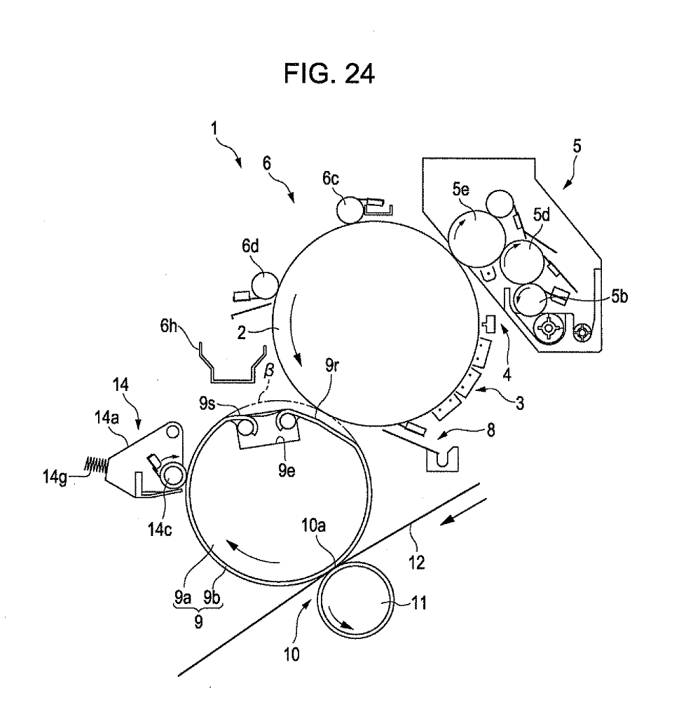

Incidentally, in the image forming apparatus 1 of the sixth example, the transfer roller 9 includes the small-diameter region I adjacent to the concave portion 9e in the rotational direction side of the transfer roller 9 as described above. In addition, the photoreceptor 2 and the transfer roller 9 are respectively positioned in fixed positions and are rotatably supported through a shaft by the apparatus body. Therefore, as shown in FIG. 24, when the transfer roller 9 is rotated and the small-diameter region of the transfer roller 9 reaches a position coming into contact with the circumferential surface portion of the photoreceptor 2, the circumferential surface portion of the transfer roller 9 is separated from the photoreceptor 2. That is, the small-diameter region T of the transfer roller 9 is formed of the noncontact portions 9r and 9s which do not come into contact with the photoreceptor 2. Since the noncontact portions 9r and 9s of the transfer roller 9 do not come into contact with the photoreceptor 2 in this manner, the movement of the toner and the carrier solution from the photoreceptor 2 is suppressed.

Other configurations of the image forming apparatus 1 of the sixth example are the same as those of the image forming apparatus 1 of the second example mentioned above.

Next, operations of the primary transfer portion 7 and the secondary transfer portion 10 in the image forming apparatus 1 of the sixth example will be described.

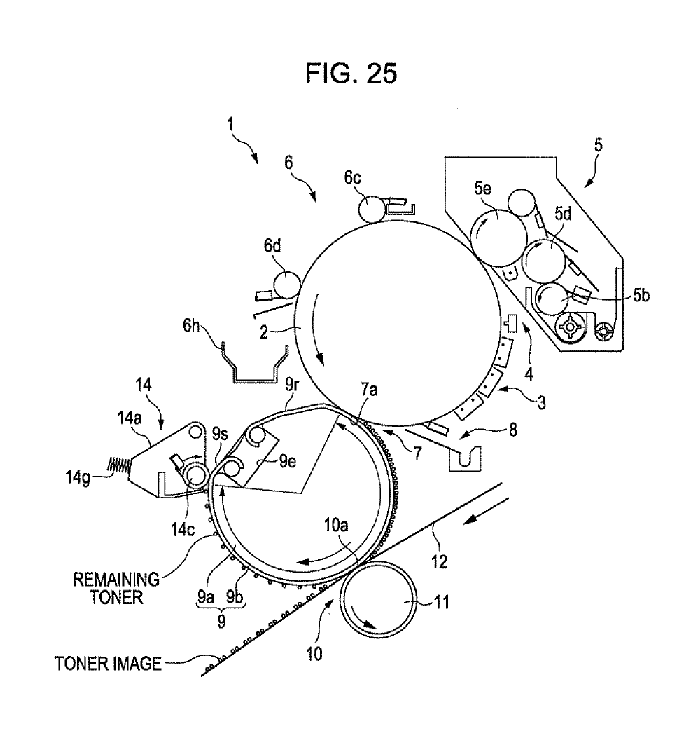

As shown in FIG. 25, the toner image transferred from the photoreceptor 2 to an image region C of the transfer roller 9 by the primary transfer nip 7a of the primary transfer portion 7 is penetrated into the secondary transfer nip 10a of the secondary transfer portion 10 by the further rotation of the transfer roller 9 and is transferred to the transfer medium 14 by the secondary transfer nip 10a. At this time, when the terminal end of the image region C of the transfer roller 9 in the rotational direction of the transfer roller is located at the primary transfer nip 7a, the tip of the image region C in the rotational direction of the transfer roller comes close to or reaches the contact portion of the transfer roller cleaning roller 14c with the photoreceptor 2.

When the transfer in the primary transfer portion 7 is terminated, the non-image region D is penetrated into the primary transfer nip 7a by the further rotation of the transfer roller 9. When the transfer roller 9 is further rotated, the small-diameter region I is penetrated into the primary transfer nip 7a. At this time, the circumferential surface portion of the small-diameter region I is separated from the photoreceptor 2 as described above with reference to FIG. 24, and is not brought into contact with the photoreceptor. Thereby, the remaining liquid developer adhering to the photoreceptor 2 after the transfer in the primary transfer portion 7 is not nearly transferred to the small-diameter region I, and only a small amount of the remaining liquid developer adheres to the small-diameter region I.

In addition, after the transfer of the toner image to the transfer medium 14 in the secondary transfer portion 10 is terminated, the transfer remaining liquid developer remains in the surface of the transfer roller 9. The transfer roller 9 is cleaned by the transfer roller cleaning roller 14c, and the toner and the carrier solution of the remaining liquid developer are removed from the transfer roller 9. At this time, since the transfer roller cleaning roller 14c rotates counter to the rotation of the transfer roller 9, the remaining toner and the remaining carrier solution adhering to the surface of the transfer roller 9 are rubbed off. The toner and the carrier solution which are rubbed off and attached to the transfer roller cleaning roller 14c are scraped off by the transfer roller cleaning blade 14d and are recovered in the liquid developer recovery portion 14e. The toner and the carrier solution recovered in the liquid developer recovery portion 14e are transported to a waste toner box which is not shown in the drawing.

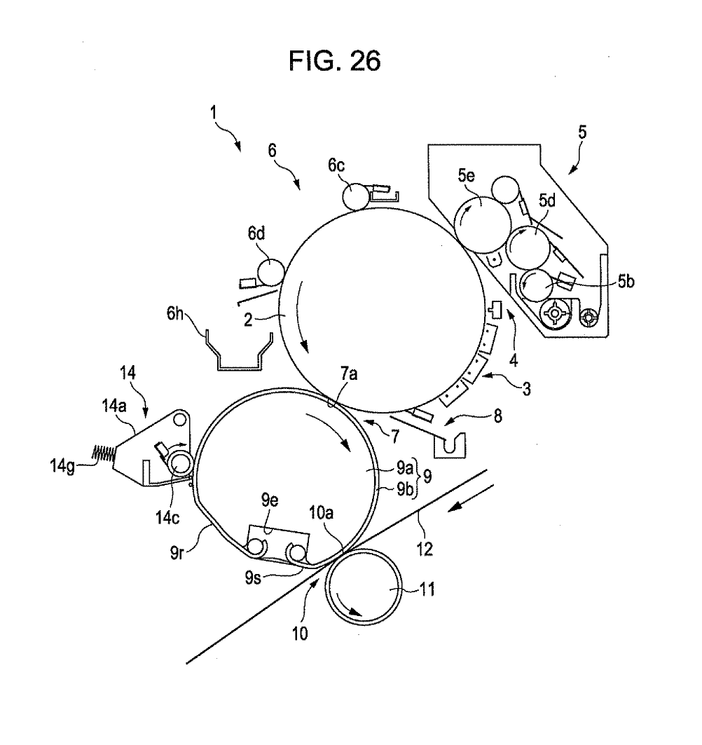

As shown in FIG. 26, when the concave portion 9e passes through the secondary transfer nip 10a, the terminal end of the image region C in the rotational direction of the transfer roller reaches the contact portion of the transfer roller cleaning roller 14c with the transfer roller 9. Thereby, the cleaning of the image region C by the transfer roller cleaning roller 14c is terminated. Thereafter, when the transfer roller 9 is further rotated, the small-diameter region I is penetrated into the contact position of the transfer roller 9 with the transfer roller cleaning roller 14c. When the transfer roller 9 is further rotated, the small-diameter region I is rotated while coming into contact with the transfer roller cleaning roller 14c. At this time, since the transfer roller cleaning roller 14c rotates counter to the rotation of the transfer roller 9, the transfer roller cleaning roller 14c rubs off an extremely small amount of the toner and an extremely small amount of the carrier solution adhering to the small-diameter region I.

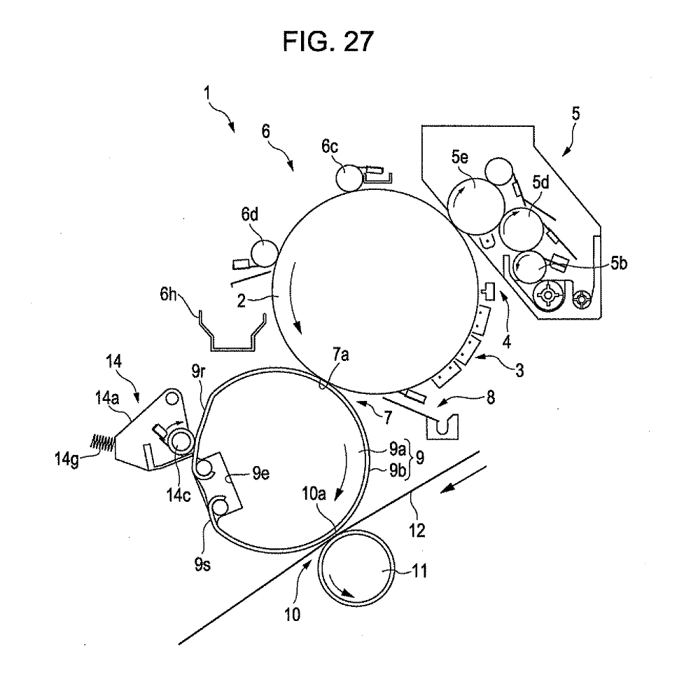

As shown in FIG. 27, the end on the rotational direction side of the small-diameter region I is located at the contact position with the transfer roller cleaning roller 14c. Thereby, the transfer roller cleaning roller 14c almost completely wears out an extremely small amount of the toner and an extremely small amount of the carrier solution adhering to the small-diameter region I of the transfer roller 9. Therefore, the toner and the carrier solution are not nearly transported from the small-diameter region I to the cover member 9h provided on the adjacent concave portion 9e. Thereby, a very extremely small amount of the toner and a very extremely small amount of the carrier solution after an extremely small amount of the toner and an extremely small amount of the carrier solution adhering to the small-diameter region I are worn out merely adhere to the cover member 9h.

In this manner, since a very extremely small amount of the remaining toner and the remaining carrier solution merely adhere to the cover member 9h, the remaining toner and the remaining carrier solution are not nearly accumulated in the concave portion 9e, and the remaining toner and the remaining carrier solution do not also seep from the concave portion 9e.

According to the image forming apparatus 1 of the sixth example, the transfer roller 9 includes the small-diameter region I adjacently to the concave portion 9e in the rotational direction of the transfer roller 9. In addition, the photoreceptor 2 and the transfer roller 9 are respectively positioned in fixed positions and are rotatably supported through a shaft by the apparatus body. Therefore, the small-diameter region I of the transfer roller 9 can be formed of the noncontact portions 9r and 9s which do not come into contact with the photoreceptor 2. Thereby, it is possible to suppress the movement of the remaining toner and the remaining carrier solution from the photoreceptor 2 to the noncontact portions 9r and 9s of the transfer roller 9. Thereby, the amounts of the remaining toner and the remaining carrier solution possibly adhering to the small-diameter region I can all be made extremely small.

Therefore, the adhesion of the remaining toner and the remaining carrier solution to the cover member 9h of the concave portion 9e adjacent to the small-diameter region I of the transfer roller 9 can be suppressed, and the amounts of the remaining toner and the remaining carrier solution possibly adhering to the cover member 9h can all be made extremely small. Thereby, it is possible to prevent the remaining toner and the remaining carrier solution from being accumulated in the concave portion 9e, and to prevent the remaining toner and the remaining carrier solution from seeping from the concave portion 9e. Further, in this manner, the remaining toner is scarcely accumulated in the concave portion 9e, and thus even when the image forming apparatus 1 is used for a long period of time, it is possible to more effectively prevent contamination of peripheral members of the transfer roller 9 such as contamination of rollers other than the transfer roller 9 and contamination of the transfer medium 14 by accumulating the remaining toner in the concave portion 9e. As a result, it is possible to eliminate the need for the web cleaning mechanism or the suction pump as disclosed in JPA-2004-317980 mentioned above, and to form the image forming apparatus 1 with a simple structure. Further, since the image forming apparatus 1 is formed with a simple structure in this manner, it is possible to realize the inexpensive image forming apparatus 1 capable of obtaining high reliability and achieving space saving.

Particularly, an extremely small amount of the remaining toner and an extremely small amount of the remaining carrier solution adhering to the small-diameter region I are almost completely worn out by the transfer roller cleaning roller 14c, whereby it is possible to more effectively suppress the adhesion of the remaining toner and the remaining carrier solution to the cover member 9h. Therefore, the amounts of the remaining toner and the remaining carrier solution possibly adhering to the cover member 9h can be all made very extremely small.

In addition, the diameter R8 of the circumferential surface portion of the noncontact portions 9r and 9s of the transfer roller 9 is made smaller than the first diameter R of the circumferential surface portion of the contact portion of the transfer roller 9 coming into contact with the photoreceptor 2, thereby allowing the accumulation of the remaining toner in the concave portion 9e to be suppressed with a much simpler structure.

Further, the noncontact portions 9r and 9s which do not come into contact with the photoreceptor 2 are provided in the non-image region (non-image portion) D in which an image is not formed, and thus do not influence the image even when the noncontact portions 9r and 9s are provided. Therefore, even when the image forming apparatus 1 is used for a long period of time, a satisfactory image can be always stably obtained.

Other operations and effects of the image forming apparatus 1 of the sixth example are the same as those of the image forming apparatus 1 of the second example mentioned above.

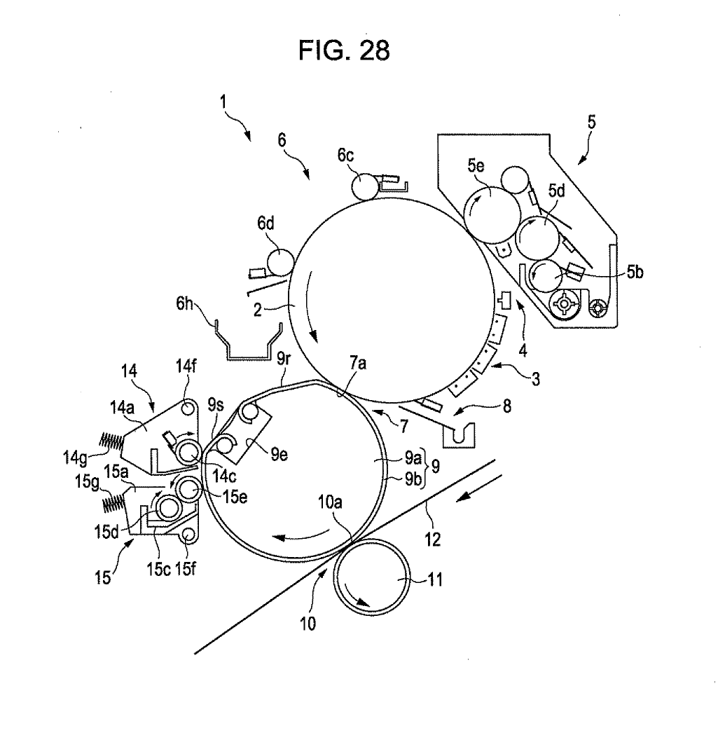

FIG. 28 is a diagram schematically and partially illustrating a portion of a seventh example of the image forming apparatus according to the embodiment of the invention.

As shown in FIG. 28, the image forming apparatus 1 of the seventh example is configured such that the carrier solution application portion 15 which is a cleaning solution application portion is arranged in the image forming apparatus 1 of the sixth example mentioned above. In that case, the carrier solution application portion 15 is arranged on the direction side opposite to the rotational direction of the transfer roller 9 from the transfer roller cleaning portion 14. The carrier solution application portion 15 includes an application portion body 15a, a carrier solution storage portion 15c, a carrier solution supply roller 15d, and a carrier solution application roller 15e. The application portion body 15a is provided in the apparatus body of the image forming apparatus 1 so as to be rotated by the rotary shaft 15f. The carrier solution storage portion 15c stores the carrier solution applied to the transfer roller 9. The carrier solution supply roller 15d and the carrier solution application roller 15e are provided so as to be rotated with each other. In that case, the carrier solution application roller 15e is trail-rotated with respect to the rotation of the transfer roller 9.

The application portion body 15a is biased so as to be rotated centering on the rotary shaft 15f by the biasing force of the spring 15g, and thus the carrier solution application roller 15e is brought into contact with the circumferential surface portion of the transfer roller 9. The carrier solution supply roller 15d draws up the carrier solution stored in the carrier solution storage portion 15c by rotation and supplies the carrier solution to the carrier solution application roller 15e. In addition, the carrier solution application roller 15e is rotated to thereby apply the carrier solution, which is a cleaning solution supplied from the carrier solution application roller 15e, to the circumferential surface portion of the transfer roller 9. Other configurations of the image forming apparatus 1 of the seventh example are the same as those of the image forming apparatus 1 of the sixth example.

In the image forming apparatus 1 of the seventh example having such a configuration, before the transfer roller cleaning roller 14c of the transfer roller cleaning portion 14 rubs off the toner and the carrier solution adhering to the surface of the transfer roller 9, a small amount of the carrier solution is applied to the surface of the transfer roller 9 by the carrier solution application roller 15e. Thereby, the toner adhering to the surface of the transfer roller 9 is more easily removed, and thus the cleaning performance of the transfer roller 9 can be improved. In that case, the carrier solution of the liquid developer is used in order to remove the toner, whereby the cleaning is completed without using an exclusive cleaning solution. Therefore, it is possible to easily and inexpensively remove the toner adhering to the surface of the transfer roller 9.

Other operations and effects of the image forming apparatus 1 of the seventh example are the same as those of the image forming apparatus 1 of the sixth example. Meanwhile, when the cleaning performance of the transfer roller 9 can be improved by applying a small amount of the carrier solution to the surface of the transfer roller 9, application members other than the carrier solution application roller 15e can also be used. In addition, when the cleaning performance of the transfer roller 9 can be improved by applying a small amount of the solution to the surface of the transfer roller 9, application solutions other than the carrier solution can also be used.

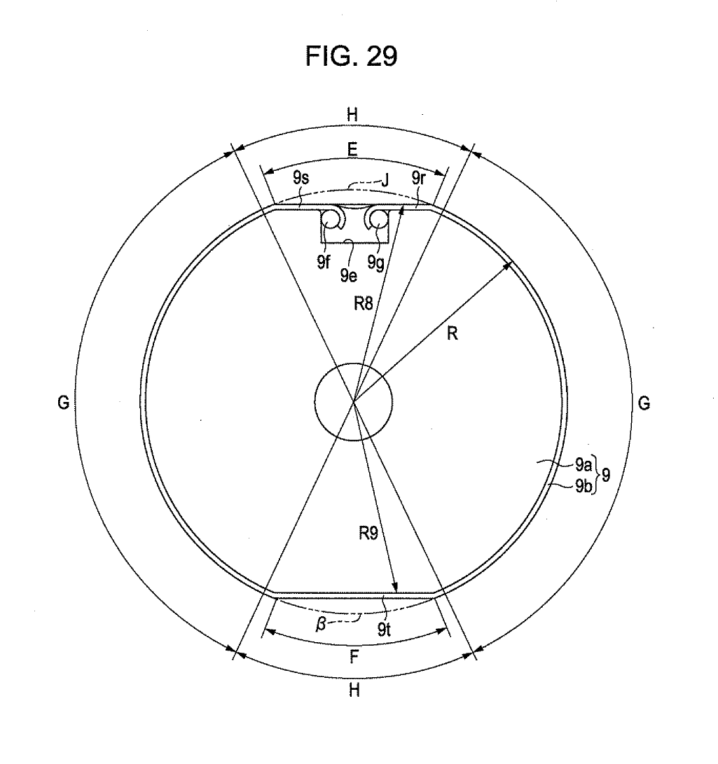

FIG. 29 is a diagram schematically and partially illustrating a transfer roller used in an eighth example of the image forming apparatus according to the embodiment of the invention.

As shown in FIG. 29, the image forming apparatus 1 of the eighth example includes the transfer roller 9 capable of performing a continuous transfer to two transfer mediums 14 through one rotation of the transfer roller 9. That is, the transfer roller 9 of the eighth example includes two image regions G, two non-image regions H, a first small-diameter region E, and a second small-diameter region F.

The first small-diameter region E is provided in one non-image region H provided with the concave portion 9e. The diameter R8 (maximum length of lengths from the rotation center of the transfer roller 9 to the circumferential surface portion in the first small-diameter region E) of the circumferential surface portion of the blanket 9b in the first small-diameter region E is smaller than the radius R of the circumferential surface portion of the blanket 9b except the first and second small-diameter regions E and F (R8<R). In addition, the second small-diameter region F is provided in the other non-image region H. The diameter R9 (maximum length of lengths from the rotation center of the transfer roller 9 to the circumferential surface portion in the second small-diameter region F) of the circumferential surface portion of the blanket 9b in the second small-diameter region F is smaller than the radius R of the circumferential surface portion of the blanket 9b except the first and second small-diameter regions E and F (R9<R). Meanwhile, in FIG. 29, the diameter R9 is not shown in a position having a maximum length for convenience in order to make an illustration easy to understand. The first and second small-diameter regions E and F do not come into contact with the photoreceptor 2 similarly to the small-diameter region I of the first and seventh examples, and constitute the noncontact portions 9r and 9s and a second noncontact portion 9t of the invention, respectively. In addition, the first small-diameter region E is provided adjacent to the concave portion 9e in both rotational directions of the transfer roller 9. On the other hand, the second small-diameter region F is provided facing the concave portion 9e.

Other configurations of the image forming apparatus 1 of the eighth example are the same as those of the image forming apparatus 1 of the sixth example.

In the image forming apparatus 1 of the eighth example having such a configuration, it is possible to wear out a small amount of the remaining toner and a small amount of the remaining carrier solution adhering to the first and second small-diameter regions E and F using the transfer roller cleaning roller 14c, between two transfer mediums 14, that is, in the first and second small-diameter regions E and F provided in two non-image regions H. In this manner, the non-image region H between the two transfer mediums 14 is used in the small-diameter region F, thereby allowing the remaining toner and the remaining carrier solution to be efficiently worn out. Other operations and effects of the image forming apparatus 1 of the eighth example are the same as those of the image forming apparatus 1 of the sixth example.

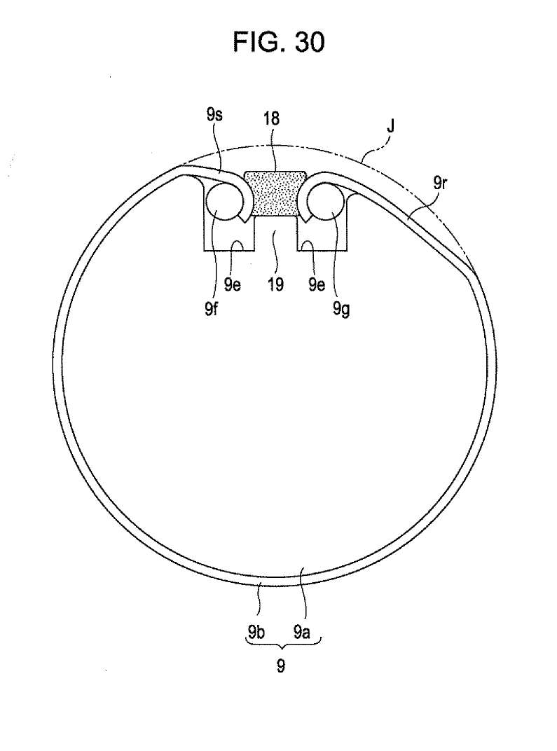

FIG. 30 is a diagram schematically and partially illustrating a transfer roller used in a ninth example of the image forming apparatus according to the embodiment of the invention.

As shown in FIG. 30, in the image forming apparatus 1 of the ninth example, a blockish toner absorbing member 18 that absorbs toner is provided at the arrangement position of the cover member 9h instead of the sheet-like cover member 9h of the image forming apparatus 1 of the sixth example mentioned above. The toner absorbing member 18 is arranged so as to cover the opening circumferential surface (more specifically, gap between both ends of the blanket 9b) of the concave portion 9e. Appropriate materials known in the related art such as a sponge capable of absorbing toner inside can be used in the cover member 18. In addition, a toner absorbing member support portion 19 is provided within the concave portion 9e in a protruding state, and the toner absorbing member 18 is supported by the toner absorbing member support portion 19 in the rotation center direction of the transfer roller 9. A very extremely small amount of the toner and a small amount of the carrier solution are absorbed by the toner absorbing member 18. In addition, the toner absorbing member 18 is supported by the toner absorbing member support portion 19, whereby the transfer roller cleaning roller 14c is prevented from falling to the opening circumferential surface (more specifically, gap between both ends of the blanket 9b) of the concave portion 9e.

Other configurations, operations and effects of the image forming apparatus 1 of the ninth example are all the same as those of the image forming apparatus 1 of the sixth example.

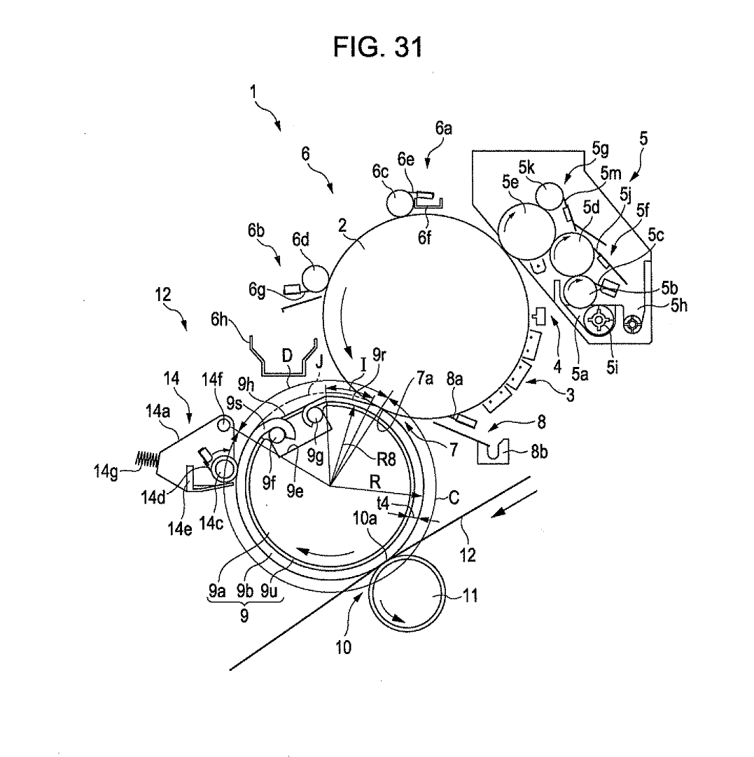

FIG. 31 is a diagram schematically and partially illustrating a portion of a tenth example of the image forming apparatus according to the embodiment of the invention.

As shown in FIG. 31, in the image forming apparatus 1 of the tenth example, the blanket 9b includes a thin film thickness portion I (corresponding to the small-diameter region I of the sixth example) provided in a predetermined region adjacent to the concave portion 9e in the rotational direction side of the transfer roller 9. In that case, the thickness of the thin film thickness portion I on the side of the blanket 9b except the thin film thickness portion I becomes larger than the thickness of the thin film thickness portion I on the concave portion 9e side. Thickness t3 (specifically, maximum thickness of the thin film thickness portion I, equivalent to the second thickness of the invention) of the thin film thickness portion I is smaller than thickness t4 (equivalent to the first thickness of the invention) of the blanket 9b except the thin film thickness portion I (t3<t4). Meanwhile, in FIG. 31, the thickness t3 is not shown in a position for convenience in order to make an illustration easy to understand maximum length.

Therefore, the diameter R8 of the outer circumferential surface of the thin film thickness portion I of the transfer roller 9 is smaller than the radius R of other outer circumferential surfaces except the concave portion 9e of the transfer roller 9 (R8<R). As a result, the outer circumferential surface of the transfer roller 9 in the thin film thickness portion I is located at the rotation center side of the transfer roller 9 from an arc-like virtual outer circumferential surface B shown by the dashed-two dotted line having a radius same as the radius R of the outer circumferential surface of the transfer roller 9.

In addition, the outer circumferential surface of the thin film thickness portion I is formed in a flat or substantially flat shape, which is smoothly continuous, having no difference in level in the circumferential direction. Meanwhile, the outer circumferential surface of the thin film thickness portion I can be formed of a convex surface, curved smoothly continuously, having no difference in level in the circumferential direction or a concave surface, curved smoothly continuously, having no difference in level in the circumferential direction. The boundary between the outer circumferential surface of the thin film thickness portion I and the outer circumferential surface having the radius R is formed smoothly continuously in the curved R portion, and the boundary between the outer circumferential surface of the thin film thickness portion I and the sidewall surface of the concave portion 9e is also formed smoothly continuously in the curved R portion.

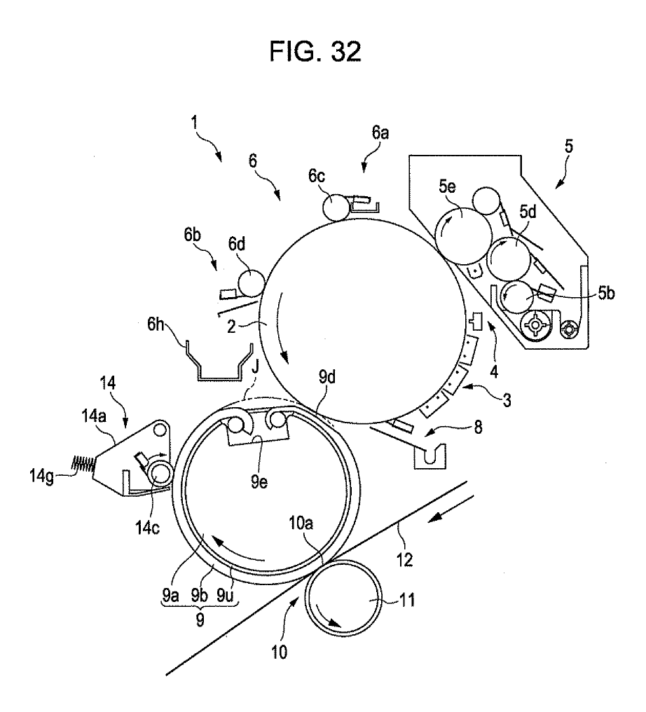

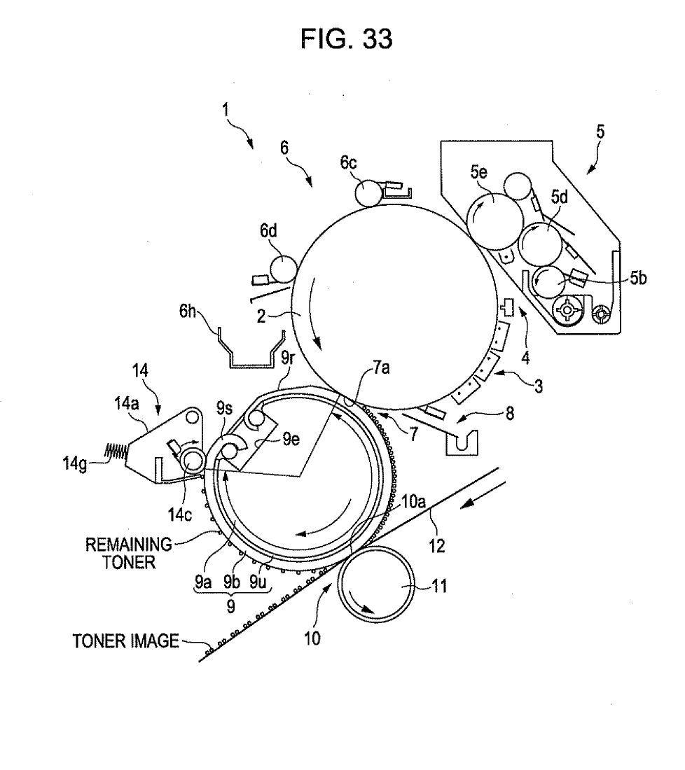

Incidentally, in the image forming apparatus 1 of the tenth example, the transfer roller 9 includes the thin film thickness portion I adjacent to the concave portion 9e in the rotational direction side of the transfer roller 9 as described above. In addition, the photoreceptor 2 and the transfer roller 9 are respectively positioned in fixed positions and are rotatably supported through a shaft by the apparatus body. Therefore, as shown in FIG. 32, when the transfer roller 9 is rotated and the thin film thickness portion I of the transfer roller 9 reaches a position coming into contact with the outer circumferential surface of the photoreceptor 2, the outer circumferential surface of the transfer roller 9 is separated from the photoreceptor 2. That is, the thin film thickness portion I of the transfer roller 9 is formed of the noncontact portions 9r and 9s which do not come into contact with the photoreceptor 2. Since the noncontact portions 9r and 9s of the transfer roller 9 do not come into contact with the photoreceptor 2 in this manner, the movement of the toner and the carrier solution from the photoreceptor 2 is suppressed.

Other configurations of the image forming apparatus 1 of the tenth example are the same as those of the sixth example mentioned above.

Next, operations of the primary transfer portion 7 and the secondary transfer portion 10 in the image forming apparatus 1 of the tenth example will be described.

When the transfer in the primary transfer portion 7 is terminated, the non-image region D is penetrated into the primary transfer nip 7a by the further rotation of the transfer roller 9. When the transfer roller 9 is further rotated, the thin film thickness portion I is penetrated into the primary transfer nip 7a. At this time, the outer circumferential surface of the thin film thickness portion I is separated from the photoreceptor 2 as described above with reference to FIG. 32, and is not brought into contact with the photoreceptor. Thereby, the remaining liquid developer adhering to the photoreceptor 2 after the transfer in the primary transfer portion 7 is not nearly transferred to the thin film thickness portion I, and only a small amount of the remaining liquid developer adheres to the thin film thickness portion I.

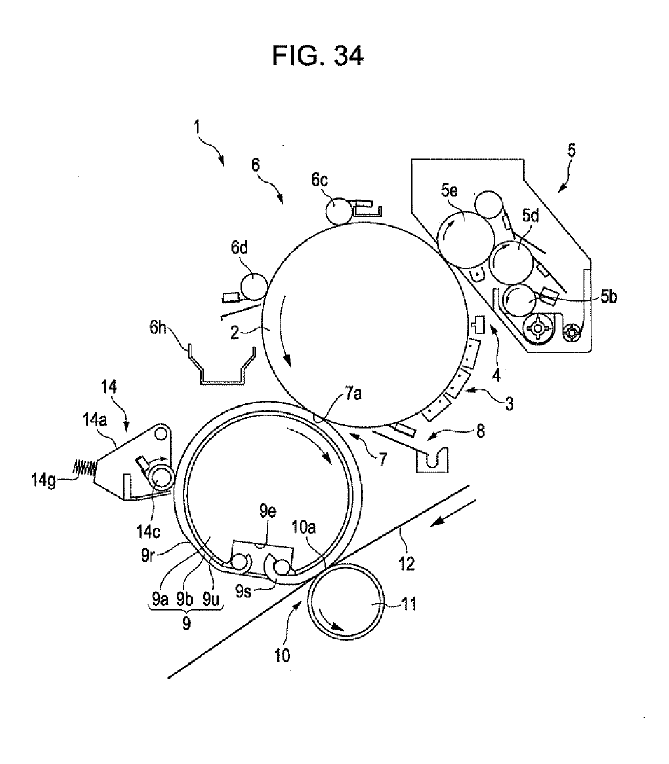

As shown in FIG. 34, when the concave portion 9e passes through the secondary transfer nip 10a, the terminal end of the image region C in the rotational direction of the transfer roller reaches the contact portion of the transfer roller cleaning roller 14c with the transfer roller 9. Thereby, the cleaning of the image region C by the transfer roller cleaning roller 14c is terminated. Thereafter, when the transfer roller 9 is further rotated, the thin film thickness portion I is penetrated into the contact position of the transfer roller 9 with the transfer roller cleaning roller 14c. When the transfer roller 9 is further rotated, the thin film thickness portion I is rotated while coming into contact with the transfer roller cleaning roller 14c. At this time, sin the transfer roller cleaning roller 14c rotates counter to the rotation of the transfer roller 9, the transfer roller cleaning roller 14c rubs off an extremely small amount of the toner and an extremely small amount of the carrier solution adhering to the thin film thickness portion I.

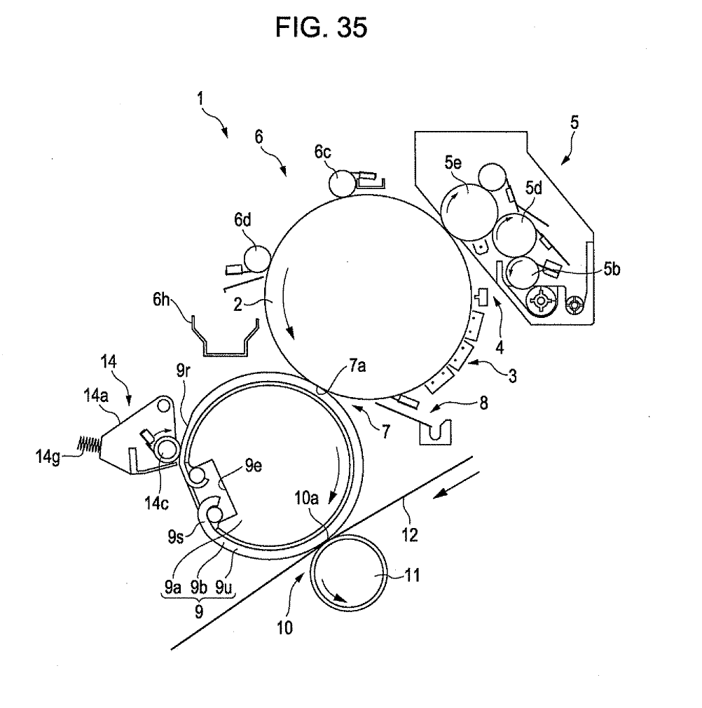

As shown in FIG. 35, the end on the rotational direction side of the thin film thickness portion I is located at the contact position with the transfer roller cleaning roller 14c. Thereby, the transfer roller cleaning roller 14c almost completely wears out an extremely small amount of the toner and an extremely small amount of the carrier solution adhering to the thin film thickness portion I of the transfer roller 9. Therefore, the toner and the carrier solution are not nearly transported from the thin film thickness portion I to the cover member 9h provided on the adjacent concave portion 9e. Thereby, a very extremely small amount of the toner and a very extremely small amount of the carrier solution after an extremely small amount of the toner and an extremely small amount of the carrier solution adhering to the thin film thickness portion I are worn out merely adhere to the cover member 9h.

In this manner, since a very extremely small amount of the remaining toner and the remaining carrier solution merely adhere to the cover member 9h, the remaining toner and the remaining carrier solution are not nearly accumulated in the concave portion 9e, and the remaining toner and the remaining carrier solution do not also seep from the concave portion 9e.

According to the image forming apparatus 1 of the tenth example, the transfer roller 9 includes the thin film thickness portion I adjacently to the concave portion 9e in the rotational direction of the transfer roller 9. In addition, the photoreceptor 2 and the transfer roller 9 are respectively positioned in fixed positions and are rotatably supported through a shaft by the apparatus body. Therefore, the thin film thickness portion I of the transfer roller 9 can be formed of the noncontact portions 9r and 9s which do not come into contact with the photoreceptor 2. Thereby, it is possible to suppress the movement of the remaining toner and the remaining carrier solution from the photoreceptor 2 to the noncontact portions 9r and 9s of the transfer roller 9. Thereby, the amounts of the remaining toner and the remaining carrier solution possibly adhering to the thin film thickness portion I can all be made extremely small.

Therefore, the adhesion of the remaining toner and the remaining carrier solution to the cover member 9h of the concave portion 9e adjacent to the thin film thickness portion I of the transfer roller 9 can be suppressed, and the amounts of the remaining toner and the remaining carrier solution possibly adhering to the cover member 9h can all be made extremely small. Thereby, it is possible to prevent the remaining toner and the remaining carrier solution from being accumulated in the concave portion 9e, and to prevent the remaining toner and the remaining carrier solution from seeping from the concave portion 9e. further, in this manner, the remaining toner is scarcely accumulated in the concave portion 9e, and thus even when the image forming apparatus 1 is used for a long period of time, it is possible to more effectively prevent contamination of peripheral members of the transfer roller 9 such as contamination of rollers other than the transfer roller 9 and contamination of the transfer medium 12 by accumulating the remaining toner in the concave portion 9e. As a result, it is possible to eliminate the need for the web cleaning mechanism or the suction pump as disclosed in JP-A-2004-317980 mentioned above, and to form the image forming apparatus 1 with a simple structure. Further, since the image forming apparatus 1 is formed with a simple structure in this manner, it is possible to realize the inexpensive image forming apparatus 1 capable of obtaining high reliability and achieving space saving.

Particularly, an extremely small amount of the remaining toner and an extremely small amount of the remaining carrier solution adhering to the thin film thickness portion I are almost completely worn out by the transfer roller cleaning roller 14c, whereby it is possible to more effectively suppress the adhesion of the remaining toner and the remaining carrier solution to the cover member 9h. Therefore, the amounts of the remaining toner and the remaining carrier solution possibly adhering to the cover member 9h can be all made very extremely small.

In addition, the thickness t3 of the noncontact portions 9r and 9s of the blanket 9b is made smaller than the thickness t4 of the contact portion of the blanket coming into contact with the photoreceptor 2, thereby allowing the accumulation of the remaining toner in the concave portion 9e to be suppressed with a much simpler structure.

Further, the noncontact portions 9r and 9s which do not come into contact with the photoreceptor 2 are provided in the non-image region (non-image portion) D in which an image is not formed, and thus do not influence the image even when the noncontact portions 9r and 9s are provided. Therefore, even when the image forming apparatus 1 is used for a long period of time, a satisfactory image can be always stably obtained.

Other operations and effects of the image forming apparatus 1 of the tenth example are the same as those of the sixth example.

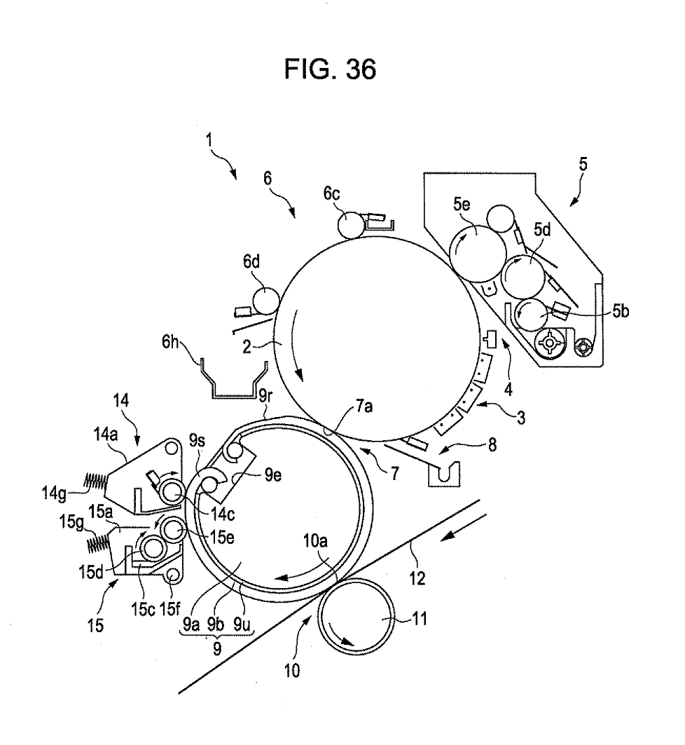

FIG. 36 is a diagram schematically and partially illustrating a portion of an eleventh example of the image forming apparatus according to the embodiment of the invention.

As shown in FIG. 36, the image forming apparatus 1 of the eleventh example is configured such that the carrier solution application portion 15 which is a cleaning solution application portion is arranged in the image forming apparatus 1 of the tenth example mentioned above. In that case, the carrier solution application portion 15 is arranged on the direction side opposite to the rotational direction of the transfer roller 9 from the transfer roller cleaning portion 14. The carrier solution application portion 15 includes an application portion body 15a, a carrier solution storage portion 15b, a carrier solution supply roller 15c, and a carrier solution application roller 15d. The application portion body 15a is provided in the apparatus body of the image forming apparatus 1 so as to be rotated by the rotary shaft 15e. The carrier solution storage portion 15b stores the carrier solution applied to the transfer roller 9. The carrier solution supply roller 15c and the carrier solution application roller 15d are provided so as to be rotated with each other. In that case, the carrier solution application roller 15d is trail-rotated with respect to the rotation of the transfer roller 9.

The application portion body 15a is biased so as to be rotated centering on the rotary shaft 15e by the biasing force of the spring 15f, and thus the carrier solution application roller 15d is brought into contact with the outer circumferential surface of the transfer roller 9. The carrier solution supply roller 15c draws up the carrier solution stored in the carrier solution storage portion 15b by rotation and supplies the carrier solution to the carrier solution application roller 15d. In addition, the carrier solution application roller 15d is rotated to thereby apply the carrier solution, which is a cleaning solution supplied from the carrier solution application roller 15d, to the outer circumferential surface of the transfer roller 9.

Other configurations of the image forming apparatus 1 of the eleventh example are the same as those of the image forming apparatus 1 of the tenth example.

In the image forming apparatus 1 of the eleventh example having such a configuration, before the transfer roller cleaning roller 14c of the transfer roller cleaning portion 14 rubs off the toner and the carrier solution adhering to the surface of the transfer roller 9, a small amount of the carrier solution is applied to the surface of the transfer roller 9 by the carrier solution application roller 15e. Thereby, the toner adhering to the surface of the transfer roller 9 is more easily removed, and thus the cleaning performance of the transfer roller 9 can be improved. In that case, the carrier solution of the liquid developer is used in order to remove the toner, whereby the cleaning is completed without using an exclusive cleaning solution. Therefore, it is possible to easily and inexpensively remove the toner adhering to the surface of the transfer roller 9.

Other operations and effects of the image forming apparatus 1 of the eleventh example are the same as those of the image forming apparatus 1 of the tenth example. Meanwhile, when the cleaning performance of the transfer roller 9 can be improved by applying a small amount of the carrier solution to the surface of the transfer roller 9, application members other than the carrier solution application roller 15d can also be used. In addition, when the cleaning performance of the transfer roller 9 can be improved by applying a small amount of the solution to the surface of the transfer roller 9, application solutions other than the carrier solution can also be used.

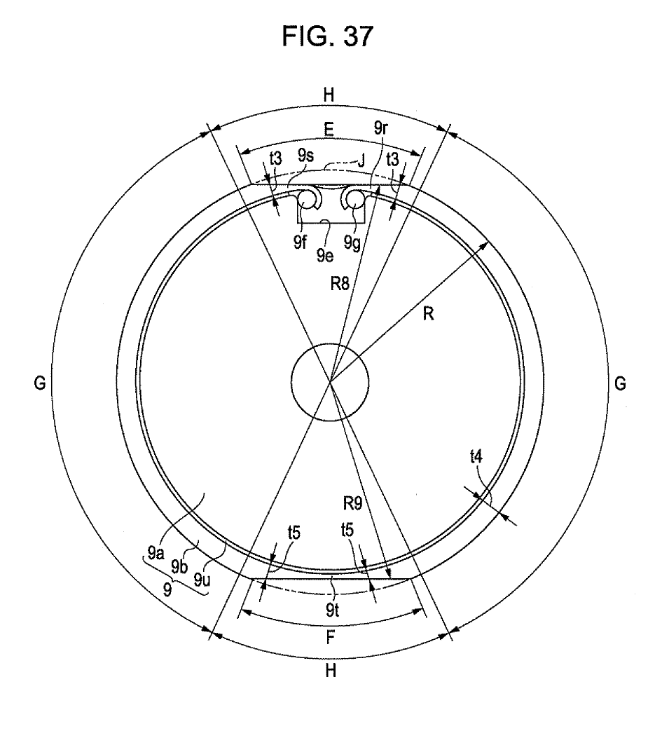

FIG. 37 is a diagram schematically and partially illustrating a transfer roller used in a twelfth example of the image forming apparatus according to the embodiment of the invention.

As shown in FIG. 37, the image forming apparatus 1 of the twelfth example includes the transfer roller 9 capable of performing a continuous transfer to two transfer mediums 12 through one rotation of the transfer roller 9. That is, the transfer roller 9 of the twelfth example includes two image regions 0, two non-image regions H, a first thin film thickness portion E, and a second thin film thickness portion F.

The first thin film thickness portion E is provided in one non-image region H provided with the concave portion 9e. The diameter R3 (maximum length of lengths from the rotation center of the transfer roller 9 to the outer circumferential surface in the first thin film thickness portion E) of the outer circumferential surface of the blanket 9b in the first thin film thickness portion E is smaller than the radius R of the outer circumferential surface of the blanket 9b except the first and second thin film thickness portions E and F (R3<R). Meanwhile, in FIG. 37, the first thin film thickness portion E of the twelfth example is shown in a shape different from that of the thin film thickness portion I of the tenth example shown in FIG. 31, but is formed in the same shape as that of the thin film thickness portion I of the tenth example. Therefore, the thickness t3 of the first thin film thickness portion E is smaller than the thickness t4 of the blanket 9b except the first thin film thickness portion E. In addition, the second thin film thickness portion F is provided in the other non-image region H. The diameter R4 (maximum length of lengths from the rotation center of the transfer roller 9 to the outer circumferential surface in the second thin film thickness portion F) of the outer circumferential surface of the blanket 9b in the second thin film thickness portion F is smaller than the radius R of the outer circumferential surface of the blanket 9b except the first and second thin film thickness portions E and F (R4<R).

Meanwhile, in FIG. 37, the diameters R3 and R4 are not shown at positions having a maximum length for convenience in order to make an illustration easy to understand. The thickness t5 (equivalent to the third thickness of the invention) of the second thin film thickness portion F is smaller than the thickness t4 of the blanket 9b except the first thin film thickness portion E (t5<t4). The first and second thin film thickness portions E and F do not come into contact with the photoreceptor 2 similarly to the thin film thickness portion I of the first and eleventh examples, and constitute the noncontact portions 9r and 9s and the second noncontact portion 9t of the invention, respectively. In addition, the first thin film thickness portion E is provided adjacent to the concave portion 9e in both rotational directions of the transfer roller 9. On the other hand, the second thin film thickness portion F is provided facing the concave portion 9e.

Other configurations of the image forming apparatus 1 of the twelfth example are the same as those of the image forming apparatus 1 of the tenth example.

In the image forming apparatus 1 of the twelfth example having such a configuration, it is possible to wear out a small amount of the remaining toner and a small amount of the remaining carrier solution adhering to the first and second thin film thickness portions E and F using the transfer roller cleaning roller 14c, between two transfer mediums 12, that is, in the first and second thin film thickness portions E and F provided in two non-image regions H. In this manner, the non-image region H between the two transfer mediums 12 is used in the thin film thickness portion F, thereby allowing the remaining toner and the remaining carrier solution to be efficiently worn out.

Other operations and effects of the image forming apparatus 1 of the twelfth example are the same as those of the image forming apparatus 1 of the tenth example.

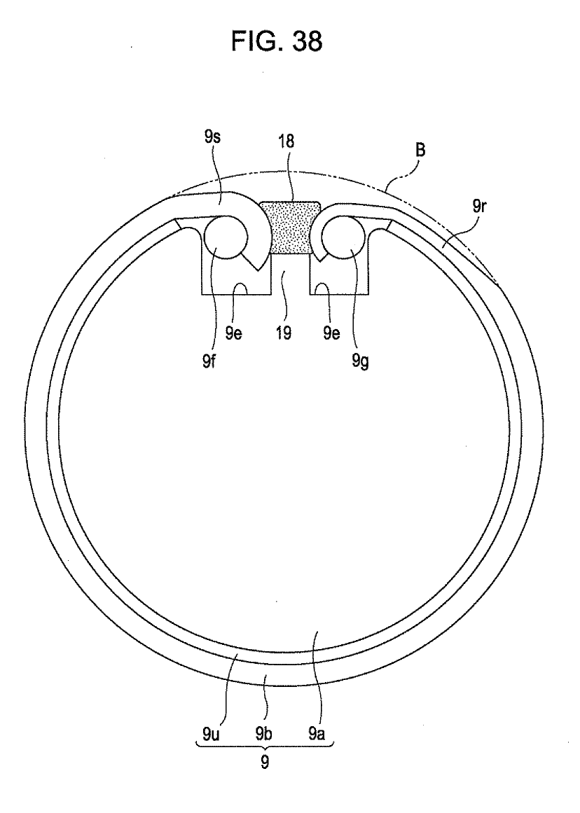

FIG. 38 is a diagram schematically and partially illustrating a transfer roller used in a thirteenth example of the image forming apparatus according to the embodiment of the invention.

As shown in FIG. 38, in the image forming apparatus 1 of the thirteenth example, a blackish toner absorbing member 18 that absorbs toner is provided at the arrangement position of the cover member 9h instead of the sheet-like cover member 9h of the image forming apparatus 1 of the tenth example mentioned above. The toner absorbing member 18 is arranged so as to cover the opening circumferential surface (more specifically, gap between both ends of the blanket 9b) of the concave portion 9e. Appropriate materials known in the related art such as a sponge capable of absorbing toner inside can be used in the cover member 18. In addition, a toner absorbing member support portion 19 is provided within the concave portion 9e in a protruding state, and the toner absorbing member 18 is supported by the toner absorbing member support portion 19 in the rotation center direction of the transfer roller 9. A very extremely small amount of the toner and a small amount of the carrier solution are absorbed by the toner absorbing member 18. In addition, the toner absorbing member 18 is supported by the toner absorbing member support portion 19, whereby the transfer roller cleaning roller 14c is prevented from falling to the opening circumferential surface (more specifically, gap between both ends of the blanket 9b) of the concave portion 9e.

Other configurations, operations and effects of the image forming apparatus 1 of the thirteenth example are all the same as those of the image forming apparatus 1 of the tenth example.

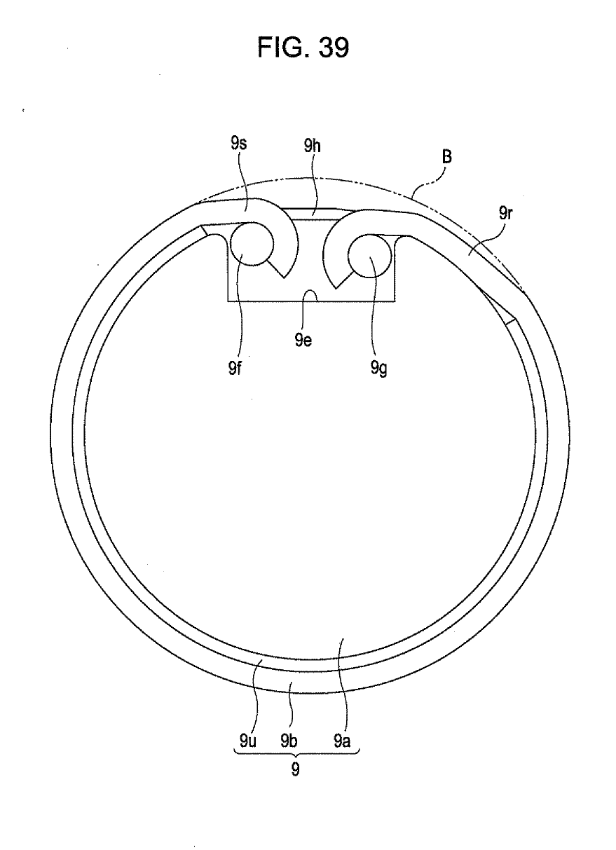

FIG. 39 is a diagram schematically and partially illustrating a transfer roller used in a fourteenth example of the image forming apparatus according to the embodiment of the invention.

In the image forming apparatus 1 of the first to thirteenth examples mentioned above, the noncontact portions 9r and 9s are all formed of the thin film thickness portion of the blanket 9b. On the other hand, as shown in FIG. 39, the image forming apparatus 1 of the fourteenth example uses the blanket 9b having a constant or a substantially constant thickness. In the image forming apparatus 1 of the fourteenth example, the noncontact portions 9r and 9s are provided in the following manner. That is, a spacer member 9u does not include the concave portion 9e and is not provided on the outer circumferential surface of the roller base 9a of a predetermined region adjacent to the concave portion 9e in the rotational direction side of the transfer roller 9. The blanket 9b having a constant or a substantially constant thickness is attached to the outer circumferential surface of the spacer member 9u, and the outer circumferential surface of the roller base 9a which does not include the concave portion 9e and is not provided with the spacer member 9u.

In this manner, the portion of the blanket 9b attached to the outer circumferential surface of the roller base 9a which does not include the concave portion 9e and is not provided with the spacer member 9u is formed as the noncontact portions 9r and 9s. That is, the diameter R8 of the outer circumferential surface of the blanket 9b of the noncontact portions 9r and 9s which do not come into contact with the photoreceptor 2 is smaller than the diameter R of the outer circumferential surface of the blanket 9b of the contact portion which comes into contact with the photoreceptor 2. According to the image forming apparatus 1 of the fourteenth example, the blanket having a constant or a substantially constant thickness is used, whereby the noncontact portions 9r and 9s can be provided simply and inexpensively.

Other configurations, operations and effects of the image forming apparatus 1 of the fourteenth example are all the same as those of the image forming apparatus 1 of the tenth example.

Meanwhile, the invention is not limited to the first example of the embodiment mentioned above. For example, in the first example of the embodiment mentioned above, the transfer roller 9 is used as an image carrying roller, a photoreceptor drum can be used as an image carrying roller. In this case, the transfer roller 9 may be provided in the image forming apparatus, and the transfer roller 9 may not be provided therein. Further, the image carrying roller may be an image carrying roller which does not have a concave portion.

In addition, the invention is not limited to the second and third examples of the embodiment mentioned above. For example, the relationship of the radius R1 (mm) of the transfer roller cleaning roller 14c, the radius R2 (mm) of the first and second rollers 14q and 14r on the cleaning roller side, the radius R3 (mm) of the carrier solution application roller 15e, and the radius R4 (mm) of the first and second rollers 15q and 15r on the application roller side is not limited to the second and third examples mentioned above, and when the relationship of (R1−R2)>(R3−R4)>0 is satisfied, it can be arbitrarily set. In addition, in the first to fourteenth examples of the embodiment mentioned above, the carrier solution supply roller 15d is used as a carrier solution supply member that supplies the carrier solution to the carrier solution application roller, but it is possible to use other carrier solution supply members such as a carrier solution dropping member that drops the carrier solution to the carrier solution application roller. Further, in the first to fourteenth examples of the embodiment mentioned above, the carrier solution is used in order to be capable of easily removing the toner, but other known cleaning solutions can also be used.

Further, the invention is not limited to the fourth and fifth example of the embodiment mentioned above. For example, in the fourth and fifth examples of the embodiment mentioned above, the description is made by applying the image carrying roller that carries an image developed using the liquid developer to the transfer roller 9, but the image carrying roller of the invention can also be applied to the photoreceptor 2.

Further, the invention is not limited to the sixth to fourteenth examples of the embodiment mentioned above. For example, in each of the examples of the embodiment mentioned above, one or two noncontact portions are provided, but a predetermined number of noncontact portions can be provided. In addition, the transfer roller cleaning member can use cleaning members other than the transfer roller cleaning roller.

In the image forming apparatus of the invention, various design changes can be made within the scope of claims.

The entire disclosure of Japanese Patent Application No. 2011-060766, filed Mar. 18, 2011, No. 2011-071856, filed Mar. 29, 2011, No. 2011-062373, filed Mar. 22, 2011, No. 2011-074396, filed Mar. 30, 2011 and No. 2011-082919, filed Apr. 4, 2011 are expressly incorporated by reference herein.

What is claimed is:

1. An image forming apparatus comprising:
a latent image carrier in which a latent image is formed;
an exposure portion that exposes the latent image carrier to form the latent image;
a development portion that develops the latent image formed in the latent image carrier using a liquid developer including toner and a carrier solution;
an image carrying roller to which an image developed in the development portion is transferred;
an application portion, having a cleaning solution application roller that applies a cleaning solution to the image carrying roller, which rotates through a first rotary shaft;
a cleaning portion, having a cleaning roller that comes into contact with the image carrying roller to which the cleaning solution is applied by the cleaning solution application roller and cleans the image carrying roller, which rotates through a second rotary shaft; and
a cleaning member support portion that supports the application portion and the cleaning portion, and rotates through a third rotary shaft to move the cleaning solution application roller by an amount of movement larger than that of the cleaning roller.

2. The image forming apparatus according to claim 1, wherein a distance between the third rotary shaft and the second rotary shaft is shorter than a distance between the third rotary shaft and the first rotary shaft, and
the second rotary shaft and the third rotary shaft are concentric with each other.

3. The image forming apparatus according to claim 1, wherein the second rotary shaft is provided in a direction of a virtual tangent line of the image carrying roller passing through a cleaning nip formed by the contact between the image carrying roller and the cleaning roller.

4. The image forming apparatus claim 1, wherein the cleaning member support portion includes a first support roller which comes into contact with the image carrying roller or is separated therefrom, and a second support roller which comes into contact with the image carrying roller or is separated therefrom, and
the third rotary shaft is arranged between the first support roller and the second support roller.

5. The image forming apparatus according to claim 1, wherein the image carrying roller includes a concave portion on a circumferential surface, and
through a rotation of the image carrying roller, distance L1 (mm) from the rotation center of the image carrying roller to the circumferential surface of the cleaning solution application roller when the concave portion of the image carrying roller and the cleaning solution application roller face each other, distance L2 (mm) from the rotation center of the image carrying roller to the circumferential surface of the cleaning roller when the concave portion of the image carrying roller and the cleaning roller face each other, and radius R (mm) up to the circumferential surface except the concave portion of the image carrying roller have the following relationship:
L2<L1<R.

6. The image forming apparatus according to claim 1, wherein the image carrying roller is an image carrying roller, having a concave portion on a circumferential surface, which transfers an image carried in the image carrier to a transfer medium, including:
a regulating roller support portion arranged concentrically with a rotary shaft of the image carrying roller;
a first regulating roller that comes into contact with the regulating roller support portion to regulate the cleaning roller to a position in which the cleaning roller is penetrated into the concave portion, when the concave portion of the image carrying roller faces the cleaning roller through the rotation of the image carrying roller; and
a second regulating roller that comes into contact with the regulating roller support portion to regulate the cleaning solution application roller to a position in which the cleaning solution application roller is penetrated into the concave portion, when the concave portion of the image carrying roller faces the cleaning solution application roller through the rotation of the image carrying roller, and
radius R1 (mm) of the cleaning roller, radius R2 (mm) of the first regulating roller, radius R3 (mm) of the application roller, and radius R4 (mm) of the second regulating roller have the following relationship:

|R1−R2|>|R3−R4|

7. The image forming apparatus according to claim 6, wherein the radius R1 (mm) of the cleaning roller is larger than the radius R3 (mm) of the cleaning solution application roller.

8. The image forming apparatus according to claim 6, wherein the regulating roller support portion is a roller of radius R5 (mm) arranged in an axial end of the image carrying roller, and
the radius R5 (mm) of the roller is equal or substantially equal to a distance from the rotation center of the image carrying roller to the circumferential surface except the concave portion of the image carrying roller.

9. The image forming apparatus according to claim 1, wherein the image carrying roller includes a concave portion on a circumferential surface, and
the image forming apparatus further comprises a cleaning roller position regulating portion that causes the cleaning roller to be located at a shaft center side of the image carrying roller rather than a virtual circumferential surface in which the concave portion is extended from the circumferential surface of the image carrying roller to the concave portion, when the concave portion of the image carrying roller faces the cleaning roller.

10. The image forming apparatus according to claim 9, further comprising a cleaning solution application roller position regulating portion that causes the cleaning solution application roller to be located at the shaft center side of the image carrying roller rather than the virtual circumferential surface, when the concave portion of the image carrying roller faces the cleaning solution application roller,
wherein the cleaning roller cleans the image carrying roller to which a cleaning solution is applied using the cleaning solution application roller.

11. The image forming apparatus according to claim 10, wherein a distance in a radial direction of the image carrying roller from the cleaning roller of which a position is regulated by the cleaning roller position regulating portion to the shaft center of the image carrying roller is shorter than a distance from the cleaning solution application roller of which a position is regulated by the cleaning solution application roller position regulating portion to the shaft center of the image carrying roller.

12. The image forming apparatus according to claim 9, further comprising a cleaning roller support frame that supports and rotates the cleaning roller,
wherein the cleaning roller position regulating portion includes a shaft member that supports the cleaning roller support frame and rotates the cleaning roller support frame, and a shaft member movement regulating member that regulates movement of the shaft member.

13. The image forming apparatus according to claim 9, wherein the cleaning roller position regulating portion is a cleaning roller which is rotated in the same direction as a rotational direction of the image carrying roller,
the cleaning roller position regulating portion includes a roller member arranged in the cleaning roller,
the cleaning solution application roller is a roller which is rotated in a direction opposite to the rotational direction of the image carrying roller, and
the cleaning solution application roller position regulating portion includes a second roller member arranged in the cleaning solution application roller.

14. The image forming apparatus according to claim 1, wherein the image carrying roller includes a circumferential surface portion having a first diameter, a circumferential surface portion having a second diameter smaller than the first diameter which is separated from the latent image carrier by rotation, and a concave portion different from the circumferential surface portion having the first diameter and the circumferential surface portion having the second diameter.

15. The image forming apparatus according to claim 14, wherein the circumferential surface portion having the second diameter of the image carrying roller is adjacent to the concave portion of the image carrying roller,
the image carrying roller includes a circumferential surface portion having a third diameter smaller than the first diameter, and
the circumferential surface portion having a third diameter is provided at a position which is not adjacent to the concave portion.

16. The image forming apparatus according to claim 14, further comprising:
a cover member that covers an opening circumferential surface of the concave portion, the cover member coming into contact with the cleaning roller; and
an absorbing member that covers the opening circumferential surface of the concave portion and absorbs a liquid developer.

17. The image forming apparatus according to claim 1, wherein the image carrying roller includes a roller base having a concave portion in a circumferential surface, and a blanket, supported by the concave portion and provided on the circumferential surface except the concave portion of the roller base, which has a film thickness portion having a first thickness and a film thickness portion having a second thickness smaller than the first thickness, and comes into contact with the latent image carrier and transfers an image developed by the development portion to a surface of the film thickness portion having the first thickness of the blanket.

18. The image forming apparatus according to claim 17, wherein the film thickness portion having the second thickness of the blanket is arranged adjacent to the concave portion of the roller base,
the image carrying roller includes a film thickness portion having a third thickness smaller than the first thickness, and
the film thickness portion having a third thickness is arranged at a position which is not adjacent to the film thickness portion having the second thickness.

19. The image forming apparatus according to claim 17, wherein the cleaning roller is a cleaning roller of which a circumferential surface moves in a direction opposite to a movement direction of the circumferential surface of the image carrying roller.

20. The image forming apparatus according to claim 17, further comprising a cover member that covers the opening circumferential surface of the concave portion,
wherein the cover member comes into contact with the cleaning roller.
